(19) United States
(12) Patent Application Publication
(10) Pub. No.: US 2019/0044697 A1
(43) Pub. Date: Feb. 7, 2019

(54) METHODS AND SYSTEMS FOR ENHANCED DATA-CENTRIC HOMOMORPHIC ENCRYPTION SEARCHING USING GEOMETRIC ALGEBRA

(71) Applicant: X-Logos, LLC, Colorado Springs, CO (US)

(72) Inventors: Carlos A. Paz de Araujo, Colorado Springs, CO (US); David W. Honorio Araujo da Silva, Colorado Springs, CO (US); Gregory B. Jones, Colorado Springs, CO (US)

(73) Assignee: X-Logos, LLC, Colorado Springs, CO (US)

(21) Appl. No.: 16/162,068

(22) Filed: Oct. 16, 2018

Related U.S. Application Data
(63) Continuation-in-part of application No. 15/946,631, filed on Apr. 5, 2018.
Application No. 15/946,631 is a continuation-in-part of application No. 15/884,047, filed on Jan. 30, 2018.
Application No. 15/884,047 is a continuation-in-part of application No. 15/667,325, filed on Aug. 2, 2017.
(60) Provisional application No. 62/370,183, filed on Aug. 2, 2016.
(60) Provisional application No. 62/452,246, filed on Jan. 30, 2017.
(60) Provisional application No. 62/483,227, filed on Apr. 7, 2017.
(60) Provisional application No. 62/572,955, filed on Oct. 16, 2017.
(60) Provisional application No. 62/572,970, filed on Oct. 16, 2017.
(60) Provisional application No. 62/713,234, filed on Aug. 1, 2018.
(60) Provisional application No. 62/719,488, filed on Aug. 17, 2018.

(51) Int. Cl. H04L 9/00; H04L 9/08; G06F 21/60

(52) U.S. Cl. CPC H04L 9/008; G06F 21/602; H04L 9/0819; H04L 9/085

(57) ABSTRACT

Disclosed are methods and systems for encrypting numeric messages using Geometric Algebra on at least one source device and then storing and searching the encrypted messages on an intermediary system without decrypting the encrypted numeric messages on the intermediary system and/or on a search request device requesting the search. Both the intermediary and search request devices/systems do not need to have knowledge of the encryption security keys. A search result (FOUND/NOT-FOUND) may be sent to a destination device. The FOUND encrypted data, as well as other encrypted data linked to the FOUND encrypted data, may be sent to a destination device and decrypted. Encrypt operations use the geometric product (Clifford Product) of multivectors created from plain text/data with one or more other multivectors that carry encryption keys. Decrypt operations decrypt encrypted data by employing geometric algebra operations such as multivector inverse, Clifford conjugate and others along with the geometric product.

### CROSS REFERENCE TO RELATED APPLICATIONS

This application is a continuation-in-part of U.S. patent application Ser. No. 15/946,631, filed Apr. 5, 2018, entitled “Methods and Systems for Enhanced Data-Centric Scalar Multiplicative Homomorphic Encryption Systems Using Geometric Algebra,” which is a continuation-in-part of U.S. patent application Ser. No. 15/884,047, filed Jan. 30, 2018, entitled “Methods and Systems for Enhanced Data-Centric Encryption Additive Homomorphic Systems Using Geometric Algebra,” which is a continuation-in-part of U.S. patent application Ser. No. 15/667,325, filed Aug. 2, 2017, entitled “Methods and Systems for Enhanced Data-Centric Encryption Systems Using Geometric Algebra,” which is based upon and claims the benefit of U.S. provisional applications Ser. No. 62/370,183, filed Aug. 2, 2016, entitled “Methods and Systems for Enhanced Data-Centric Encryption Systems Using Geometric Algebra;” Ser. No. 62/452,246, filed Jan. 30, 2017, entitled “Methods and Systems for Enhanced Data-Centric Encryption Additive Homomorphic Systems Using Geometric Algebra;” and Ser. No. 62/483,227, filed Apr. 7, 2017, entitled “Methods and Systems for Enhanced Data-Centric Scalar Multiplicative Homomorphic Encryption Systems Using Geometric Algebra,” and which U.S. patent application Ser. No. 15/884,047 is also based upon and claims the benefit of U.S. provisional applications Ser. No. 62/572,955, filed Oct. 16, 2017, entitled “Methods and System for Enhanced Data-Centric Homomorphic Encryption Searching Using Geometric Algebra;” and Ser. No. 62/572,970, filed Oct. 16, 2017, entitled “Methods and System for Enhanced Data-Centric Homomorphic Encryption Sorting Using Geometric Algebra,” and this application is also based upon and claims the benefit of U.S. provisional application Ser. No. 62/713,234, filed Aug. 1, 2018, entitled “Methods and Systems for Hashing Cryptographic Systems Using Geometric Algebra;” and Ser. No. 62/719,488, filed Aug. 17, 2018, entitled “Methods and Systems for an Enhanced Data-Centric Encryption Dynamic Packing Scheme,” all of which are specifically incorporated herein by reference for all that they disclose and teach.

### BACKGROUND OF THE INVENTION

In the last several decades, personal computers and other consumer computing devices, such has hand-held devices and smart phones, have become ubiquitous among the general public. As the proliferation of personal computers and other computing devices became prevalent, the usefulness of the computers and other computing devices was increased by interconnected communications between different computers/computing devices via various electronic networking communications systems. With the advent of the publicly accessible Internet and the establishment of the World Wide Web (WWW) for common communications between computers and/or other computing devices on the Internet, it became common for private identification and financial information to be transferred over the publicly accessible Internet. To ensure that the private information is not accessed by parties that are not intended to be privy to the private information, various encryption techniques have been applied to the private data being transferred over the Internet. As data storage has become accessible over networking technologies, including over the publicly accessible Internet, it has also become prudent to store sensitive data in an encrypted format.

Modern encryption employs mathematical techniques that manipulate positive integers or binary bits. Asymmetric encryption, such as RSA (Rivest-Shamir-Adleman), relies on number theoretic one-way functions that are predictably difficult to factor and can be made more difficult with an ever increasing size of the encryption keys. Symmetric encryption, such as DES (Data Encryption Standard) and AES (Advanced Encryption Standard), uses bit manipulations within registers to shuffle the cryptotext to increase “diffusion” as well as register based operations with a shared key to increase “confusion.” Diffusion and confusion are measures for the increase in statistical entropy on the data payload being transmitted. The concepts of diffusion and confusion in encryption are normally attributed as first being identified by Claude Shannon in the 1940s. Diffusion is generally thought of as complicating the mathematical process of generating unencrypted (plain text) data from the encrypted (cryptotext) data, thus, making it difficult to discover the encryption key of the encryption process by spreading the influence of each piece of the unencrypted (plain) data across several pieces of the encrypted (cryptotext) data. Consequently, an encryption system that has a high degree of diffusion will typically change several characters of the encrypted (cryptotext) data for the change of a single character in the unencrypted (plain) data making it difficult for an attacker to identify changes in the unencrypted (plain) data. Confusion is generally thought of as obscuring the relationship between the unencrypted (plain) data and the encrypted (cryptotext) data. Accordingly, an encryption system that has a high degree of confusion would entail a process that drastically changes the unencrypted (plain) data into the encrypted (cryptotext) data in a way that, even when an attacker knows the operation of the encryption method (such as the public standards of RSA, DES, and/or AES), it is still difficult to deduce the encryption key.

Homomorphic Encryption is a form of encryption that allows computations to be carried out on cipher text as it is encrypted without decrypting the cipher text that generates an encrypted result which, when decrypted, matches the result of operations performed on the unencrypted plaintext.

The word homomorphism comes from the ancient Greek language: óμóζ (homos) meaning “same” and μoρφ\tilde{η} (morphe) meaning “form” or “shape.” Homomorphism may have different definitions depending on the field of use. In mathematics, for example, homomorphism may be considered a transformation of a first set into a second set where the relationship between the elements of the first set are preserved in the relationship of the elements of the second set.

For instance, a map f between sets A and B is a homomorphism of A into B if

f(a₁opa₂)=f(a₁)opf(a₂)|a₁,a₂∈A

where “op” is the respective group operation defining the relationship between A and B.

More specifically, for abstract algebra, the term homomorphism may be a structure-preserving map between two algebraic structures such as groups, rings, or vector spaces. Isomorphisms, automorphisms, and endomorphisms are typically considered special types of homomorphisms. Among other more specific definitions of homomorphism, algebra homomorphism may be considered a homomorphism that preserves the algebra structure between two sets.

### SUMMARY OF THE INVENTION

An embodiment of the present invention may comprise a method for performing homomorphic searching of an intermediary computing system that stores at least one cryptotext encrypted data representation of at least one corresponding plain text data value wherein the homomorphic search is initiated using a plaintext search data value without encrypting the plaintext search data value and without the intermediary computing device decrypting the at least one stored cryptotext encrypted data representation, the method comprising: distributing by at least one source computing device at least one numeric message data value (Mₙ) into coefficients of at least one corresponding message multivector (M̅ₙ) in accord with a homomorphic preserving mathematical relationship between an unencrypted numeric data value and multivector coefficients representing the unencrypted numeric data value that is known to the at least one source computing device and the search request computing device; distributing by the at least one source computing device the shared secret numeric value (S_{S}) into the shared secret multivector (S̅ₛ) in accord with a shared secret coefficient distribution algorithm such that the shared secret numeric value (S_{S}) is kept secret from other devices not intended to have access to the at least one corresponding numeric message data value (Mₙ) including the intermediary computing system; encrypting by the at least one source computing device at least one corresponding cryptotext multivector (C̅ₙ) as the encryption function of at least one Geometric Algebra geometric product operation on the at least one corresponding message multivector (Mₙ) and the shared secret multivector (S_{S}); sending by the at least one source computing device the at least one cryptotext multivector (C̅ₙ) to the intermediary computing system; receiving by the intermediary computing system the at least one cryptotext multivector (C̅ₙ) sent by the at least one source computing device; storing by the intermediary computing system the at least one cryptotext multivector (C̅ₙ) on the intermediary computing system; distributing by the search request computing device a search request numeric message data value (SR) into coefficients of a corresponding search request message multivector (S̅R̅) in accord with the homomorphic preserving mathematical relationship; calculating by the search request computing device a Geometric Algebra rationalize R(S̅R̅) of the search request message multivector (S̅R̅); sending by the search request computing device a search request for the rationalize R(S̅R̅) of the search request message multivector (S̅R̅) to the intermediary computing system; receiving by the intermediary computing system the search request for the rationalize R(S̅R̅) of the search request message multivector (S̅R̅) sent by the search request computing device; calculating by the intermediary computing system a Geometric Algebra rationalize R(C̅ₙ) of the at least one cryptotext multivector (C̅ₙ) stored on the intermediary computing device; calculating by the intermediary computing system the rationalize R(C̅ₙ) of the at least one cryptotext multivector (C̅ₙ) modulus operation by the rationalize R(S̅R̅) of the search request message multivector (S̅R̅); and determining by the intermediary computing system a search result as a function of the modulus operation on the at least one cryptotext multivector (C̅ₙ) by the rationalize R(S̅R̅) of the search request message multivector (S̅R̅) such that a FOUND result is indicated when the modulus operation result is zero and a NOT-FOUND result is indicated when the modulus operation result is non-zero.

An embodiment of the present invention may further comprise a method for encrypting a numeric message data value (M) on a source computing device in order to transfer a cryptotext multivector (C̅) encrypted representation of the numeric message data value (M) to an intermediary computing system that will save the cryptotext multivector (C̅) and perform homomorphic searches of cryptotext multivectors stored on the intermediary computing system as requested by a search request computing device, the method comprising: distributing by the source computing device the numeric message data value (M) into coefficients of a message multivector (M̅) in accord with a homomorphic preserving mathematical relationship between an unencrypted numeric data value and multivector coefficients representing the unencrypted numeric data value that is known to the source computing device and the destination computing device; distributing by the source computing device a shared secret numeric value (S_{S}) into coefficients of a shared secret multivector (S̅_{S}) in accord with a shared secret coefficient distribution algorithm such that the shared secret numeric value (S_{S}) is kept secret from other devices not intended to have access to the numeric message data including the intermediary computing system; encrypting by the source computing device the cryptotext multivector (C̅) as an encryption function of at least one Geometric Algebra geometric product operation on the message multivector (M̅) and the shared secret multivector (S̅_{S}); and sending by the source computing device the cryptotext multivector (C̅) to the intermediary computing system.

An embodiment of the present invention may further comprise a method for a search request computing device to request that an intermediary computing system perform a homomorphic search of cryptotext multivectors stored on the intermediary computing system, the method comprising: distributing by the search request computing device a search request numeric message data value (SR) into coefficients of a corresponding search request message multivector (S̅R̅) in accord with the homomorphic preserving mathematical relationship, the homomorphic preserving mathematical relationship also being known to and used by at least one source computing that delivers the cryptotext multivectors to the intermediary computing system; calculating by the search request computing device a Geometric Algebra rationalize R(S̅R̅) of the search request message multivector (S̅R̅); and sending by the search request computing device a search request for the rationalize R(S̅R̅) of the search request message multivector (S̅R̅) to the intermediary computing system.

An embodiment of the present invention may further comprise a method for performing a homomorphic search of cryptotext multivectors stored on an intermediary computing system in response to a search request from a search request computing device, the method comprising: receiving by the intermediary computing system the at least one cryptotext multivector (C̅ₙ) sent by at least one source computing device; storing by the intermediary computing system the at least one cryptotext multivector (C̅ₙ) on the intermediary computing system; receiving by the intermediary computing system the rationalize R(S̅R̅) of a search request message multivector (S̅R̅) sent by the search request computing device; calculating by the intermediary computing system a Geometric Algebra rationalize R(C̅ₙ) of the at least one cryptotext multivector (C̅ₙ) stored on the intermediary computing device; calculating by the intermediary computing system the rationalize R(C̅ₙ) of the at least one cryptotext multivector (C̅ₙ) modulus operation by the rationalize R(S̅R̅) of the search request message multivector (S̅R̅); and determining by the intermediary computing system a search result as a function of the modulus operation on the at least one cryptotext multivector (C̅ₙ) by the rationalize R(S̅R̅) of the search request message multivector (S̅R̅) such that a FOUND result is indicated when the modulus operation result is zero and a NOT-FOUND result is indicated when the modulus operation result is non-zero.

An embodiment of the present invention may further comprise a method for decrypting at least one cryptotext multivector (C̅ₙ) associated with a FOUND search result of a homomorphic search performed by an intermediary computing system of cryptotext multivectors stored on the intermediary computing system, the method comprising: receiving by the destination computing device the at least one cryptotext multivector (C̅ₙ) associated with the FOUND search result sent by the intermediary computing system; distributing by the destination computing device the shared secret numeric value (S_{S}) into the shared secret multivector (S̅_{S}) in accord with the shared secret coefficient distribution algorithm that is the same shared secret coefficient distribution algorithm known to and used by at least one source computing that delivers the cryptotext multivectors to the intermediary computing system; decrypting by the destination computing device the at least one cryptotext multivector (C̅ₙ) associated with the FOUND search result as a decryption function of at least one Geometric Algebra geometric product operation on the at least one cryptotext multivector (C̅ₙ) and an inverse (S̅_{S}⁻¹) of the shared secret multivector (S̅_{S}) into the at least one message multivector (M̅ₙ) such that the decryption function provides a corresponding decryption operation for the encryption process of the at least one cryptotext multivector (C̅ₙ) at the at least one source computing that delivers the cryptotext multivectors to the intermediary computing system; and converting by the destination computing device the at least one message multivector (M̅ₙ) into the at least one corresponding numeric message data value (Mₙ) in accord with the homomorphic preserving mathematical relationship that is the same homomorphic preserving mathematical relationship known to and used by the at least one source computing device that delivers the cryptotext multivectors to the intermediary computing system.

An embodiment of the present invention may further comprise a homomorphic search Enhanced Data-Centric Encryption (EDCE) system for homomorphic searching of an intermediary computing system that stores at least one cryptotext encrypted data representation of at least one corresponding plain text data value wherein the homomorphic search is initiated using a plaintext search data value without encrypting the plaintext search data value and without the intermediary computing device decrypting the at least one stored cryptotext encrypted data representation, the homomorphic search EDCE system comprising: at least one source computing device, wherein each of the at least one source computing devices further comprises: a source numeric message distribution subsystem that distributes at least one numeric message data value (Mₙ) into coefficients of at least one corresponding message multivector (M̅ₙ) in accord with a homomorphic preserving mathematical relationship between an unencrypted numeric data value and multivector coefficients representing the unencrypted numeric data value that is known to the at least one source computing device and the search request computing device; a source numeric shared secret distribution subsystem that distributes the shared secret numeric value (S_{S}) into the shared secret multivector (S̅_{S}) in accord with a shared secret coefficient distribution algorithm such that the shared secret numeric value (S_{S}) is kept secret from other devices not intended to have access to the at least one corresponding numeric message data value (Mₙ) including the intermediary computing system; a source encryption subsystem that encrypts at least one corresponding cryptotext multivector (C̅ₙ) as the encryption function of at least one Geometric Algebra geometric product operation on the at least one corresponding message multivector (M̅ₙ) and the shared secret multivector (S̅_{S}); and a source send subsystem that sends the at least one cryptotext multivector (C̅ₙ) to the intermediary computing system; a search request computing device, wherein the search request computing device further comprises: a search request numeric message distribution subsystem that distributes a search request numeric message data value (SR) into coefficients of a corresponding search request message multivector (S̅R̅) in accord with the homomorphic preserving mathematical relationship; a search request rationalize calculation subsystem that calculates a Geometric Algebra rationalize R(S̅R̅) of the search request message multivector (S̅R̅); and a search request send subsystem that sends a search request for the rationalize R(S̅R̅) of the search request message multivector (S̅R̅) to the intermediary computing system; and the intermediary computing system, wherein the intermediary computing system further comprises: an intermediary receive subsystem that receives the at least one cryptotext multivector (C̅ₙ) sent by the at least one source computing device; an intermediary store subsystem that stores the at least one cryptotext multivector (C̅ₙ) on the intermediary computing system; an intermediary receive search request subsystem that receives the search request for the rationalize R(S̅R̅) of the search request message multivector (S̅R̅) sent by the search request computing device; an intermediary rationalize calculation subsystem that calculates a Geometric Algebra rationalize R(C̅ₙ) of the at least one cryptotext multivector (C̅ₙ) stored on the intermediary computing device; an intermediary modulus calculation subsystem that calculates the rationalize R(C̅ₙ) of the at least one cryptotext multivector (C̅ₙ) modulus operation by the rationalize R(S̅R̅) of the search request message multivector (S̅R̅); and an intermediary search result determination subsystem that determines a search result as a function of the modulus operation on the at least one cryptotext multivector (C̅ₙ) by the rationalize R(S̅R̅) of the search request message multivector (S̅R̅) such that a FOUND result is indicated when the modulus operation result is zero and a NOT-FOUND result is indicated when the modulus operation result is non-zero.

An embodiment of the present invention may further comprise a homomorphic search Enhanced Data-Centric Encryption (EDCE) system source computing device for encrypting a numeric message data value (M) in order to transfer a cryptotext multivector (C̅) encrypted representation of the numeric message data value (M) to an intermediary computing system that will save the cryptotext multivector (C̅) and perform homomorphic searches of cryptotext multivectors stored on the intermediary computing system as requested by a search request computing device, the homomorphic search EDCE system source computing device comprising: a source numeric message distribution subsystem that distributes the numeric message data value (M) into coefficients of a message multivector (M̅) in accord with a homomorphic preserving mathematical relationship between an unencrypted numeric data value and multivector coefficients representing the unencrypted numeric data value that is known to the source computing device and the destination computing device; a source numeric shared secret distribution subsystem that distributes a shared secret numeric value (S_{S}) into coefficients of a shared secret multivector (S̅_{S}) in accord with a shared secret coefficient distribution algorithm such that the shared secret numeric value (S_{S}) is kept secret from other devices not intended to have access to the numeric message data including the intermediary computing system; a source encryption subsystem that encrypts the cryptotext multivector (C̅) as an encryption function of at least one Geometric Algebra geometric product operation on the message multivector (M̅) and the shared secret multivector (S̅_{S}); and a source send subsystem that sends the cryptotext multivector (C̅) to the intermediary computing system.

An embodiment of the present invention may further comprise a homomorphic search Enhanced Data-Centric Encryption (EDCE) system search request computing device to request that an intermediary computing system perform a homomorphic search of cryptotext multivectors stored on the intermediary computing system, the homomorphic search EDCE system search request computing device comprising: a search request numeric message distribution subsystem that distributes a search request numeric message data value (SR) into coefficients of a corresponding search request message multivector (S̅R̅) in accord with the homomorphic preserving mathematical relationship, the homomorphic preserving mathematical relationship also being known to and used by at least one source computing that delivers the cryptotext multivectors to the intermediary computing system; a search request rationalize calculation subsystem that calculates a Geometric Algebra rationalize R(S̅R̅) of the search request message multivector (S̅R̅); and a search request send subsystem that sends a search request for the rationalize R(S̅R̅) of the search request message multivector (S̅R̅) to the intermediary computing system.

An embodiment of the present invention may further comprise a homomorphic search Enhanced Data-Centric Encryption (EDCE) system intermediary computing system for performing a homomorphic search of cryptotext multivectors stored on the homomorphic search EDCE system intermediary computing system in response to a search request from a search request computing device, the homomorphic search EDCE system intermediary computing system comprising: an intermediary receive subsystem that receives the at least one cryptotext multivector (C̅ₙ) sent by at least one source computing device; an intermediary store subsystem that stores the at least one cryptotext multivector (C̅ₙ) on the intermediary computing system; an intermediary receive search request subsystem that receives the rationalize R(S̅R̅) of a search request message multivector (S̅R̅) sent by the search request computing device; an intermediary rationalize calculation subsystem that calculates a Geometric Algebra rationalize R(C̅ₙ) of the at least one cryptotext multivector (C̅ₙ) stored on the intermediary computing device; an intermediary modulus calculation subsystem that calculates the rationalize R(C̅ₙ) of the at least one cryptotext multivector (C̅ₙ) modulus operation by the rationalize R(S̅R̅) of the search request message multivector (S̅R̅); and an intermediary search result determination subsystem that determines a search result as a function of the modulus operation on the at least one cryptotext multivector (C̅ₙ) by the rationalize R(S̅R̅) of the search request message multivector (S̅R̅) such that a FOUND result is indicated when the modulus operation result is zero and a NOT-FOUND result is indicated when the modulus operation result is non-zero.

An embodiment of the present invention may further comprise a homomorphic search Enhanced Data-Centric Encryption (EDCE) system destination computing device for decrypting at least one cryptotext multivector (C̅ₙ) associated with a FOUND search result of a homomorphic search performed by an intermediary computing system of cryptotext multivectors stored on the intermediary computing system, the homomorphic search EDCE system destination computing device comprising: a destination receive subsystem that receives the at least one cryptotext multivector (C̅ₙ) associated with the FOUND search result sent by the intermediary computing system; a destination numeric shared secret distribution subsystem that distributes the shared secret numeric value (S_{S}) into the shared secret multivector (S̅_{S}) in accord with the shared secret coefficient distribution algorithm that is the same shared secret coefficient distribution algorithm known to and used by at least one source computing that delivers the cryptotext multivectors to the intermediary computing system; a destination decryption subsystem that decrypts the at least one cryptotext multivector (C̅ₙ) associated with the FOUND search result as a decryption function of at least one Geometric Algebra geometric product operation on the at least one cryptotext multivector (C̅ₙ) and an inverse (S̅_{S}⁻¹) of the shared secret multivector (S̅_{S}) into the at least one message multivector (M̅ₙ) such that the decryption function provides a corresponding decryption operation for the encryption process of the at least one cryptotext multivector (C̅ₙ); and a destination convert multivector subsystem that converts the at least one message multivector (M̅ₙ) into the at least one corresponding numeric message data value (Mₙ) in accord with the homomorphic preserving mathematical relationship that is the same homomorphic preserving mathematical relationship known to and used by the at least one source computing device that delivers the cryptotext multivectors to the intermediary computing system.

### BRIEF DESCRIPTION OF THE DRAWINGS

In the drawings,

FIG. 1 is a block diagram of the hardware implementation for a core encryption embodiment (i.e., a core Enhanced Data-Centric Encryption-EDCE-embodiment).

FIG. 2 is a flow chart of the general operation for a core encryption embodiment.

FIG. 3A is a flow chart of the source computing device symmetric key operation for a core encryption embodiment.

FIG. 3B is a flow chart of the destination computing device symmetric key operation for a core encryption embodiment.

FIG. 4A is a flow chart of the source computing device symmetric key and cryptotext masking operation for a core encryption embodiment.

FIG. 4B is a flow chart of the destination computing device symmetric key and cryptotext masking operation for an encryption embodiment.

FIG. 5 is a flow chart of a core encryption embodiment for the EDCE encryption/decryption performed by using a geometric product “sandwich.”

FIG. 6 is a block diagram illustrating generating/extracting/obtaining a second shared secret key from the original shared secret multivector for a core encryption embodiment.

FIG. 7 is a block diagram of the hardware implementation for a homomorphic search encryption embodiment.

FIG. 8 is a flow chart of the general operation for a homomorphic search encryption embodiment.

FIG. 9A is a flow chart of the operations for sending a search result to a destination computing device for a homomorphic search encryption embodiment.

FIG. 9B is a flow chart of the operations for sending the encrypted value associated with a FOUND search result to a destination computing device for a homomorphic search encryption embodiment.

FIG. 9C is a flow chart of additional operations for linking additional encrypted data to a search target and sending the additional linked encrypted data along with the encrypted value associated with a FOUND search result to a destination computing device for a homomorphic search encryption embodiment.

### DETAILED DESCRIPTION OF THE EMBODIMENTS

Homomorphic Encryption is a form of encryption that allows computations to be carried out on cipher text as it is encrypted without decrypting the cipher text that generates an encrypted result which, when decrypted, matches the result of operations performed on the unencrypted plaintext.

The essential purpose of homomorphic encryption is to allow computation on encrypted data without decrypting the data in order to perform the computation. In this way, the encrypted data can remain confidential and secure while the encrypted data is processed for the desired computation. Accordingly, useful tasks may be accomplished on encrypted (i.e., confidential and secure) data residing in untrusted environments. In a world of distributed computation and heterogeneous networking, the ability to perform computations on encrypted data may be a highly desirable capability. Hence, finding a general method for computing on encrypted data is likely a highly desirable goal for cryptography.

The most sought after application of homomorphic encryption may be for cloud computing. Data that is stored in the Cloud is typically not encrypted, and the breach of the Cloud stored, unencrypted data is ranked by the Cloud Security Alliance as the number one threat to data security. Encrypting Cloud stored data may mitigate the threat of data being compromised by a breach, but then the remote clients (owners of the data) would not then be able to perform operations (i.e., add, multiply, etc.) on the Cloud stored data while the data remains in the Cloud. In order to perform operations on encrypted data stored in the Cloud, it would be necessary to download the encrypted Cloud stored data, decrypt the data, perform all desired operations on the data locally, encrypt the resulting data and send the resulting data back to the Cloud. Alternatively, if a user wants the Cloud services provider to perform the computations, the Cloud would require access to the user's encryption keys. It is becoming increasing undesirable to provide the Cloud access to a user's security keys as the more entities that have access to the security keys inherently increases the susceptibility of the security keys to being breached, or even stolen by an unscrupulous provider. Homomorphic encryption would allow the Cloud to operate on client data without decryption, and without access to the client's security keys.

An embodiment may advantageously utilize Geometric Algebra to provide the encryption and decryption of numeric messages that are to be transmitted through, and possibly have operations performed by, an intermediary computing system (e.g., the broad-based computing system currently, and commonly, referred to as the Cloud, or cloud computing). An embodiment of the Geometric Algebra encryption/decryption system that performs the foundational “core” encryption/decryption functions of transferring data securely using Geometric Algebra based encryption/decryption from a source system to a destination system without having arithmetic or other comparative operations performed on the transmitted encrypted data by an intermediary system may be referred to as an Enhanced Data-Centric Encryption (EDCE) system. When an EDCE system is further enhanced to support and provide for arithmetic and/or other comparative operations to be performed at an intermediary computing system (e.g., the Cloud) without decrypting and re-encrypting the data at the intermediary computing system, that system may be referred to as an Enhanced Data-Centric Homomorphic Encryption (EDCHE) system.

Geometric Algebra is an area of mathematics that describes the geometric interaction of vectors and other objects in a context intended to mathematically represent physical interactions of objects in the physical world. The use of Geometric Algebra for cryptography represents a new, manmade use of Geometric Algebra for a purpose entirely outside of the natural basis of Geometric Algebra for representing physical interactions of objects in the real, physical, word. As used herein, this area of mathematics encompasses Geometric Algebra, Conformal Geometric Algebra and Clifford Algebra (referred to collectively herein as “Geometric Algebra”). Generally, Geometric Algebra defines the operations, such as geometric product, inverses and identities, which facilitate many features of embodiments of the core EDCE and the EDCHE systems disclosed herein. Further, Geometric Algebra allows for the organization and representation of data into the “payload” of a multivector where the data in the payload may represent, for example, plaintext, cryptotext, or identifying signatures. Consequently, Embodiments of both the core EDCE system and the EDCHE system make beneficial use of Geometric Algebra properties to provide encryption, decryption, and intermediary homomorphic operations in a relatively computationally simplistic manner while still providing robust security for both data in motion and data at rest (e.g., data stored in the Cloud).

For an embodiment of an EDCHE system, methods and systems to encrypt and decrypt messages using Geometric Algebra may utilize the intrinsic algebraic homomorphic properties of Geometric Algebra to permit arithmetic and other comparative operations on encrypted messages handled by an intermediary computing system without the need for the intermediary computing system to decrypt the encrypted messages prior to performing the arithmetic and other comparative operations. Accordingly, the intermediary computing system does not need to know any information regarding any of the secret security keys of the encryption/decryption processes to properly perform the arithmetic and other comparative operations. The encrypted results of the arithmetic and other comparative operations performed by the intermediary computing system, when decrypted at a destination computing device, produce results equivalent to the same operations as if the operations were performed on the unencrypted plain text messages. To properly achieve the homomorphic effect for intermediary arithmetic and other comparative operations, a proper data organization methodology that preserves such homomorphic properties (i.e., the mathematical relationship between the vectors utilized in the encryption process and the original plaintext messages being encrypted) should be enforced on the choice of coefficients for the vectors representing the plain text messages. As discussed in more detail below, ensuring that the coefficients of the multivector representation of the plaintext numeric message follow a mathematical data organization methodology (i.e., a homomorphic preserving mathematical relationship) between the value of the plaintext numeric message and at least one of the values of the coefficients of the multivector representation of the plaintext numeric message where the mathematical operations incorporating the one or more values of the multivector coefficients have a result equal to the original plaintext numeric message value will provide the proper data organization to preserve the homomorphic properties of the Geometric Algebra operations of the core EDCE encryption/decryption processes. Due to the use of the proper data organization, an embodiment of an EDCHE system provides a cryptosystem that allows unlimited multiplications and additions of cipher text (i.e., transmitted/stored encrypted messages at the intermediary/cloud computer system) due solely to the intrinsic algebraic homomorphic properties of an embodiment of the EDCHE system. Thus, an embodiment of an EDCHE system may provide the homomorphic properties as a product of algebraic homomorphism without the need to use additional methods, such as “bootstrapping” (e.g., performing a recursive operation to reduce the noise associated with a cipher text) to achieve the homomorphic properties.

The encrypted data values may be stored on the intermediary computing system until such time that particular arithmetic or other comparative operations are desired by a user, then the intermediary computing system may perform the requested arithmetic or other comparative operations. Likewise, the encrypted data values may be immediately operated on by the intermediary computing system as soon as the subject encrypted data values are received by the intermediary computing system. However, as one skilled in the art will recognize, the process of receiving the encrypted data values at the intermediary computing system inherently includes storing the encrypted data values at the intermediary computing system even if only fleetingly in an immediately used and erased Random Access Memory (RAM) location or operational register location of a computational subsystem of the intermediary computing system.

Embodiments of both EDCE and EDCHE may be comprised of functional blocks, each of which may be tailored as described in more detail below according to objectives for scope, capability and security. The following sections provide a mathematical and numerical description of these functional blocks.

In order to help minimize the potential confusion of the complex subject matter herein, the descriptions below have been split up to separately cover foundational “core” EDCE concepts and the additional enhancements concepts that permit homomorphic operations for EDCHE. In view of that, Section 1 provides a general description of embodiments of the foundational “core” EDCE system. Section 2 provides additional descriptions of embodiments of the foundational “core” EDCE system, including the packing of information into multivectors, the encryption and decryption of such multivectors and the unpacking to recover the original information. Section 3 provides a description of the further enhancements to embodiments of the foundational “core” EDCE system that achieve homomorphic properties for embodiments of an EDCHE system. Generally, in this description, as is the typical convention, for particular examples of operations, Alice and Bob are used for the sending/source and receiving/destination entities, respectively. Thus, the arrangement of the disclosure may be summarized as follows:

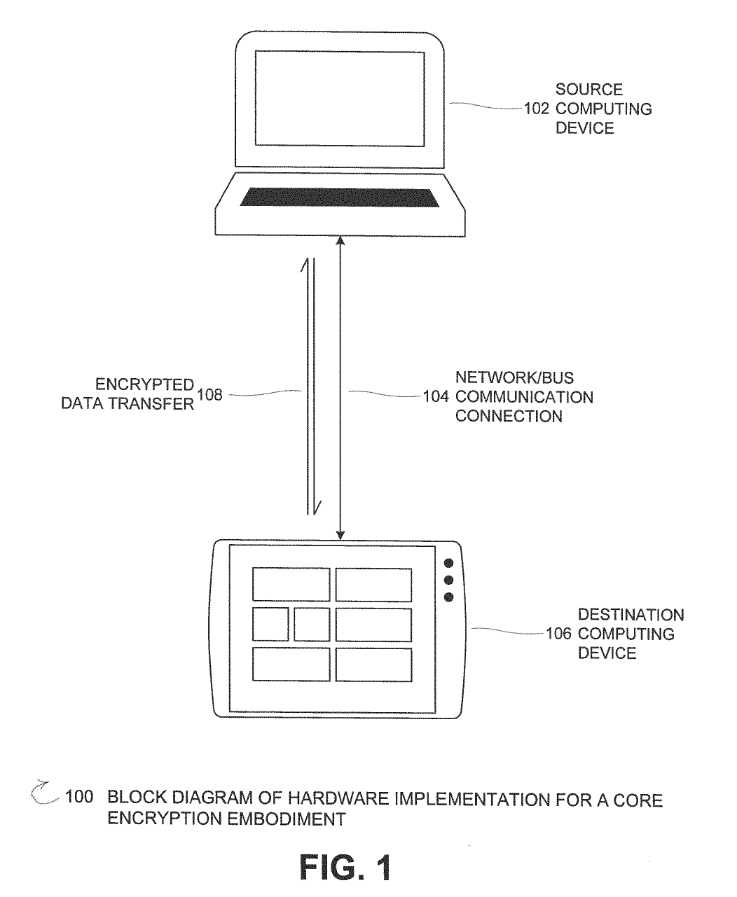

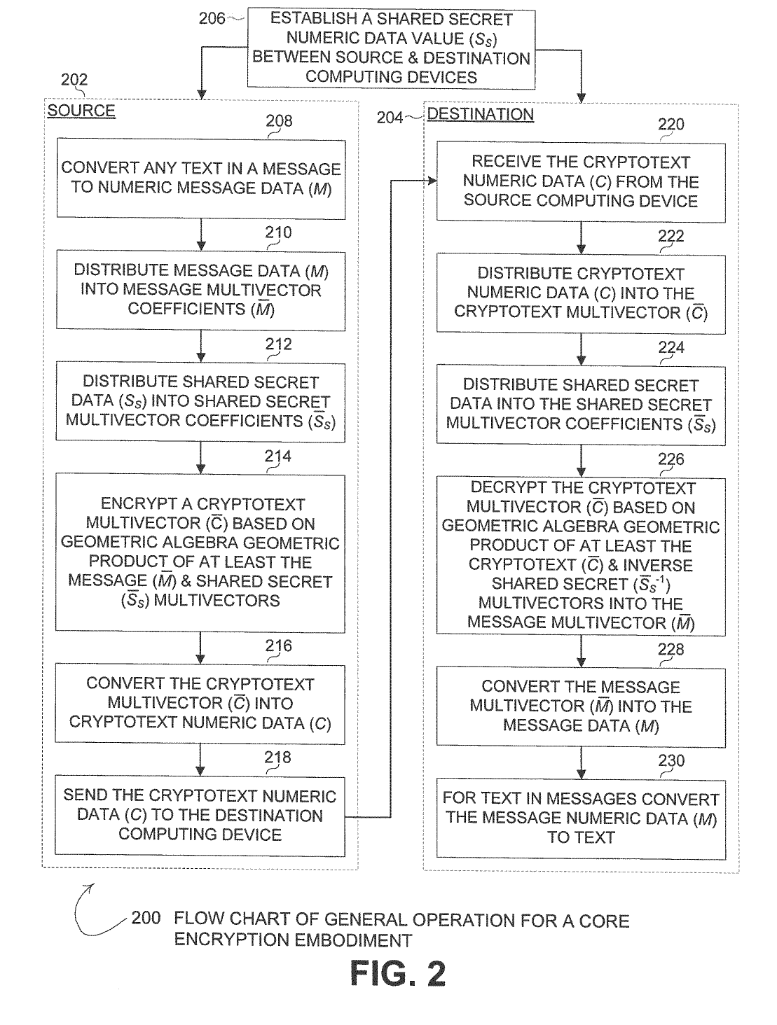

Section 1: General Core EDCE Message Encryption/Decryption
A. Hardware Implementation for Core EDCE Embodiments (FIG. 1)
B. General Core EDCE Operational Flow Charts (FIGS. 2-4)

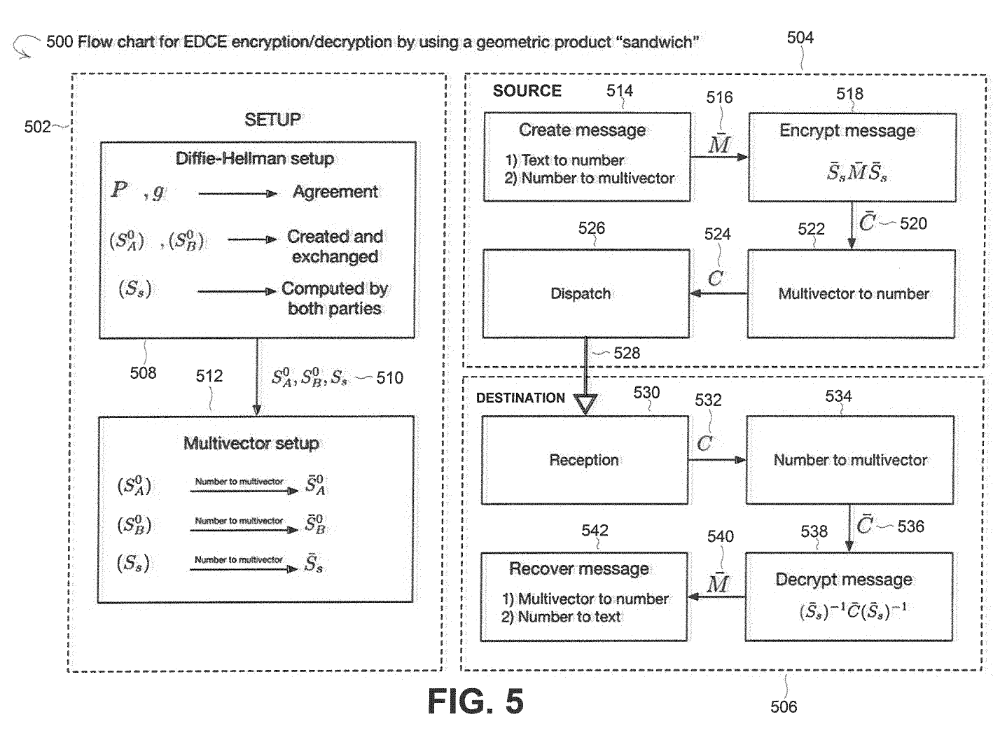

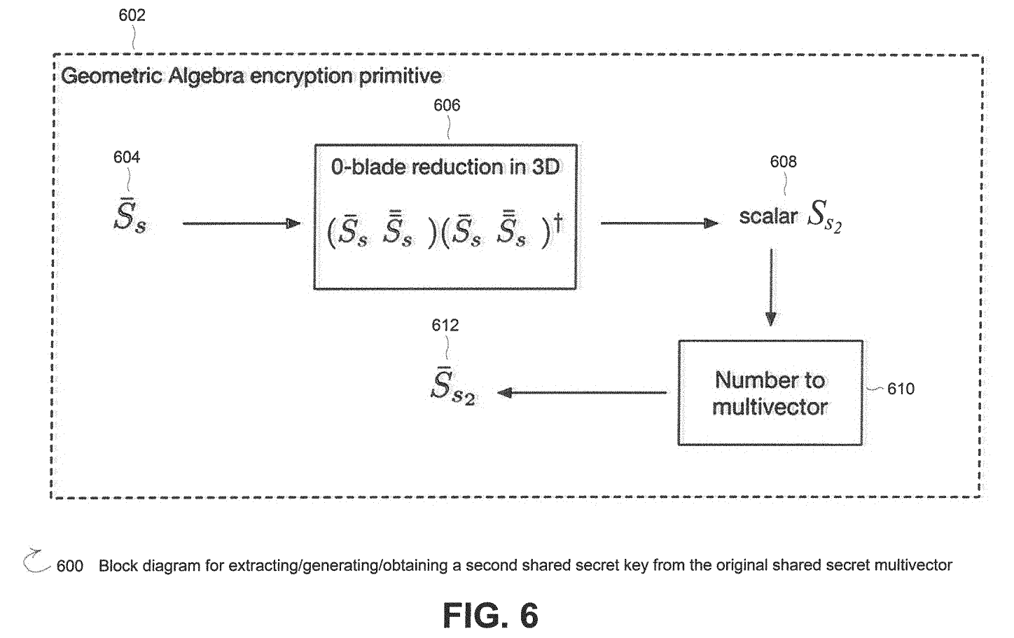

Section 2: Additional Descriptions of Core EDCE Message Encryption/Decryption
A. Packing and unpacking multivectors
   1) Text to number
   2) Number to text
   3) Multivector Data Structure
   4) Number to multivector
   5) Multivector to number
B. Shared Secret
C. Cryptotext creation
D. Decryption
E. EDCE Flow Chart (FIG. 5)
F. Symmetric Key Pair Encryption/Decryption from 0-Blade Reduction Operation (FIG. 6)
   0-Blade Reduction Operation
   Geometric Algebra Encryption Primitives
   Numerical Examples for encryption and decryption with double shared secret in 3 dimensions
G. An Unbreakable Primitive Using Geometric Algebra and Arithmetic Functions
   Example with secret sharing and 3D multivectors

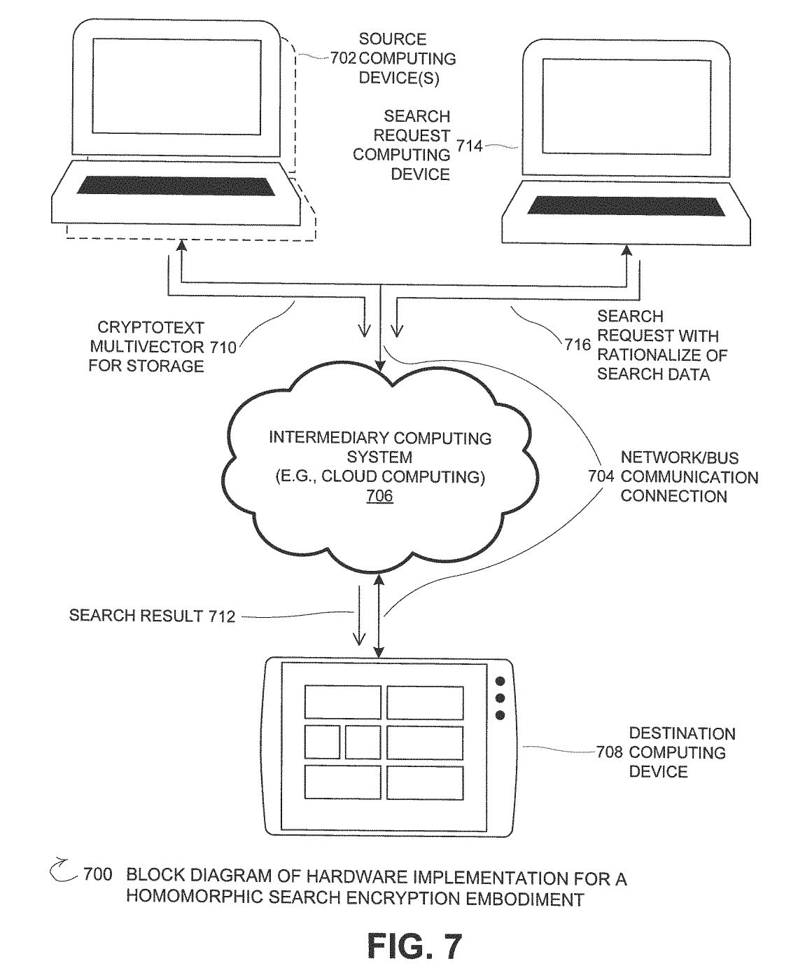

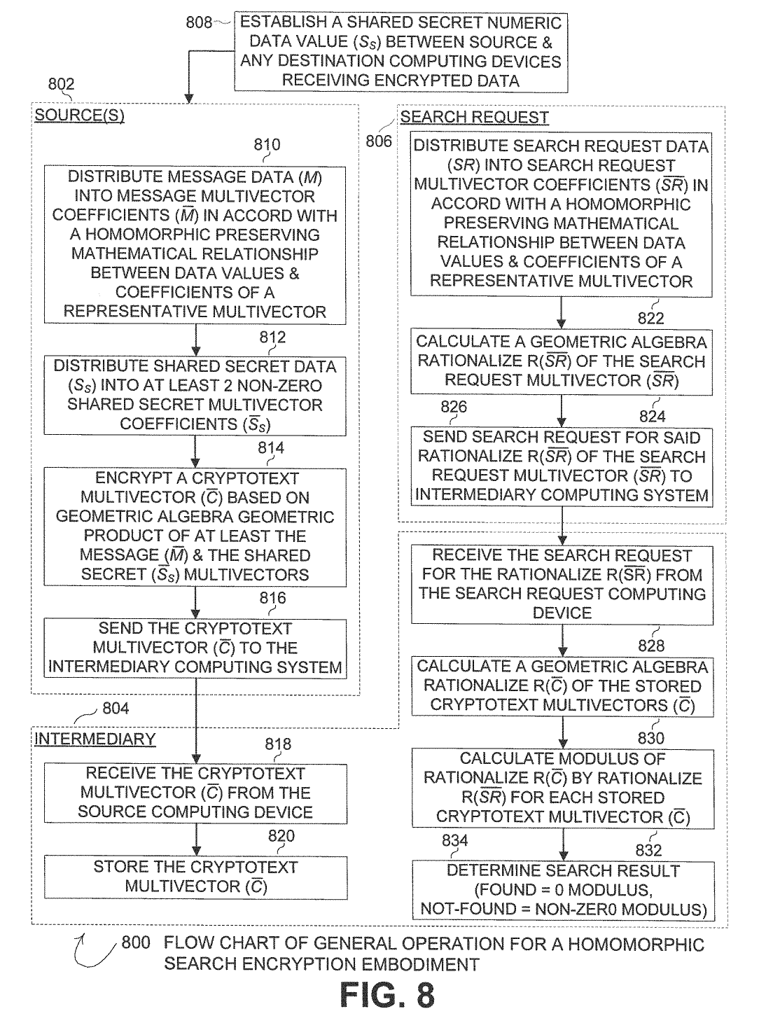

Section 3: Homomorphic EDCHE Enhancements to EDCE Operation
A. Homomorphic Data Organization (i.e., Coefficient Distribution/“Packing”)
B. Number to multivector that supports Homomorphism
   First example
   Second example
   Third example
C. Multivector to number that supports Homomorphism
   First example
   Second example
   Third example
D. Search Homomorphism in EDCHE
   Mathematical Explanation of Multiplicative Homomorphic Property of EDCE as Applied for Searching
   Homomorphic Searching Example Using EDCE (Report Example)
E. Hardware Implementation for Homomorphic Searching EDCHE Embodiments (FIG. 7)
F. Homomorphic Searching EDCHE Operational Flow Charts (FIGS. 8 & 9A-C)

### Section 1: General Core EDCE Message Encryption/Decryption

With the arrival of the internet and many forms of mobile devices, the volume of encrypted data is growing exponentially. Portable devices like “thumb drives,” “smart cards” and Solid State Disks (SSDs) contain both plain text and or encrypted “passive” data storage. Passive data storage is found on the tiny devices for the Internet of Things (IoT) as well as the large memories in server farms.

When data leaves storage, when it is in motion, it is even more vulnerable to attack. Current encryption techniques have not evolved alongside network security infrastructure and they are not well suited for the sheer volume of data in motion. As we move towards “cloud computing,” as mobile devices move us towards “perimeter-less” network security, the industry is moving away from trusting just the security of networks, servers or applications and focusing toward data-centric encryption. With data-centric encryption and authentication there are controls that are traveling with the data rather than just happening at the application layer or the final destination in a network.

However, the fluidity of this data in motion stalls with the computationally intensive mathematics that remain at the heart of current encryption infrastructures. Ciphers such as RSA (Rivest-Shamir-Adleman), DES (Data Encryption Standard) and/or AES (Advanced Encryption Standard) are little more than static “machinery” that bogs down communication efficiency. The actual problem is much bigger. How can robust security be provided when:
a) End-point computational resources are limited (e.g., the Internet of Things-IoT).
b) Encryption/decryption must be near-real time
c) Authentication of the source and destination must be continuously reasserted

A “core” embodiment may be described as enhanced data-centric encryption, or EDCE. Compared to incumbent encryption schemes, EDCE is computationally simplistic while providing robust security over the span of the communication channel. EDCE security is scalable from tiny embedded IoT (Internet of Things) devices up to server farms. EDCE functionality enables many cipher schemes that show speed and bandwidth advantages over current methods. One aspect of EDCE that provides speed enhancement in the encryption/decryption of data is that the EDCE encryption/decryption may be implemented using basic arithmetic operations of addition, subtraction, multiplication, and division. Notably, EDCE does not require a complex operation to select a large prime number, to calculate a logarithm function, to calculate a natural logarithm function, and/or to calculate other complex and computationally intensive mathematical functions (i.e., prime numbers, logarithms, natural logarithms, and/or other complex mathematical operations are not required in the Geometric Algebra calculations disclosed herein).

A central feature of the various embodiments is the use of Geometric Algebra, an area of mathematics that has not been utilized before in encryption. Geometric Algebra as used herein is an area of mathematics that encompasses Geometric Algebra, Conformal Geometric Algebra and Clifford Algebra (collectively herein, “Geometric Algebra”). Geometric Algebra allows for the organization and representation of data into the “payload” of a multivector where the data may be plaintext, cryptotext, or signatures, for example. Geometric Algebra defines the operations, such as geometric product, inverses and identities, which are the enablers of encryption/decryption calculations of various embodiments.

Multivectors are simply the additive combination of a scalar, a vector, a bi-vector and so forth up to an n-dimension vector. However, the unit vectors follow the algebraic structure of quatemions (Hamilton) and non-commutative algebra (Grassman). These two types of algebra allowed Clifford to conceive of the Geometric Product which is used by the various embodiments as one of the “primitive” functions of the embodiments of EDCE and EDCHE systems.

An example of a two-dimension (2D) multivector Ā that includes a scalar and a vector is:

Ā=a₀+a₁ē₁+a₂ē₂+a₁₂ē₁₂

where ēᵢ is a unit vector along the i-axis and ē₁₂ represents the orientation of the area created by a₁₂. The operations of Geometric Algebra on multivectors are discussed more fully in “Appendix A: Geometric Algebra Overview” of the parent patent application Ser. No. 15/667,325, entitled “Methods and Systems for Enhanced Data-Centric Encryption Systems Using Geometric Algebra,” but some general observations may be helpful to the description of the various embodiments disclosed below. First, each of the aᵢ values in the multivector Ā above may be “packed” with information and each aᵢ value may range from zero to very large (e.g., >256,000 bits or an entire message). Secondly, the inverse of Ā when multiplied by Ā yields unity, or:

ĀĀ⁻¹=1

Thus, if a second multivector B̅ is created and the geometric product Ā B̅ is transmitted then the destination can recover B̅ through:

ĀĀ⁻¹B̅=B̅

For the various embodiments, the “payload” may be packed in the values of the scalars and coefficients of the multivector elements. The packing method may define, among many things, the Geometric Algebra operations permissible for EDCE and/or EDCHE embodiments. For example, the Rationalize operation on multivectors yields zero when all multivector coefficients are equal. Such multivectors having all equal coefficients have no inverse and the geometric product of such multivectors having all equal coefficients with another multivector has no inverse. As discussed in more detail below, the decryption methodology for EDCE and EDCHE systems utilize the inverse of the cryptotext multivector being decrypted and of the security key(s) multivector to perform the decryption. Therefore, the cryptotext multivector being decrypted should not have all equal value coefficients. One means to ensure that the cryptotext multivector being decrypted does not have all equal value coefficients is to have the packing/coefficient distribution method ensure that not all coefficients are equal to each other (i.e., at least one coefficient should be different than the other coefficients) when creating the shared security multivector(s) and the data message multivectors. For an embodiment of the EDCE that simply transfers the data message, this will ensure that the cryptotext multivector to be decrypted will not have all equivalent coefficients. For an EDCHE system that may perform operations involving multiple encrypted data values, the same packing/coefficient distribution method to ensure that the source message multivectors do not have all equivalent coefficients will minimize the potential for the cryptotext multivector being decrypted from having all equivalent coefficients, but, when various addition and subtraction operations are performed with multiple distinctly different cryptotext multivectors, there is a remote possibility that the cryptotext multivector result of the homomorphic operations will have all equivalent coefficients. The destination computing device may simply assert that such a result cryptotext multivector is “undefined,” or, the destination or intermediary computing system may provide a means to update the result cryptotext multivector so the result cryptotext multivector does not have all equivalent coefficients. Great care should be taken to ensure that such an update of the result cryptotext multivector does not change the ultimate value of the result plaintext value of the result cryptotext multivector after decryption.

For embodiments that intend to retain homomorphic properties for encrypted data messages such as an embodiment of an EDCHE system, there is an additional restriction that the “packed” multivector that represents the original plaintext numeric message have a mathematical relationship (i.e., the homomorphic preserving mathematical relationship) to the original plaintext numeric message. In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value. The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway.

Additionally, separate multivectors may be encoded for many purposes, such as a shared secret (defined below), authentication information, and timestamps. In addition to the encryption and decryption of a message, the EDCE multivector format and Geometric Algebra foundation of a core EDCE embodiment may enable a single transmission to contain far more than just cryptotext, including dummy data to increase encryption security, command instructions for additional operations, and/or configuration data for the additional operations.

### A. Hardware Implementation for Core EDCE Embodiments (FIG. 1)

FIG. 1 is a block diagram 100 of the hardware implementation for an embodiment. A first computing device 102 is connected over an electronic network/bus connection 104 to a second computing device 106. In the embodiment shown in FIG. 1, the first computing device 102 acts as the source device 102 that sends the encrypted message 108 over the network/bus connection 104. The second computing device 106 acts as the destination device 106 that receives the encrypted message 108 from the network/bus connection 104. Generally, communications, including encrypted communications, are bi-directional such that the first 102 and second 106 computing devices may change roles as the source device 102 and destination device 106 as is necessary to accommodate the transfer of data back and forth between the first 102 and second 106 computing devices.

Further, as shown in FIG. 1, the first computing device 102 appears to be a laptop computer and the second computing device 106 appears to be a tablet device. Generally, any computing device capable of communication over any form of electronic network or bus communication platform may be one, or both of the first 102 and second 106 computing devices. Further, the first 102 and second computing devices 106 may actually be the same physical computing device communicating over an internal bus connection 104 with itself, but still desiring encrypted communication to ensure that an attacker cannot monitor the internal communications bus 104 to obtain sensitive data communications in an unencrypted format.

Various embodiments may implement the network/bus communications channel 104 using any communications channel 104 capable of transferring electronic data between the first 102 and second 106 computing devices. For instance, the network/bus communication connection 104 may be an Internet connection routed over one or more different communications channels during transmission from the first 102 to the second 106 computing devices. Likewise, the network/bus communication connection 104 may be an internal communications bus of a computing device, or even the internal bus of a processing or memory storage Integrated Circuit (IC) chip, such as a memory chip or a Central Processing Unit (CPU) chip. The network/bus communication channel 104 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the first 102 and/or second 106 computing devices. The first 102 and/or second 106 computing devices may each be a computer or computer system, or any other electronic device(s) capable of performing the communications and computations of an embodiment. The first 102 and second 104 computing devices may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASI), and/or a Field Programmable Gate Array (FPGA). Notably, the first 102 and second 106 computing devices may be the storage controller of a data storage media (e.g., the controller for a hard disk drive) such that data delivered to/from the data storage media is always encrypted so as to limit the ability of an attacker to ever have access to unencrypted data. Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

### B. General Core EDCE Operational Flow Charts (FIGS. 2-4)

FIG. 2 is a flow chart 200 of the general operation for an embodiment. At process 206 a shared secret numeric data value (S_{S}) is shared between the source 202 and destination 204. The various embodiments may share the shared secret numeric data value (S_{S}) between the source 202 and destination 204 via any means desired by the users. To ensure the shared secret numeric data value (S_{S}) is kept secret, it is likely that some type of handshaking/setup encrypted key transfer mechanism will be desired to share the shared secret numeric data value (S_{S}). For example, the shared secret numeric data value (S_{S}) may be shared between the source 202 and destination 204 by means including, but not limited to: pre-conditioning the source 202 computing device and the destination 204 computing device with the shared secret numeric value (S_{S}), a standard public/private key exchange technique, RSA (Rivest-Shamir-Adleman) key exchange, and/or Diffie-Hellman key exchange (disclosed in more detail herein, below). Further, the original shared secret may be an alphanumeric string in ASCII (American Standard Code for Information Exchange) or another encoding protocol that is converted to a numeric value based on the associated encoding protocol, such as: ASCII, other English language/alphabetic coding systems, foreign language encoding for non-alphabetic languages (e.g., katakana for Japanese), or even pure symbol to numeric values such as for emoji's. However, both the source 202 and destination 204 need to know and use the same alphanumeric text conversion into a numeric value process to ensure that results of both the source 202 and the destination 204 are the same.

At process 208, the source 202 converts any alphanumeric text in the message into numeric message data (M) based on the alphanumeric encoding protocol (e.g., ASCII, other English language/alphabetic coding systems, foreign language encoding for non-alphabetic languages (e.g., katakana for Japanese), or even pure symbol to numeric values such as for emoji's) of the original text. Again, both the source 202 and destination 204 need to know and use the same alphanumeric text conversion into a numeric value process to ensure that results of both the source 202 and the destination 204 are the same. If the message data is already in numeric form, it is not necessary to perform process 208 as the original numeric message data (M) may be used as is. The various embodiments may perform the encryption process with numeric message data (M) that is, but is not limited to: positive numbers, negative numbers, zero, integer numbers, rational numbers (including fractions), and/or real numbers. At process 210, the source 202 distributes the numeric message data (M) into message multivector (M̅) coefficients. The encryption system will work with just one non-zero message multivector (M̅) coefficient, but, the more non-zero message multivector (M̅) coefficients there are, the stronger the encryption will become, so it is desirable to have more than one non-zero message multivector (M̅) coefficient. At process 212, the source 202 distributes shared secret numeric value (S_{S}) into shared secret multivector (S̅_{S}) coefficients. Again, the encryption system will work with just one non-zero shared secret multivector (S̅_{S}) coefficient, but, the more non-zero shared secret multivector (S̅_{S}) coefficients there are, the stronger the encryption will become, so, again, it is desirable to have more than one non-zero shared secret multivector (S̅_{S}) coefficient. One skilled in the art will recognize that there are many approaches for distributing numeric data into several coefficients of a multivector (see herein, below for disclosure of some example packing/distribution methods). The primary requirement for the distribution process from the numeric values of the message (M) and the shared secret (S_{S}) to the multivector coefficient values (M̅ and S̅_{S}) is that the source 202 and the destination 204 both know the processes 210/222 and 212/224 such that the destination 204 can reconstruct the original message (M). As long as it is known to both the source 202 and the destination 204, the distribution of numeric data to multivector coefficients may be performed differently between the message (M) and the shared secret (S_{S}). Further, the various embodiments may perform the encryption process with multivector coefficient values for both the message (M̅) and shared (S̅_{S}) that are, but are not limited to: positive numbers, negative numbers, zero, integer numbers, rational numbers (including fractions), and/or real numbers.

The distributing/packing method defines, among many things, the Geometric Algebra operations permissible for EDCE and/or EDCHE embodiments. For example, the Rationalize operation on multivectors yields zero when all multivector coefficients are equal. Such multivectors having all equal coefficients have no inverse and the geometric product of such multivectors having all equal coefficients with another multivector has no inverse. For example, the Rationalize operation on multivectors yields zero when all multivector coefficients are equal. Such multivectors having all equal coefficients have no inverse and the geometric product of such multivectors having all equal coefficients with another multivector has no inverse. As discussed in more detail below, the decryption methodology for EDCE and EDCHE systems utilize the inverse of the cryptotext multivector being decrypted and of the security key(s) multivector to perform the decryption. Therefore, the cryptotext multivector being decrypted should not have all equal value coefficients. One means to ensure that the cryptotext multivector being decrypted does not have all equal value coefficients is to have the packing/coefficient distribution method ensure that not all coefficients are equal to each other (i.e., at least one coefficient should be different than the other coefficients) when creating the shared security multivector(s) and the data message multivectors. For an embodiment of the EDCE that simply transfers the data message, this will ensure that the cryptotext multivector to be decrypted will not have all equivalent coefficients. For an EDCHE system that may perform operations involving multiple encrypted data values, the same packing/coefficient distribution method to ensure that the source message multivectors do not have all equivalent coefficients will minimize the potential for the cryptotext multivector being decrypted from having all equivalent coefficients, but, when various addition and subtraction operations are performed with multiple distinctly different cryptotext multivectors, there is a remote possibility that the cryptotext multivector result of the homomorphic operations will have all equivalent coefficients. The destination computing device may simply assert that such a result cryptotext multivector is “undefined,” or, the destination or intermediary computing system may provide a means to update the result cryptotext multivector so the result cryptotext multivector does not have all equivalent coefficients. Great care should be taken to ensure that such an update of the result cryptotext multivector does not change the ultimate value of the result plaintext value of the result cryptotext multivector after decryption. Therefore, it may be desirable for the distribution/packing method to also ensure that not all coefficients are equal to each other (i.e., at least one coefficient should be different than the other coefficients).

For embodiments that intend to retain homomorphic properties for encrypted data messages such as an embodiment of an EDCHE system, there is an additional restriction that the “packed” multivector that represents the original plaintext numeric message have a mathematical relationship (i.e., the homomorphic preserving mathematical relationship) to the original plaintext numeric message. In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value. The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway.

The restriction to retain homomorphic properties is only applicable to the distribution (i.e., “packing”) of the message multivector (M̅) coefficients and not to the distribution (i.e., “packing”) of the shared secret multivector (S̅_{S}). Consequently, the distribution (i.e., “packing”) of the shared secret multivector (S̅_{S}) may be performed in any fashion so long as the distribution (i.e., “packing”) method of the shared secret multivector (S̅_{S}) is known and used consistently by the source 202 and destination 204 computing devices as, ultimately, the shared secret multivector (S̅_{S}) used by the source 202 and destination 204 should be equal to each other to ensure that the decryption operations 226 work properly in relation to the encryption 214 operations. The number of potential coefficients is directly related to the size/dimension (N) of the multivectors such that the number of coefficients increases by a factor of 2 (i.e., 2^{N}) for each incremental increase in the size/dimension (N) of the multivector. To increase the confusion and/or diffusion of the encryption process disclosed herein, using multivectors of at least two dimensions will provide at least four coefficients to distribute the numeric data of the message (M) and the shared secret (S_{S}). By increasing the number of dimensions (N) of multivectors beyond two-dimension multivectors, the confusion and/or diffusion security characteristics will also be increased due to the additionally available multivector coefficients. Further, with the additionally available coefficients it is also possible to transfer more data in a single multivector message (M̅) payload using the additionally available multivector coefficients.

At process 214, the source 202 encrypts a cryptotext multivector (C̅) as a function of at least one Geometric Algebra geometric product operation on the message multivector (M̅) and the shared secret multivector (S̅_{S}). At process 216, the source 202 converts the cryptotext multivector (C̅) into cryptotext numeric data (C) in accord with reverse operation of a cryptotext data coefficient distribution algorithm that is known to both the source 202 and the destination 204. While not typical of most encryption systems, an embodiment may also omit process 216 and directly send a representation of the cryptotext multivector (C̅) without first converting the cryptotext multivector (C̅) into cryptotext numeric data (C). The transmission may be implemented as a series of transfers of the coefficients or as some form of records/packets that define a data structure that carries the coefficient data of the cryptotext multivector (C̅). Typically, the various embodiments will include process 216 to convert the cryptotext multivector (C̅) into cryptotext numeric data (C) in order to maintain compatibility with legacy and/or third party systems as well as to obtain the additional confusion and diffusion characteristics of encapsulating the cryptotext multivector (C̅) coefficients into a single cryptotext numeric data (C) value. If process 216 is used to convert the cryptotext multivector (C̅) into cryptotext numeric data (C), it is necessary for any computing device/system that wishes to operate on the cryptotext multivector (C̅) to have knowledge of the particular conversion methodology so that computing device/system may properly recreate the cryptotext multivector (C̅).

Due to the nature of the geometric product operation of Geometric Algebra, there are many possible variations of the geometric product application that will provide similar degrees of confusion and diffusion. Some, but not all, of the potential geometric product calculations to encrypt the message data (M) include: a geometric product (C̅=M̅S̅_{S}) of the message multivector (M̅) and the shared secret multivector (S̅_{S}), and a geometric product “sandwich” (C̅=S̅_{S}M̅S̅_{S}). At process 218, the source 202 sends the cryptotext numeric data (C) to the destination 204.

At process 220, the destination 204 receives the cryptotext numeric data (C) sent by the source 202. At process 222, the destination distributes the cryptotext numeric data (C) into the cryptotext multivector (C̅) using the cryptotext data coefficient distribution algorithm that is known to both the source 202 and the destination 204. For the less typical embodiment, if process 216 to convert the cryptotext multivector (C̅) into cryptotext numeric data (C) is omitted, then process 222 is also omitted as the cryptotext multivector (C̅) was transmitted directly so there is not a need to convert the cryptotext numeric data (C) back into the cryptotext multivector (C̅). At process 224, the destination 204 distributes shared secret numeric value (S_{S}) into shared secret multivector (S̅_{S}) coefficients in the same fashion as was done for the source 202 at process 212. At process 226, the destination decrypts the cryptotext multivector (C̅) as a function of at least one Geometric Algebra geometric product operation on the cryptotext multivector (C̅) and an inverse (S̅_{S}⁻¹) of the shared secret multivector (S̅_{S}) back into the message multivector (M̅). Again, due to the nature of the geometric product operation of Geometric Algebra there are many possible variations of the geometric product application that will provide similar degrees of confusion and diffusion. Some, but not all, of the potential geometric product calculations to decrypt the message data (M) include: a geometric product (M̅=C̅S̅_{S}⁻¹) of the cryptotext multivector (C̅) and the inverse (S̅_{S}⁻¹) of the shared secret multivector (S̅_{S}), and a geometric product “sandwich” (M̅=S̅_{S}⁻¹C̅S̅_{S}⁻¹ to decrypt). At process 228, the destination 204 converts the message multivector (M̅) into the message numeric data (M) in accord with reverse operation of the message data coefficient distribution algorithm of the source 202 at process 210. At process 230, if necessary, the destination 202 converts the numeric message data (M) back into the original alphanumeric text message as a reverse function of the process of the source 202 at step 208 that converted that alphanumeric text to the numeric message data (M) using standard computer character encoding characteristics.

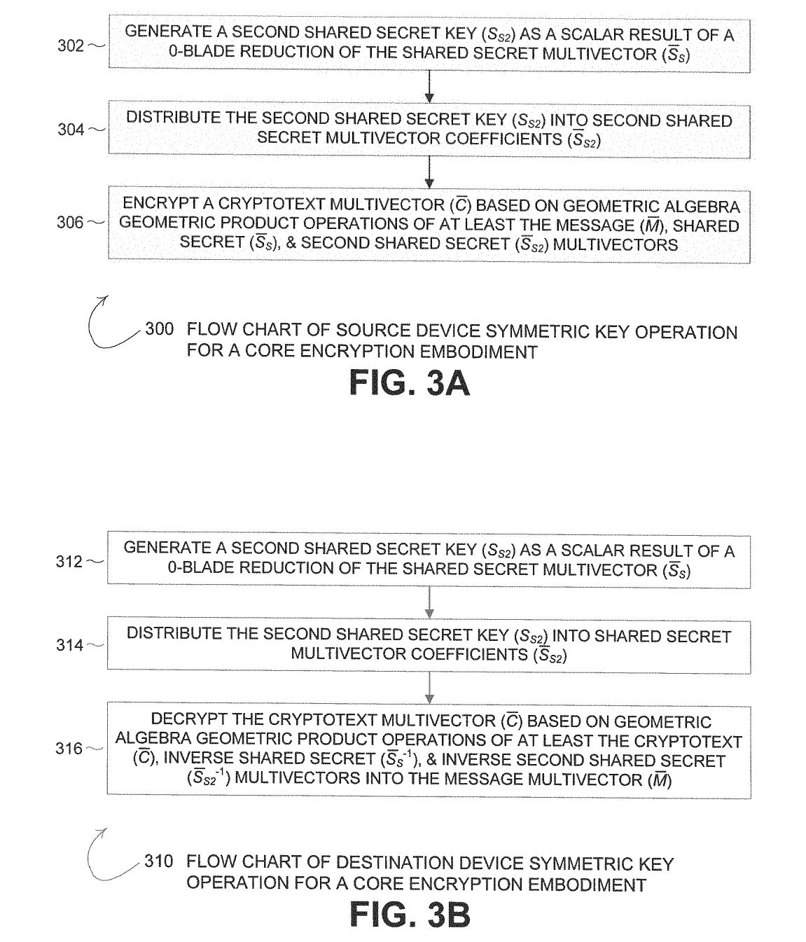

FIG. 3A is a flow chart 300 of the source computing device symmetric key operation for an embodiment. The encryption process 214 of the source 202 of FIG. 2 may further include processes 302-306 to use symmetric shared secret security keys to further enhance the security of an embodiment. For instance, at process 302, the source computing device may generate/extract/obtain a second shared secret key (S_{S}_{₂}) from the original shared secret multivector (S̅_{S}) by performing a 0-Blade Reduction Operation on the original shared secret multivector (S̅_{S}) to obtain a scalar numerical value for the second shared secret key (S_{S}_{₂}). The 0-Blade Reduction Operation may be found as a geometric product (S_{S}_{₂}=(S̅_{S}S̅_{S})(S̅_{S}S̅_{S})^{†}) of the geometric product (S̅_{S}S̅_{S}) of the original shared secret multivector (S̅_{S}) and a Clifford conjugate (S̅_{S}) of the original shared secret multivector (S̅_{S}) and the geometric reverse ((S̅_{S}S̅_{S})^{†}) of the geometric product (S̅_{S}S̅_{S}) of the shared secret multivector (S̅_{S}) and the Clifford conjugate (S̅_{S}) of the original shared secret multivector (S̅_{S}). A further discussion of the 0-Blade Reduction Operation to calculate the second shared secret key (S_{S}_{₂}) may be found herein, below.

At process 304, the source computing device distributes the second shared secret key numeric value (S_{S}_{₂}) into second shared secret multivector (S̅_{S}_{₂}) coefficients where also not all coefficients are equal to each other (i.e., at least one coefficient should be different than the other coefficients). Once again, one skilled in the art will recognize that there are many approaches for distributing numeric data into several coefficients of a multivector (see herein, below, for disclosure of one such distribution method). The primary requirement for the distribution process from the numeric values of the second shared secret key (S_{S}_{₂}) to the second shared secret multivector coefficient values (S̅_{S}_{₂}) is that the source computing device (of FIG. 3A) and the destination computing device (of FIG. 3B) both know the process 304/314 such that the destination computing device can reconstruct the original message (M) by being able to independently recreate the second shared secret multivector (S̅_{S}_{₂}) from the second shared secret key numerical value (S_{S}_{₂}). As long as it is known to both the source computing device and the destination computing device, the distribution of numeric data to multivector coefficients may be performed differently between the message (M), the original shared secret (S_{S}), and the second shared secret key (S_{S}_{₂}).

At process 306, the source computing device encrypts the cryptotext multivector (C̅) as a function of Geometric Algebra geometric product operations on the message multivector (M̅), the shared secret multivector (S̅_{S}), and the second shared secret multivector (S̅_{S}_{₂}). Again, due to the nature of the geometric product operation of Geometric Algebra there are many possible variations of the geometric product operations that will provide similar degrees of confusion and diffusion. One of the potential additional geometric product calculations to encrypt the message data (M) includes, but is not limited to, the geometric product “sandwich” (C̅=S̅_{S}M̅S̅_{S}_{₂} to encrypt).

FIG. 3B is a flow chart 310 of the destination computing device symmetric key operation for an embodiment. The decryption process 226 of the destination 204 of FIG. 2, in conjunction with the operation of the source computing device as described in the disclosure above with respect to FIG. 3A, may include processes 312-316 to use symmetric shared secret security keys to further enhance the security of an embodiment. At process 312, the destination computing device may independently generate/extract/obtain the second shared secret key (S_{S}_{₂}) from the original shared secret multivector (S̅_{S}) by performing the 0-Blade Reduction Operation on the original shared secret multivector (S̅_{S}) to obtain a scalar numerical value for the second shared secret key (S_{S}_{₂}). Again, the 0-Blade Reduction Operation may be found as a geometric product (S_{S}_{₂}=(S̅_{S}S̅_{S})(S̅_{S}S̅_{S})^{†}) of the geometric product (S̅_{S}S̅_{S}) of the original shared secret multivector (S̅_{S}) and a Clifford conjugate (S̅_{S}) of the original shared secret multivector (S̅_{S}) and the geometric reverse ((S̅_{S}S̅_{S})^{†}) of the geometric product (S̅_{S}S̅_{S}) of the shared secret multivector (S̅_{S}) and the Clifford conjugate (S̅_{S}) of the original shared secret multivector (S̅_{S}). See also the further discussion of the 0-Blade Reduction Operation to calculate the second shared secret key (S_{S}_{₂}), which may be found herein, below.

At process 314, the destination computing device also distributes the second shared secret key numeric value (S_{S}_{₂}) into the second shared secret multivector (S̅_{S}) coefficients. Yet again, one skilled in the art will recognize that there are many approaches for distributing numeric data into several coefficients of a multivector (see herein, below, for disclosure of one such distribution method). Again, the primary requirement for the distribution process from the numeric values of the second shared secret key (S_{S}_{₂}) to the second shared secret multivector coefficient values (S̅_{S}_{₂}) is that the source computing device (of FIG. 3A) and the destination computing device (of FIG. 3B) both know the process 304/314 such that the destination computing device can reconstruct the original message (M) by being able to independently recreate the second shared secret multivector (S̅_{S}_{₂}) from the second shared secret key numerical value (S_{S}_{₂}). As long as it is known to both the source computing device and the destination computing device, the distribution of numeric data to multivector coefficients may be performed differently between the message (M), the original shared secret (S_{S}), and the second shared secret key (S_{S}_{₂}).

At process 316, the destination computing device decrypts the cryptotext multivector (C̅) as a function of Geometric Algebra geometric product operations on the cryptotext multivector (C̅), an inverse (S̅_{S}⁻¹) of the original shared secret multivector (S̅_{S}), and an inverse (S̅_{S}_{₂}⁻¹) of the second shared secret multivector (S̅_{S}_{₂}) back into the message multivector (M̅). Once again, due to the nature of the geometric product operation of Geometric Algebra there are many possible variations of the geometric product operations that will provide similar degrees of confusion and diffusion. One of the potential additional geometric product calculations to decrypt the message data (M) includes, but is not limited to, the geometric product “sandwich” (M̅=S̅_{S}⁻¹C̅S̅_{S}_{₂}⁻¹ to decrypt), where the selection of which decryption geometric product operation is based on the geometric product calculation used to encrypt the message data (M).

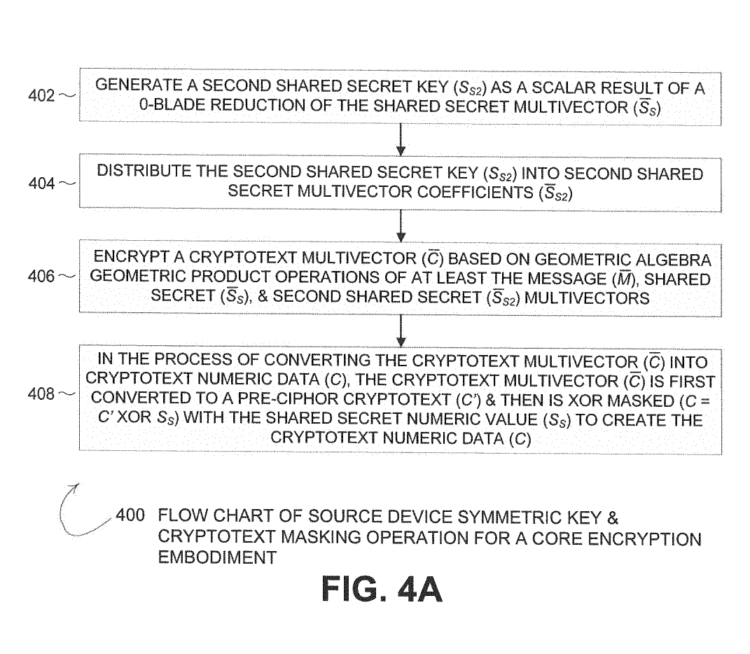

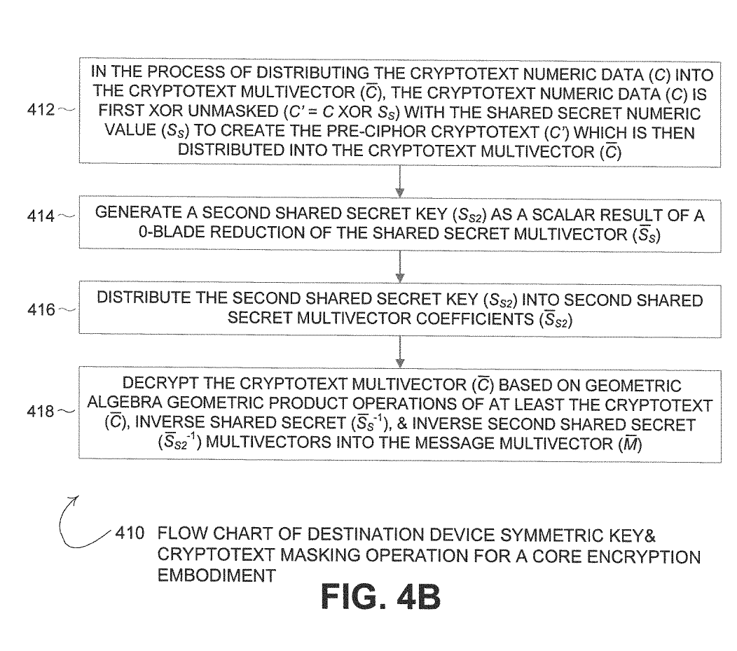

FIG. 4A is a flow chart 400 of the source computing device symmetric key and cryptotext masking operation for an embodiment. Similar to the disclosure with respect to FIG. 3A above, the encryption process 214 of the source 202 of FIG. 2 may further include processes 402-406 to use symmetric shared secret security keys to further enhance the security of an embodiment. At process 402, the source computing device may generate/extract/obtain a second shared secret key (S_{S}_{₂}) from the original shared secret multivector (S̅_{S}) by performing a 0-Blade Reduction Operation on the original shared secret multivector (S̅_{S}) to obtain a scalar numerical value for the second shared secret key (S_{S}). The 0-Blade Reduction Operation may be found as a geometric product (S_{S}_{₂}=(S̅_{S}S̅_{S})(S̅_{S}S̅_{S})^{†}) of the geometric product (S̅_{S}S̅_{S}) of the original shared secret multivector (S̅_{S}) and a Clifford conjugate (S̅_{S}) of the original shared secret multivector (S̅_{S}) and the geometric reverse ((S̅_{S}S̅_{S})^{†}) of the geometric product (S̅_{S}S̅_{S}) of the shared secret multivector (S̅_{S}) and the Clifford conjugate (S̅_{S}) of the original shared secret multivector (S̅_{S}). A further discussion of the 0-Blade Reduction Operation to calculate the second shared secret key (S_{S}_{₂}) may be found herein, below.

At process 404, the source computing device distributes the second shared secret key numeric value (S_{S}_{₂}) into second shared secret multivector (S̅_{S}_{₂}) coefficients where also not all coefficients are equal to each other (i.e., at least one coefficient should be different than the other coefficients). Once again, one skilled in the art will recognize that there are many approaches for distributing numeric data into several coefficients of a multivector (see herein, below, for disclosure some such distribution methods). The primary requirement for the distribution process from the numeric values of the second shared secret key (S_{S}_{₂}) to the second shared secret multivector coefficient values (S̅_{S}_{₂}) is that the source computing device (of FIG. 4A) and the destination computing device (of FIG. 4B) both know the process 404/416 such that the destination computing device can reconstruct the original message (M) by being able to independently recreate the second shared secret multivector (S̅_{S}_{₂}) from the second shared secret key numerical value (S_{S}_{₂}). As long as it is known to both the source computing device and the destination computing device, the distribution of numeric data to multivector coefficients may be performed differently between the message (M), the original shared secret (S_{S}), and the second shared secret key (S_{S}_{₂}).

At process 406, the source computing device encrypts the cryptotext multivector (C̅) as a function of Geometric Algebra geometric product operations on the message multivector (M̅), the shared secret multivector (S̅_{S}), and the second shared secret multivector (S̅_{S}_{₂}). Again, due to the nature of the geometric product operation of Geometric Algebra there are many possible variations of the geometric product operations that will provide similar degrees of confusion and diffusion. One of the potential additional geometric product calculations to encrypt the message data (M) includes, but is not limited to, the geometric product “sandwich” (C̅=S̅_{S}M̅S̅_{S}_{₂} to encrypt).

At process 408, in the process of the source computing device for converting the cryptotext multivector (C̅) into cryptotext numeric data (C) (see, for example, the disclosure above with respect to process 216 of FIG. 2), the cryptotext multivector (C̅) is first converted into a pre-cipher cryptotext (C′) in accord with reverse operation of a cryptotext data coefficient distribution algorithm that is known to both the source computing device (FIG. 4A) and the destination computing device (FIG. 4B). The pre-cipher cryptotext (C′) is then masked as an exclusive or (C=C′ XOR S_{S}) of the pre-cipher cryptotext (C′) and the original shared secret numeric value (S_{S}) to obtain/create the cryptotext numeric data (C) to send to the destination computing device.

FIG. 4B is a flow chart 410 of the destination computing device symmetric key and cryptotext masking operation for an embodiment. At process 412, in the process of the destination computing device for distributing the cryptotext numeric data (C) into the coefficients for the cryptotext multivector (C̅) (see, for example, the disclosure above with respect to process 222 of FIG. 2), is first unmasked through an exclusive or (C′=C XOR S_{S}) of the sent cryptotext numeric data (C) and the original shared secret numeric value (S_{S}) in order to obtain/create the pre-cipher cryptotext numeric data (C′) on the destination computing device. The destination computing device then distributes the pre-cipher cryptotext numeric data (C′) into the cryptotext multivector (C̅) using the cryptotext data coefficient distribution algorithm that is known to both the source and destination computing devices.

The remaining decryption process 226 of the destination 204 of FIG. 2, in conjunction with the operation of the source computing device as described in the disclosure above with respect to FIG. 4A, may include processes 414-418 to use symmetric shared secret security keys to further enhance the security of an embodiment. At process 414, the destination computing device may independently generate/extract/obtain the second shared secret key (S_{S}_{₂}) from the original shared secret multivector (S̅_{S}) by performing the 0-Blade Reduction Operation on the original shared secret multivector (S̅_{S}) to obtain a scalar numerical value for the second shared secret key (S_{S}_{₂}). Again, the 0-Blade Reduction Operation may be found as a geometric product (S_{S}_{₂}=(S̅_{S}S̅_{S})(S̅_{S}S̅_{S})^{†}) of the geometric product (S̅_{S}S̅_{S}) of the original shared secret multivector (S̅_{S}) and a Clifford conjugate (S̅_{S}) of the original shared secret multivector (S̅_{S}) and the geometric reverse ((S̅_{S}S̅_{S})^{†}) of the geometric product (S̅_{S}S̅_{S}) of the shared secret multivector (S̅_{S}) and the Clifford conjugate (S̅_{S}) of the original shared secret multivector (S̅_{S}). See also the further discussion of the 0-Blade Reduction Operation to calculate the second shared secret key (S_{S}_{₂}), which may be found herein, below.

At process 416, the destination computing device also distributes the second shared secret key numeric value (S_{S}_{₂}) into the second shared secret multivector (S̅_{S}) coefficients. Yet again, one skilled in the art will recognize that there are many approaches for distributing numeric data into several coefficients of a multivector (see herein, below, for disclosure of one such distribution method). Again, the primary requirement for the distribution/packing process from the numeric values of the second shared secret key (S_{S}_{₂}) to the second shared secret multivector coefficient values (S̅_{S}_{₂}) is that the source computing device (of FIG. 4A) and the destination computing device (of FIG. 4B) both know the process 404/416 such that the destination computing device can reconstruct the original message (M) by being able to independently recreate the second shared secret multivector (S̅_{S}_{₂}) from the second shared secret key numerical value (S_{S}_{₂}). As long as it is known to both the source computing device and the destination computing device, the distribution of numeric data to multivector coefficients may be performed differently between the message (M), the original shared secret (S_{S}), and the second shared secret key (S_{S}_{₂}).

At process 416, the destination computing device decrypts the cryptotext multivector (C̅) as a function of Geometric Algebra geometric product operations on the cryptotext multivector (C̅), an inverse (S̅_{S}⁻¹) of the original shared secret multivector (S̅_{S}), and an inverse (S̅_{S}_{₂}) of the second shared secret multivector (S̅_{S}_{₂}) back into the message multivector (M̅). Once again, due to the nature of the geometric product operation of Geometric Algebra there are many possible variations of the geometric product operations that will provide similar degrees of confusion and diffusion. One of the potential additional geometric product calculations to decrypt the message data (M) includes, but is not limited to, the geometric product “sandwich” (M̅=S̅_{S}⁻¹C̅S̅_{S}_{₂}⁻¹ to decrypt), where the selection of which decryption geometric product operation is based on the geometric product calculation used to encrypt the message data (M).

Additionally, while the flow charts and flow chart details described above with respect to FIGS. 2-4 describe a methodology that may be embodied as a method or process, another embodiment may be recognized as a computer system, and/or as a source computer system and a destination computer system, that encrypts data, transfers the data, and decrypts the data by implementing the processes described above with respect to the flow chart and flow chart details of FIGS. 2-4. Further, in describing the computer system, and/or the source computer system and the destination computer system, that encrypts data, transfers the data, and decrypts the data, one, or more, individual processes described above for the methodology may be broken down and represented as a subsystem of the overall encryption computer system. A subsystem of the computer system, and/or the source computer system and the destination computer system, that encrypts data, transfers the data, and decrypts the data may be assigned, in whole or in part, to a particular hardware implemented system, such as a dedicated Application Specific Integrated Circuit (ASIC) or Field Programmable Gate Array (FPGA). One or more subsystems, in whole or in part, may alternatively be implemented as software or firmware instructions defining the operation of a computer system with specific regard to the one or more subsystems implemented as software or firmware instructions. The software or firmware instructions may cause the Central Processing Unit, memory, and/or other systems of a computer system to operate in particular accordance with the particular one or more subsystems designated features.

### Section 2: Additional Descriptions of Core EDCE Message Encryption/Decryption

The disclosure below provides a simplified example of the operations and data relationships during the performance of a fundamental “core” EDCE embodiment. The amount of data, the type of data, and the particular data values shown and described in the example are not meant to represent any particular real system, but are provided only for the purpose of showing the operations and data relationships of an embodiment. Further, the embodiments described below are not meant to restrict operations to particular data types, encryption shared secret key exchange techniques, text to numeric and back conversion techniques, and/or number to multivector coefficient assignment techniques.

In addition to the utilization of the Geometric Algebra geometric product as a novel encryption primitive, the various embodiments may be comprised of functional blocks, each of which may be tailored as described according to objectives for scope, capability and security. The following sections provide a mathematical and numerical description of one or more example embodiments of these functional blocks. The numerical results in the examples are generally derived from Geometric Algebra executing in the C programming language.

### A. Packing and Unpacking Multivectors

### Contents

1) Text to Number
2) Number to text
3) Multivector data structure
4) Number to multivector
5) Multivector to number

### 1) Text to Number

For the example EDCE embodiment described herein, each text message needs to be converted to a number in order to become a valid operational unit for all EDCE computations. For the embodiments shown herein, the numbers are typically shown in base 10, but the various embodiments may choose other number bases as desired by the system designer. For instance, a hex (base 16) representation may provide particular advantages when dealing with ASCII numerical representations as standard ASCII has a representation based on the numbers 0-127 (i.e., 2⁷), which is one power of two (i.e., hex is 2⁸) less than the typical 8 bits represented by a hex number of xFF. According to the ASCII character-encoding scheme, symbols such as the letters a, b, c and so on, are represented in order formats (such as binary, decimal, octets, hexadecimal, etc.), which are described in the ASCII printable code chart, a table that presents the relationship between formats. So the letters “a,” “b” and “c” in ASCII decimal code are 97, 98 and 99, respectively.

As an example, assume that the plaintext text message is “message.” In ASCII decimal code, this is represented as follows:

| m | e | s | s | a | g | e |
|---|---|---|---|---|---|---|
| 109 | 101 | 115 | 115 | 97 | 103 | 101 |

With this relationship between symbols and decimal numbers, the conversion from text to number in base 10, using the text “message”, is executed as follows:

The variable n represents the final number of the conversion from text to number. We start defining this variable to zero. So, n=0.

Then we create an array with the ASCII decimal codes for each letter of the message:
text=“message”
ASCII_array_from_“message”=[109, 101, 115, 115, 97, 103, 101]

This array has a size of 7 elements, thus array size=7

Then, for each value of the array of ASCII characters, in a loop, we will
(i) multiply n by 256 (we chose 256 because it is a power of two greater than the largest number in the ASCII printable code chart, so we are reserving a space of 8 bits, since 2⁸=256)
(ii) sum with the equivalent ASCII decimal code, assigning the result to the same initial n variable, as follows:

For i=0; i<array_size; i++
n=n*256+ascii_array_from_message[i]

Note the details of each iteration below:

n = 0
array = [109, 101, 115, 115, 97, 103, 101]
array_size = 7
For i = 0
n = 0 * 256 + 109
n = 109
For i = 1
n = 109 * 256 + 101
n = 28005
For i = 2
n = 28005 * 256 + 115
n = 7169395
For i = 3
n = 7169395 * 256 + 115
n = 1835365235
For i = 4
n = 1835365235 * 256 + 97
n = 469853500257
For i = 5
n = 469853500257 * 256 + 103
n = 120282496065895
For i = 6
n = 120282496065895 * 256 + 101
n = 30792318992869221

By performing the above calculation, the final value of n is: 30792318992869221

Thus, the plain text “message” as a number in base 10 is equal to 30792318992869221. Once we have a base 10 number it is possible to perform the calculations described herein for message encryption. If desired, entropy may be added at this step by performing transformations on the ASCII codes, such as addition or modulo operations, but those entropy adding operations may affect whether intermediary homomorphic operations may properly be performed on the message data as those entropy adding operations may adversely affect the mathematical relationship to the original message values. No such entropy adding transformations are used in the examples that follow.

### 2) Number to Text

After performing various calculations, a base 10 number is transmitted and received. From the above example of a message multivector, the coefficients are concatenated to form a number string. The “number to text” conversion process for this number string also uses the ASCII printable code chart, but the recovery routine is different from the “text to number” conversion. The procedure is described below:

We start with the variable s, which is an empty string that will become the final text recovered from the input number. (Note: the symbol ““ ”” is from the C-language and means empty string)

s=“ ”

The input number is 30792318992869221.

n=30792318992869221

Now, we perform a loop until n is “emptied”, since this number refers to an actual text message. This means the loop will stop when n is equal to zero. In each loop iteration, we will recover, from the last to the first, each ASCII decimal code correspondent to the text that we are retrieving. To do that, we will perform a bitwise AND operation using the value 0xFF (which is 256-1 in hexadecimal format or in base 16). We will convert the code to character symbols and concatenate with the current string, always putting the most recent recovered character in the front of the string. Lastly, we will update the value of n by performing a right shift of 8 bits.

Let's say that the function “get_char” converts the ASCII decimal code to a character symbol.

The procedure is as follows:

while n>0
s=get_char(n AND 0xFF)+s

Note the details of each iteration below:

n=30792318992869221

while n>0
s=get_char(n AND 0xFF)+s

Iteration 0:
ascii_code = n AND 0xFF = 101
s = get_char(ascii_code) + s
s = “e”
n = n >> 8
n = 120282496065895
Iteration 1:
ascii_code = n AND 0xFF = 103
s = get_char(ascii_code) + s
s = “ge”
n = n >> 8
n = 469853500257
Iteration 2:
ascii_code = n AND 0xFF = 97
s = get_char(ascii_code) + s
s = “age”
n = n >> 8
n = 1835365235
Iteration 3:
ascii_code = n AND 0xFF = 115
s = get_char(ascii_code) + s
s = “sage”
n = n >> 8
n = 7169395
Iteration 4:
ascii_code = n AND 0xFF = 115
s = get_char(ascii_code) + s
s = “ssage”
n = n >> 8
n = 28005
Iteration 5:
ascii_code = n AND 0xFF = 101
s = get_char(ascii_code) + s
s = “essage”
n = n >> 8
n = 109
Iteration 6:
ascii_code = n AND 0xFF = 109
s = get_char(ascii_code) + s
s = “message”
n = n >> 8
n = 0

Thus, the number 30792318992869221 is converted to the text string “message,” which agrees with the original plaintext.

### 3) Multivector Data Structure

For the example embodiment discussed herein, any number in base 10 may be a coefficient of a multivector element. A multivector may contain arbitrary data, or data that is a result of a series of operations. A base 10 number may also be represented in multivector form by distributing pieces of this number string to the coefficients in the multivector. Multivectors that are 2D have 4 elements/coefficients available to pack with pieces of this number string, a 3D multivector has 8 elements, and 4D has 16. EDCE has been demonstrated up to at least 7D. A 4D multivector with 16 elements is written as:

Ā=a₀+a₁e₁+a₂e₂+a₃e₃+a₄e₄+a₁₂e₁₂+a₁₃e₁₃+a₁₄e₁₄+a₂₃e₂₃+a₂₄e₂₄+a₃₄e₃₄+a₁₂₃e₁₂₃+a₁₂₄e₁₂₄+a₁₃₄e₁₃₄+a₂₃₄e₂₃₄+a₁₂₃₄e₁₂₃₄

### 4) Number to Multivector

Given the base 10 number string 30792318992869221, this string may be a single coefficient of, say, a 2D multivector, as follows:

0+30792318992869221e₁+e₂+e₁₂

EDCE has been demonstrated where the number string distributed to an element of the multivector exceeds 4,000 digits. However, the base 10 number in our example will typically be “distributed” in an ad hoc manner across all the multivector elements, such as:

30792+31899e₁+28692e₂+21e₁₂

The above distribution is called “number to multivector.” For a core EDCE embodiment, the method of distributing the number string may be according to any of a variety of algorithms as long as the method is known and used by both the sending and receiving entities. To increase cryptographic “confusion,” the distribution algorithm may include shuffling of the assignments to elements, performing functional operations on numbers assigned to elements or changing the algorithm between messages in a conversation. More operations increase encryption entropy. However, it should be noted that shuffling and other algorithms to increase cryptographic confusion may break the potential for homomorphic operations by and EDCHE embodiment.

In order to ensure that the Geometric Algebra operations properly impart encryption security and also provide decryption capability, there are also some other rules that should be followed when performing the “number to multivector” process. For instance, the distributing/packing method defines, among many things, the Geometric Algebra operations permissible for EDCE and/or EDCHE embodiments. For example, the Rationalize operation on multivectors yields zero when all multivector coefficients are equal. Such multivectors having all equal coefficients have no inverse and the geometric product of such multivectors having all equal coefficients with another multivector has no inverse. As discussed in more detail below, the decryption methodology for EDCE and EDCHE systems utilize the inverse of the cryptotext multivector being decrypted and of the security key(s) multivector to perform the decryption. Therefore, the cryptotext multivector being decrypted should not have all equal value coefficients. One means to ensure that the cryptotext multivector being decrypted does not have all equal value coefficients is to have the packing/coefficient distribution method ensure that not all coefficients are equal to each other (i.e., at least one coefficient should be different than the other coefficients) when creating the shared security multivector(s) and the data message multivectors. For an embodiment of the EDCE that simply transfers the data message, this will ensure that the cryptotext multivector to be decrypted will not have all equivalent coefficients. For an EDCHE system that may perform operations involving multiple encrypted data values, the same packing/coefficient distribution method to ensure that the source message multivectors do not have all equivalent coefficients will minimize the potential for the cryptotext multivector being decrypted from having all equivalent coefficients, but, when various addition and subtraction operations are performed with multiple distinctly different cryptotext multivectors, there is a remote possibility that the cryptotext multivector result of the homomorphic operations will have all equivalent coefficients. The destination computing device may simply assert that such a result cryptotext multivector is “undefined,” or, the destination or intermediary computing system may provide a means to update the result cryptotext multivector so the result cryptotext multivector does not have all equivalent coefficients. Great care should be taken to ensure that such an update of the result cryptotext multivector does not change the ultimate value of the result plaintext value of the result cryptotext multivector after decryption.

The simple distribution method used in some of the core EDCE embodiment examples below is described as follows: Let the input base 10 number string=30792318992869221. We count the number of digits and determine that the number size is 17 digits. We then determine how to distribute these digits to the elements of a multivector. Considering a multivector of 2D, which has 4 elements, we apply the following equation:

$$ep = ( \frac{{Size}_{number}}{{Number}_{elements}} ) + 1$$

$$ep = ( \frac{17}{4} ) + 1 = 5$$

Where ep is “each portion” length.

Now we have the original base 10 number and its size (17), the multivector structure (2D, 8 elements) and the length of each element (5). Now we need to “slice” the base 10 number in order to distribute each part as a coefficient of the new multivector.

Computationally, the procedure is as follows:

| | |
|---|---|
| Base 10 number | 30792318992869221 |
| Number size | 17 |
| Number of multivector elements | 4 |
| Each portion length | 5 |
| First element | 30792 |
| Second element | 31899 |
| Third element | 28692 |
| Fourth element | 21 |

This creates the following multivector:

30792+31899e₁+28692e₂+21e₁₂

### Handling Special Cases:

Regardless of the method of distribution, the leading digit in any coefficient must be non-zero. For example, let the number to be converted to multivector be 30792318990869221. Applying the distribution method shown above would result in:

30792+31899e₁+08692e₂+21e₁₂

Note the third element=08692e₂. The computer will treat this number as 8692. When converting back from multivector to number, instead of 30,792,318,990,869,221 we would have 3,079,231,899,869,221, which is not the same number (commas added only for comparability).

To avoid this outcome, it is necessary to include verification in the algorithm that the first number of a coefficient is non-zero. If it is zero, this number should be placed as the last number in the coefficient of the previous element of the multivector. So, the correct result of the conversion of the number 30792318990869221 to a 2D multivector is:

30792+318990e₁+8692e₂+21e₁₂

### Homomorphic “Number to Multivector” Distribution Method Restrictions:

For embodiments that intend to retain homomorphic properties for encrypted data messages such as an embodiment of an EDCHE system, there is an additional restriction that the “packed” multivector that represents the original plaintext numeric message have a mathematical relationship (i.e., the homomorphic preserving mathematical relationship) to the original plaintext numeric message. In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value. The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway.

Additional and more detailed examples of homomorphism conserving “number to multivector” processes are described in more detail below in Section 3 that covers homomorphic searching EDCHE embodiments in more detail.

### 5) Multivector to Number

The simple distribution method used in some of the core EDCE embodiment examples below is described as follows:

For the simple distribution (i.e., “packing”) method disclosed above for parsing the string representation of a base 10 number to obtain the coefficient values, converting a multivector to a base 10 number is simply the reverse process of concatenating the coefficients of the multivector in order to form a base 10 number.

As an example: the multivector: 30792+31899e₁+28692e₂+21e₁₂ becomes: 30792318992869221.

Note that in the core EDCE protocol of some of the example embodiments herein, only base 10 number strings are transmitted, not multivectors, but sending only base 10 number strings is not a requirement for an embodiment. In some embodiments, the number may be sent using a numeric variable representation such as an integer or floating point data type. Further, while not typical of most encryption systems, instead of sending a single cryptotext number (C), an embodiment may also simply skip the step of converting the multivector (C̅) into cryptotext numeric data (C), and directly send a representation of the cryptotext multivector (C) without first converting the cryptotext multivector (C̅) into cryptotext numeric data (C). The transmission may be implemented as a series of transfers of the coefficients or as some form of records/packets that define a data structure that carries the coefficient data of the cryptotext multivector (C̅). As would be the case for a more typical encryption system, if the process to convert the cryptotext multivector (C̅) into cryptotext numeric data (C) is used to convert the cryptotext multivector (C̅) into cryptotext numeric data (C), it is necessary for any computing device/system that wishes to operate on the cryptotext multivector (C̅) to have knowledge of the particular conversion methodology so that the computing device/system may properly recreate the cryptotext multivector (C̅).

### B. Shared Secret

A “Shared Secret” is a fundamental element in cryptography. A Shared Secret enables secure communication between two or more parties. For the various embodiments the Shared Secret is a number string of digits that may be packed into a multivector in the manner shown above. The “Shared Secret Multivector” may be used to operate on other multivectors, such as creating the geometric product of the Shared Secret Multivector and the message multivector.

A variety of methods are already in practice to establish the Shared Secret between sources and destinations. As disclosed herein, the conversion of a “Shared Secret” number to a “Shared Secret Multivector” is completely novel. Communication end-point devices may be “pre-conditioned” with a unique identifier (number string) known only to the system administrators. In a public/private key environment such as RSA, the Shared Secret may be encrypted by the source using only the destination's public key. The method used in the examples below is the Diffie-Hellman key exchange protocol. This is a convenient, widely adopted method to establish a number string Shared Secret. However, any method that securely produces a shared number string is suitable for use with the various embodiments.

The Diffie-Hellman protocol uses the multiplicative group of integers modulo p (see, for example, https://en.wikipedia.org/wiki/Multiplicative_group_of integers_modulo_n), where p is prime (see, for example, https://en.wikipedia.org/wiki/Prime_number), and g is a primitive root modulo p (see, for example, https://en.wikipedia.org/wiki/Primitive_root_modulo_n and https://en.wikipedia.org/wiki/Modular_arithmetic). These two values are chosen in this way to ensure that the resulting shared secret can take on any value from 1 to p−1. A simple example of Diffie-Hellman follows:
Alice and Bob first agree on using the same root modulo p and base g.
Alice chooses a secret integer a (Alice's password) and creates her signature S_{A}⁰ as

S_{A}⁰=g^{a} mod p
and sends it to Bob. (Note: the superscript 0 is a placeholder for later use, if any.)
Similarly, Bob chooses a secret integer b (Bob's password) and creates his signature S_{B}⁰ as

S_{B}⁰=g^{b} mod p

and sends it to Alice.
Alice and Bob are able to compute the shared secret key S_{S} as follows:
   Alice computes S_{S}=(S_{B}⁰)^{a} mod p
   Bob computes S_{S}=(S_{A}⁰)^{b} mod p
The keys computed by Alice and Bob are the same. This is the Shared Secret.

Note that Diffie-Hellman protocol is not limited to negotiating a key shared by only two participants. Any number of users can take part in the agreement by performing iterations of the protocol and exchanging intermediate data.

### Numeric Example

Assume the following:

| | |
|---|---|
| Selected and shared prime number | 821309937410771225846473211469 |
| p | |
| Selected and shared base number | 773039877053085816220792898603 |
| g | |
| Alice's secret a | 325952971969365237094889914154 |
| Bob's secret b | 289473367541568799631931700475 |

To compute S_{A}⁰, Alice's public signature and S_{B}⁰, Bob's public signature:

S_{A}⁰=g^{a} mod p

S_{B}⁰=g^{b} mod p

S_{A}⁰=49009686585026240237091226039

S_{B}⁰=286639204586849997936652161962

To compute the shared secret, both Alice and Bob will perform the following equation, which will generate the same value for both, thus the shared secret is reference as Sₛ:

Sₛ=S_{B}⁰^{^{a}} mod p

Sₛ=S_{A}⁰^{^{b}} mod p

Sₛ=374101092446920532886590141005

The shared secret number string above may be distributed as before to create a Shared Secret Multivector:

S̅ₛ=37410109+24469205e₁+32886590e₂+141005e₁₂

In a similar manner the S_{A}⁰ and S_{B}⁰ number string for Alice and Bob can be distributed in a multivector format to create S̅_{A}⁰ and S̅_{B}⁰. These multivectors for Alice and Bob are essential to the additional EDCE security features discussed in Section 2.

### C. Cryptotext Creation

The cryptotext is created using the EDCE primitive which is the geometric product of the Message multivector and one or more other multivectors. In the most basic form, the cryptotext multivector may be the geometric product of the Message multivector and the Shared Secret Multivector.

The procedure is defined as follows. Let the plaintext message be “this is a test.” By applying the “text to number” conversion, we will get the plaintext message as the number:
2361031878030638688519054699098996

By applying the “number to multivector” conversion using a 2D multivector structure the plaintext multivector is:

M̅=236103187+803063868e₁+851905469e₂+9098996e₁₂

Using the Shared Secret multivector that was determined above:

S̅ₛ=37410109+24469205e₁+32886590e₂+141005e₁₂

The cryptotext multivector can be defined as the geometric product:

C̅=M̅S̅_{S}

Using methods for calculating the geometric product of M̅ and S̅_{S} implemented in C programming code, the cryptotext multivector C̅ described above is calculated as:

C̅=56497963248932053+35999076139905242e₁+39525095983837611e₂+5938268771181474e₁₂

In order to be transmitted, as a payload, C̅ now may be converted to a base 10 number, through the “multivector to number” conversion process described above.

C₁₀=5649796324893205335999076139905242395250959838376115938268771181474

To increase the entropy of the Cryptotext Multivector, the Geometric Product of the Message Multivector may be taken with more than one other multivector or by using the same multivector twice to form a sandwich or by the addition of left and right multivector operations on the same Shared Secret Multivector. Two examples of these types are C̅=S̅_{S}M̅S̅_{S} and C̅=S̅_{S}M̅+M̅S̅_{S}. The use of these primitives and their inverse is shown in the flow charts in FIGS. 3 and 4.

Note that there are several alternative methods to construct the Cryptotext Multivector. One alternative is to encrypt the plaintext message using a conventional symmetric cipher such as AES, converting the number string output of that cipher to multivector format and use this multivector in calculating the geometric product with S̅_{S}, which yields C̅. This alternative may be practiced during the transition to EDCE within the enterprise to preserve backward compatibility with legacy encryption systems.

### D. Decryption

Since Bob has the same shared secret of the source, he can open the cryptotext by performing a geometric product of the cryptotext multivector and the inverse of the shared secret multivector. When Bob receives C₁₀, he will apply the appropriate number to multivector conversion to get:

C̅=56497963248932053+35999076139905242e₁+39525095983837611e₂+5938268771181474e₁₂

To recover the plaintext multivector M̅ Bob determines the geometric product of the cryptotext multivector and the inverse of the Shared Secret multivector.

M̅=C̅S̅_{S}⁻¹

The method to determine S̅_{S}⁻¹ given S̅_{S} is described in more detail in “Appendix A: Geometric Algebra Overview” of the parent patent application Ser. No. 15/667,325, entitled “Methods and Systems for Enhanced Data-Centric Encryption Systems Using Geometric Algebra.” It has been computed as:

$${\overline{S}}_{S}^{1} = 0.000026073076962327080434360644193616198433147472820027689698131 + 0.000000825457638290213311181056473878297303908013995989312703222 {e}_{1} + ( - 0.000003022013576864948697543940186562731020525315836555058082087 ) {e}_{2} + ( - 0.000001476164784851810000367564890720274369477622677012150966249 ) {e}_{3} + ( - 0.000001979165546727098436715224982579657444314140144210619540629 ) {e}_{12} + ( - 0.000004182897588855026711933985071316069976075801566911515708555 ) {e}_{13} + ( - 0.000002840357355486048162850225401518433913770465475305727734285 ) {e}_{23} + ( - 0.000000583992297267872657596889780817224702593392912954493277677 ) {e}_{123}$$

### Thus,

M̅=236103187+803063868e₁+851905469e₂+9098996e₁₂

The multivector M̅ is converted to a base 10 number:

M₁₀=2361031878030638688519054699098996

Finally, this number is converted to text using the “number to text” procedure described above, resulting in:

M_{plain text}=“this is a test”

### E. EDCE Flow Chart (FIG. 5)

FIG. 5 is a flow chart 500 of an embodiment for the core Enhanced Data-Centric Encryption (EDCE) encryption/decryption performed by using a geometric product “sandwich.”

Setup (502): The sequence is initiated by establishing the signature and shared secret multivectors. Here the Diffie-Hellman procedure 508 is shown but other asymmetric key ciphers such as RSA may be used to generate a number string known only to the source 504 and the destination 506. Alternatively, end-point devices may be “pre-conditioned” with a secret (number string) known to the system administrator from which the session multivectors may be constructed. The Diffie-Hillman procedure 508 sets up/creates the shared secret keys 510 and then the setup 502 creates multivectors of the Diffie-Hillman keys 510 in the multivector setup 512.

Source (504): The Message Multivector 516 is constructed at the create message operation 514 by concatenating the message ASCII code string to a number string and then distributing that number to the coefficients of the message multivector at 514. The method of distributing to coefficients uses a prescribed algorithm known and used by both the source 504 and the destination 506.

The Message Multivector 516 is then encrypted 518 by computing the geometric product of the message and Shared Secret multivectors. FIG. 5 shows the Cryptotext Multivector 520 as the “sandwich” of geometric products C̅=S̅_{S}M̅S̅_{S}. The coefficients of the Cryptotext Multivector 520 are then concatenated into a base 10 number string, C (524), and transmitted through a user-defined dispatch function 526 over an electronic network/bus communication channel 528.

Destination (506): C (532) is received through a user-defined operation 530 and converted back to the Cryptotext Multivector 536 using the prescribed distribution method 534. The destination 506 computes the multivector inverse of the Shared Secret Multivector and uses this result in the decrypt equations 538 such as M̅=S̅_{S}⁻¹C̅S̅_{S}⁻¹ to recover the Message Multivector 540. The Message Multivector 540 is then converted to a number string and then to plaintext at 542.

F. Symmetric Key Pair Encryption/Decryption from 0-Blade Reduction Operation (FIG. 6) 0-Blade Reduction Operation

In order to increase security to the Geometric Algebra encryption primitives, a pair of symmetric shared secret keys may be used instead of a single shared secret key. The following lists the processes that may be used to generate/extract/obtain the second shared secret multivector (S̅_{S}_{₂}) from the original shared secret numeric value key (S_{S}).
1. The original shared secret numeric value (S_{S}), which may be obtained from a key exchange procedure, such as, but not limited to, the Diffie-Hellman key exchange process, may be used as the first shared secret numeric key of the pair of symmetric shared secret keys;
2. Using a multivector distribution operation, the original shared secret numeric key (S_{S}) may be loaded into a multivector representation, which may be denoted as (S̅_{S}).
3. A 0-Blade Reduction Operation on the original shared secret multivector (S̅_{S}) may be performed in order to extract/generate/obtain a scalar value that is the second shared secret numeric key (S_{S}_{₂});
4. The scalar that results from 0-Blade Reduction Operation, which has been defined as (S_{S}_{₂}), may be loaded into a multivector through another multivector coefficient distribution operation with the resulting multivector being the second shared secret multivector (S̅_{S}_{₂}).

FIG. 6 is a block diagram 600 illustrating generating/extracting/obtaining a second shared secret multivector key (S̅_{S}_{₂}) 612 from the original shared secret multivector (S̅_{S}) 604 for an embodiment. The original shared secret multivector (S̅_{S}) 604 may be used to encrypt and decrypt data as the first shared secret multivector key of a pair of symmetric shared secret multivector keys. For the Geometric Algebra encryption primitive 602, the original shared secret multivector (S̅_{S}) 604 is operated on by the 0-Blade Reduction Operation 606 (S_{S}_{₂}=(S̅_{S}S̅_{S})(S̅_{S}S̅_{S})^{†}). The 0-Blade Reduction Operation 606 results in the scalar value of the second shared secret numeric key (S_{S}_{₂}) 608. A number to multivector coefficient distribution process 610 converts the second shared secret numeric key (S_{S}_{_{z}}) into a second shared secret multivector (S̅_{S}_{₂}) 612. The second shared secret multivector (S̅_{S}_{₂}) may then be used to encrypt and decrypt data as the second shared secret multivector key of a pair of symmetric shared secret multivector keys.

### Geometric Algebra Encryption Primitives

Primitive 1—“Sandwich”/Triple Product

Encryption

The first encryption primitive can be created through a sequence of geometric products using the pair of keys generated via the 0-Blade Reduction Operation (described herein, above) as follows:

C̅=S̅_{S}M̅S̅_{S}_{₂}

Decryption

The decryption process uses the previously defined inverse multivector as follows:

M̅=S̅_{S}⁻¹C̅S̅_{S}_{₂}⁻¹

Numerical Examples for Encryption and Decryption with Doubled Shared-Secret in 3 Dimensions

Let the message multivector M̅ be:

M̅=23+24e₁+19e₂+31e₃+23e₁₂+30e₁₃+21e₂₃+268e₁₂₃

and the original secret multivector S̅_{S} be:

S̅_{S}=29+22e₁+31e₂+28e₃+23e₁₂+17e₁₃+20e₂₃+215e₁₂₃

From the original secret multivector S̅_{S}, create a scalar by applying a 0-Blade Reduction Operation as follows:

scalar=(S̅_{S}S̅_{S})(S̅_{S}S̅_{S})^{†}

scalar=2281454761

Then create the second secret multivector S̅_{S}_{₂} by converting the scalar to a multivector, as follows:

S̅_{S}_{₂}=22+81e₁+45e₂+47e₃+61e₁₂+0e₁₃+0e₂₃+0e₁₂₃

### Geometric Product “Sandwich” or Geometric Triple Product

In order to encrypt the multivector M̅, compute the geometric product “sandwich” as follows:

C̅=S̅_{S}M̅S̅_{S}_{₂}

C̅=−2797319+(−5355930)e₁+(−3496422)e₂+(−3343014)e₃+(−3868508)e₂+(−1313899)e₁₃+1690341e₂₃+1961527e₁₂₃

and recover the message multivector M̅ as follows:

M̅=S̅_{S}⁻¹C̅S̅_{S}_{₂}⁻¹

M̅=23+24e₁+19e₂+31e₃+23e₁₂+30e₁₃+21e₂₃+268e₁₂₃

G. An Unbreakable Primitive Using Geometric Algebra and Arithmetic Functions Example with Secret Sharing and 3D Multivectors

Set Up

A multivector may act as a Geometric Algebra object such that components of multi-dimensions and Clifford k-vectors are present. An example is:

M̅=a₀+a₁ē₁+a₂ē₂+a₃ē₃+a₁₂ē₁₂+a₂₃ē₂₃+a₃₁ē₃₁+a₁₂₃ē₁₂₃

which shows the components:
a₀⇒scalar—known as 0-blade or 0-vector
a₁ē₁+a₂ē₂+a₃ē₃⇒3D vector or 1-blade or vector
a₁₂ ē₁₂+a₂₃ē₂₃+a₃₁ē₃₁⇒2-blade or bi-vector
a₁₂₃ē₁₂₃⇒3-blade or tri-vector

A typical, but not the only, arithmetic function used for secret sharing is the Diffie-Hellman function, which is based on cyclic groups with element g; for example:

S_{S}=g^{ab} mod p

where S_{S} is a shared secret which can be used by both the source and destination sides and where the operation g^{ab} mod p yields S_{S}. This is standard in the cyber security field.

### Unbreakable Primitive

Given a message M, distribute the numerical content of M over a multivector M̅. For example, let M be represented as below:

M=m₁,m₂,m₃ . . . mₙ

such that mᵢ is a number that constitutes a placed integer value for a coefficient. Then:

M̅=m₀+m₁ē₁+m₂ē₂+m₃ē₃+m₄ē₁₂+m₆ē₂₃+m₇ē₁₂₃

Note that other multivector variations are also possible.

The shared secret S_{S} is changed to a multivector in the same or a similar manner, such as:

S_{S}=s₁₁,s₁₂,s₁₃ . . . s₁ₙ

S̅_{S}=s₁₀+s₁₁ē₁+s₁₂ē₂+s₁₃ē₃+s₁₄ē₁₂+s₁₅ē₁₃+s₁₆ē₂₃+s₁₇ē₁₂₃

An operation known as “0-Blade Reduction” creates a new scalar from S̅_{S} as a second shared secret S_{S}_{₂}, where:

Sₛ_{₂}=(S̅_{S}S̅_{S})(S̅_{S}S̅_{S})^{†}=scalar

Then S_{S}_{₂} is converted to a multivector, for example:

S̅ₛ_{₂}=s₂₀+s₂₁ē₁+s₂₂ē₂+s₂₃ē₃+s₂₄ē₁₂+s₂₅ē₁₃+s₂₆ē₂₃+s₂₇ē₁₂₃

Finally, the multivector-based “sandwich”/triple product equation may be used to create a cipher. Thus, the cryptotext multivector C is:

C̅=S̅_{S}M̅S̅_{S}_{₂}

because Sₛ_{₂} is a result of a one-way function and S_{S} is a shared secret, which, when operated on by the 0-Blade Reduction Operation (which may sometimes be referenced herein as the function Z_{b} ( )) becomes a new result embedding a new one-way function.

Up to this point the encryption may have susceptibility to a pair of known cryptotext attacks. However, as shown in part below, the final unbreakability has been achieved.

Encryption Primitives with Unbreakable Cipher:

Primitive—“Sandwich”/Triple Product

Encryption

The first encryption primitive may be created through a sequence of geometric products using the pair of keys generated via the 0-Blade Reduction Operation (described above) as follows:

C̅=S̅_{S}M̅S̅_{S}_{₂}

In order to add another layer of security to the cipher text C̅ and guarantee unbreakability against standard cipher analysis, such as the known plain-text attack, it may be helpful to do the following:
The cipher text, originally in multivector form, is converted to a number C′

$$\overline{C} {}^{multivector to number} {C}^{′}$$

yielding a ‘pre-cipher’ which is denoted here as C′.
Then ‘mask’ this pre-cipher C′ by performing an XOR operation with the shared secret S_{S}

C=C′ XOR S_{S}
to obtain the final cipher/crypto text C, which is sent to a destination computing device.

Decryption

The decryption process may comprise the following steps:
Receive the cryptotext C at the destination computing device.
Recover the pre-cipher cryptotext C′ from the cryptotext C using the shared secret S_{S}, as follows:

C′=C XOR S_{S}
Convert C′ into a multivector yielding the cryptotext multivector C̅:

$${C}^{′} {}^{multivector \_ to \_ number} \overline{C}$$

Recover the message multivector M̅ making use of the inverse multivectors with respect to S̅_{S} and S̅ₛ_{₂}

M̅=S̅_{S}⁻¹C̅S̅_{S}_{₂}⁻¹

Note that a solution for higher dimensions requires a different formula. Further note that if the original shared secret (S_{S}) is generated using an encrypted/secure key exchange, such as, but not limited to the Diffie-Hellman process discussed in more detail herein, there is no transmission of the original shared secret multivector (S̅_{S}) and, consequently, no transmission of the second shared secret multivector (S̅_{S}_{₂}). Still further note that since the second shared secret multivector (S̅_{S}_{₂}) is a result of a one-way function, the use of the second shared secret multivector (S̅_{S}_{₂}) in either of the Geometric Algebra encryption primitive operations above, further guarantees security. Ultimately, as best as can be ascertained, there is no feasible way or high computer power to find S_{S}, Sₛ_{₂} or sequences of such, which can be also dynamically updated in a continuous fashion using other Geometric Algebra operations to further increase security.

### Section 3: Homomorphic EDCHE Enhancements to EDCE Operation

EDCHE is an extension to the EDCE cryptosystem described in more detail in Sections 1 and 2 above. The extension to support homomorphic operations requires additional considerations, particularly in the organization of the data message multivector coefficients, but, for the most part, the extension to support homomorphic operations relies on the intrinsic algebraic homomorphism of the Geometric Algebra foundation that are part of the encryption/decryption functions of the core EDCE. For instance, the Geometric Algebra geometric product operations that perform the actual encryption and decryption operations remain the same for both EDCE and EDCHE embodiments. The handling of the security keys also remains the same for both EDCE and EDCHE embodiments, including the data organization for “number to multivector” operations and any restrictions thereon. Likewise, any operations to convert text to a number and/or operations to convert a number also remain the same for both EDCE and EDCHE embodiments. The choice of whether or not to convert a cryptotext multivector (C̅) into cryptotext numeric data (C) prior to transmitting the encrypted data to a destination system (or to an intermediary system along the path to the final destination) remains the same for both EDCE and EDCHE embodiments and the processes to convert between cryptotext multivector (C̅) and cryptotext numeric data (C) also remain the same between EDCE and EDCHE, except there may be some restrictions on the types of permissible operations allowed for EDCHE embodiments to ensure that an intermediary computing system operating on the encrypted data does not need knowledge of any security keys involved in the encryption/decryption process. Even the data organization for “number to multivector” and “multivector to number” operations share the core EDCE restrictions between EDCE and EDCHE embodiments, the EDCHE embodiments add further restrictions that the data organization preserves homomorphic properties (i.e., have a homomorphic preserving mathematical relationship between the vectors utilized in the encryption process and the original plaintext messages being encrypted). Accordingly, since an EDCHE embodiment simply adds restrictions to an EDCE system regarding data organization operations for the multivector representation of the data being encrypted as well as to conversions between a cryptotext multivector (C̅) and a cryptotext numeric data (C), EDCHE embodiments being a subset of EDCE embodiments may operate as EDCE embodiments, but EDCE embodiments may not all necessarily operate as EDCHE embodiments.

Potential homomorphic encryption operations for an EDCHE embodiment may include multiple operations, such as, but not limited to: encrypted addition/subtraction, scalar addition/subtraction, encrypted multiplication, scalar multiplication, encrypted searching, and encrypted sorting. Each of the potential homomorphic encryption operations involves operations particular to the particular operation. For this reason, separate disclosures for each particular operation may be presented to so as to make the clear the specific details comprising the implementation of each particular operation. An additional document that briefly presents the combination of the potential homomorphic operations may also be separately presented that provides a brief summary of each operation and provides the additional details for performing combinations of the potential encryption operations. In view of potential disclosures, this particular disclosure is intended to address the specific details that comprise the particular details of homomorphic encryption searching operations.

The description of EDCHE below will typically use the term “source” for the entity (e.g., computing device/system) where numeric values that are to be available for homomorphic searches originate and “destination” for the entity (e.g., computing device/system) that receives the result of the homomorphic search operation. The term “intermediary” will typically define the “intermediate” entity acting in between the source(s) and destination on the encrypted numeric value operands originated at the source entity(ies). The term “search request” will typically define the “search request” entity commanding the “intermediary” entity to search the encrypted values stored by the “intermediary entity.” Alternatively, the term “client” may be used to describe the owner of the operand, the issuer of the search request, and/or the receiver of search result data (i.e., the source, search request, and/or destination computing device/system), while the generic term “cloud” may be used for data that is at rest in an untrusted environment (i.e., the intermediary computing system/device). In some respects, the terms “client” and “cloud” may more closely reflect a real-world application where the source, search request, and destination are the same entity, sending data to the intermediary “cloud” for storage, then requesting an operation (e.g., a search of stored data stored in encrypted format on the cloud) from the cloud when needed by the client. Ultimately, the terms source, destination, search request, and intermediary reflect the relative operations being performed by a computing system/device, and do not necessarily define the computing system/device as whole. Thus, the source, search request, destination, and intermediary operations/systems may reside as a particular application on one or more computing systems/devices. As the source, search request, destination, and intermediary computing systems/devices may be general-purpose computing systems capable of running multiple applications at the same time, it is inherently possible that the source, search request, destination, and intermediary operations are encapsulated as separate applications/functions that may permit, one, two, three, or all of the separate applications/functions to run on a single computing device/system. Also, a single interconnected computer system of a single owner/client may have untrusted environments that include data that is at rest (i.e., stored) in the owner/client's own end-point devices outside of the owner/client's digital secure perimeter such that it is beneficial to store the data in the untrusted environment of a single computing system in encrypted format even though other environments on the same computer system/device may properly handle secured information in unencrypted format.

To assist the reader in locating information, the arrangement of the remainder of the Section 3 disclosure below may be summarized as follows:
A. Homomorphic Data Organization (i.e., Coefficient Distribution/“Packing”)
B. Number to multivector that supports Homomorphism
   First example
   Second example
   Third example
C. Multivector to number that supports Homomorphism
   First example
   Second example
   Third example
D. Search Homomorphism in EDCHE
   Mathematical Explanation of Multiplicative Homomorphic Property of EDCE as Applied for Searching:
   Homomorphic Searching Example Using EDCE (Report Example)
E. Hardware Implementation for Homomorphic Searching EDCHE Embodiments (FIG. 7)
F. Homomorphic Searching EDCHE Operational Flow Charts (FIGS. 8 & 9A-C)

### A. Homomorphic Data Organization (i.e., Coefficient Distribution/“Packing”)

In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” (i.e., distributed) into multivector coefficient elements should necessarily maintain some mathematical representation of the original number. Consequently, the packing/distribution method may define, among many things, the Geometric Algebra operations permissible for an EDCHE embodiment. For example, the Rationalize operation on multivectors yields zero when all multivector coefficients are equal. Such multivectors having all equal coefficients have no inverse and the geometric product of such multivectors having all equal coefficients with another multivector has no inverse. As discussed in Sections 1 and 2 above, the decryption methodology for EDCE and EDCHE systems utilize the inverse of the cryptotext multivector being decrypted and of the security key(s) multivector to perform the decryption. Therefore, the cryptotext multivector being decrypted should not have all equal value coefficients. One means to ensure that the cryptotext multivector being decrypted does not have all equal value coefficients is to have the packing/coefficient distribution method ensure that not all coefficients are equal to each other (i.e., at least one coefficient should be different than the other coefficients) when creating the shared security multivector(s) and the data message multivectors. For an embodiment of the EDCE that simply transfers the data message, this will ensure that the cryptotext multivector to be decrypted will not have all equivalent coefficients. For an EDCHE system that may perform operations involving multiple encrypted data values, the same packing/coefficient distribution method to ensure that the source message multivectors do not have all equivalent coefficients will minimize the potential for the cryptotext multivector being decrypted from having all equivalent coefficients.

For an embodiment of an EDCHE system, the methods and systems that encrypt and decrypt messages using Geometric Algebra may utilize the intrinsic algebraic homomorphic properties of Geometric Algebra to permit arithmetic and other comparative operations on encrypted messages handled by an intermediary computing system without the need for the intermediary computing system to decrypt the encrypted messages prior to performing the arithmetic and other comparative operations. Accordingly, the intermediary computing system does not need to know any information regarding any of the secret security keys of the encryption/decryption processes to properly perform the arithmetic and other comparative operations. The encrypted results of the arithmetic and other comparative operations performed by the intermediary computing system, when decrypted at a destination computing device, produce results equivalent to the same operations as if the operations were performed on the unencrypted plain text messages. In order to properly achieve the homomorphic effect for intermediary arithmetic and other comparative operations, a proper data organization methodology (i.e., packing/distributing coefficients into a multivector) that preserves such homomorphic properties (i.e., the mathematical relationship between the vectors utilized in the encryption process and the original plaintext messages being encrypted) should be enforced on the choice of coefficients for the vectors representing the plain text messages. Homomorphism in the EDCHE is built upon the commutative nature of the Geometric Algebra operations of the encryption and decryption principles described above in Sections 1 and 2 for EDCE embodiments. Therefore, the distribution/packing data arrangement should also preserve a commutative mathematical relationship to the original numeric value being encrypted. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value (i.e., the homomorphic preserving mathematical relationship). The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway. Ensuring that the coefficients of the vector representation of the plaintext numeric message meet the above described definition of the homomorphic preserving mathematical relationship will provide the proper commutative data organization (i.e., packing/distributing) methodology that preserves the homomorphic properties of the Geometric Algebra operations of the core EDCE encryption/decryption processes. Due to the use of the proper commutative data organization, an embodiment of an EDCHE system provides a cryptosystem that allows unlimited multiplications and additions of cipher text (i.e., transmitted/stored encrypted messages at the intermediary/cloud computer system) due solely to the intrinsic algebraic homomorphic properties of an embodiment of the EDCHE system. Thus, an embodiment of an EDCHE system may provide the homomorphic properties as a product of algebraic homomorphism without the need to use additional methods, such as “bootstrapping” (e.g., performing a recursive operation to reduce the noise associated with a cipher text) to achieve the homomorphic properties.

B. Number to Multivector that Supports Homomorphism

As described above, in order to preserve homomorphism, a “number to multivector” paradigm where the “packed” multivector that represents the original plaintext numeric message has a mathematical relationship (i.e., the homomorphic preserving mathematical relationship) to the original plaintext numeric message preserves the homomorphic characteristics of the Geometric Algebra operations of EDCE encryption/decryption operations. In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value. The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway. For an example three dimensional multivector there are eight possible coefficients in the multivector representation (i.e., c₀, c₁, c₂, c₃, c₁₂, c₁₃, c₂₃, and c₁₂₃, numbered so as to correspond with the unit vector associated with each coefficient). In an example homomorphic preserving mathematical relationship that includes both addition and subtraction, if the coefficients for the e₂ and e₁₂ unit vectors (i.e., c₂ and c₁₂) are subtracted in the calculation of the homomorphic preserving mathematical relationship for a first numeric data message conversion to a multivector, all other numeric messages converted to a message vector should also ensure that the c₂ and c₁₂ coefficients are subtracted in the conversion homomorphic preserving mathematical relationship process. Likewise, when converting a multivector into a numeric value, the homomorphic preserving mathematical relationship process should also retain the subtraction of the c₂ and c₁₂ coefficients. Other than the location of additions and subtractions within the homomorphic preserving mathematical relationship of the coefficients, the actual values of the coefficients may be selected as desired by a user so long as the homomorphic preserving mathematical relationship equals the original numeric value being encrypted. The only other restriction for multivectors representing different numeric values within a homomorphic operation is that the multivectors all share the same dimensionality (i.e., all multivectors are 2D, all multivectors are 3D, all multivectors 4D, etc.). One skilled in the art will recognize that there are many, perhaps even an infinite, number of ways to select coefficient values that meet the stated criteria/restrictions and that each of those ways will create a satisfactory EDCHE embodiment so long as the stated criteria/restrictions are, in fact, met.

Some processes are common within each multivector coefficient selection process. For instance, the first step in representing a numeric message value in a multivector is to define the number of coefficients that are present in the multivector. The total number of coefficient elements of a multivector is directly related to the dimensionality of the multivector by the equation n=2^{m} where n is the total number of coefficient elements and m is equal to the dimensionality of the multivector (e.g., for a 3D multivector n=2³=8). Thus, in order to represent the numeric message N in a 3D multivector, the total number of coefficient elements to be determined is eight.

The coefficient selections may encompass any number that may be represented in the data type chosen by a system designer to hold the coefficient values, including, but not limited to: positive numbers, negative numbers, zero, integer numbers, rational numbers (including fractions), and/or real numbers. As a base of understanding, the format of a multivector will always assume that the coefficients add together. For instance, the form for a 3D multivector representing the numeric value N would be:

multivector N=c₀+c₁e₁+c₂e₂+c₃e₃+c₁₂e₁₂+c₁₃e₁₃+c₂₃e₂₃+c₁₂₃e₁₂₃

Subtractions would be represented as negative coefficients. This “form” of the multivector coefficients adding together would remain consistent regardless of whether or not the corresponding coefficient is added or subtracted in the homomorphic preserving mathematical relationship between the original numeric value and the coefficients of the representative multivector.

Below are several examples of processes to automate or otherwise demonstrate methodology for the selection of coefficient values for a message multivectors that represents a numeric message value N. One skilled in the art will again recognize that many ways to select the coefficient values that meet the stated criteria/restrictions and that embodiments are not limited to the example methodologies described herein.

### First Example

In this first example, the EDCHE embodiment performs the homomorphic preserving mathematical relationship process such that all coefficients are added together and there are not any coefficients that are subtracted. A first step might be to factorize the numeric message N and write the value N as a sum of other numbers (cᵢ) that are to represent the numeric message value in a message multivector such that:

$$N = {\sum }_{i = 0}^{n - 1} {c}_{i}$$

where n is the number of elements in the multivector as determined by n=2^{m} where m is the dimension of the multivector. (e.g., n=8 for a 3D multivector). One skilled in the art will recognize that at this point there are many ways to assign the coefficient values (c) that will satisfy the homomorphic preserving mathematical relationship equation to enable proper operation of an EDCHE embodiment. One such method might be to perform an integer division of N by the number of elements n. Given the numeric value N=5487 and a 3D multivector where n=8, the result is 5487 integer division by 8, which is equal to 685. The remainder may be obtained by calculating N mod n (i.e., 5487 mod 8), which may be added to the last coefficient, resulting in a last coefficient value (i.e., c₁₂₃) of 685+7, which equals 692. The sum may then be written as:

N=c₀+c₁+c₂+c₃+c₁₂+c₁₃+c₂₃+c₁₂₃

5487=685+685+685+685+685+685+685+692

and the resulting multivector representing the numeric value N would be:

multivector N=c₀+c₁e₁+c₂e₂+c₃e₃+c₁₂e₁₂+c₁₃ e₁₃+c₂₃e₂₃+c₁₂₃e₁₂₃

multivector N=685+685e₁+685e₂+685e₃+685e₁₂+685e₁₃+685e₂₃+692e₁₂₃

The assignment of which coefficient value receives the addition of the N mod n operation may be random, or the assignment may be of a predetermined form designed to increase entropy to enhance the encryption security.

In the case where the numeric value is divisible by the number of coefficient elements n of the message multivector (i.e., N mod n=0 such that all cᵢ are equal, which is not permitted for proper decryption operation), a number less than the value of one coefficient element (e.g., c₁₃) may be subtracted from that coefficient element (e.g., again c₁₃) and added to another coefficient element (e.g., c₂₃). For example, given N=2944 for a 3D multivector where n=8, 2944 may be integer divided by 8 to equal 386 with no remainder. An embodiment may then simply subtract one from c₁₃ and add one to c₂₃ to ensure that not all coefficient elements are equal such that the homomorphic preserving mathematical relationship may then be written as:

N=c₀+c₁+c₂+c₃+c₁₂+c₁₃+c₂₃+c₁₂₃

2944=368+368+368+368+368+367+369+368

and the resulting multivector representing the numeric value N would be:

multivector N=c₀+c₁e₁+c₂e₂+c₃e₃+c₁₂e₁₂+c₁₃e₁₃+c₂₃e₂₃+c₁₂₃e₁₂₃

multivector N=368+368e₁+368e₂+368e₃+368e₁₂+367e₁₃+369e₂₃+368e₁₂₃

### Second Example

As with the first example, the EDCHE embodiment performs the homomorphic preserving mathematical relationship process such that all coefficients are added together and there are not any coefficients that are subtracted. Thus, for a 3D multivector with coefficients c₀, c₁, c₂, c₃, c₁₂, c₁₃, c₂₃, and c₁₂₃, where the coefficients are numbered so as to correspond with the unit vector associated with each coefficient, the homomorphic preserving mathematical relationship equation to represent the numeric value N would, again, be:

N=c₀+c₁+c₂+c₃+c₁₂+c₁₃+c₂₃+c₁₂₃

Instead of having a strict equation to follow, an algorithm that randomly finds integers that satisfy the sum of integers equation may be created. To ensure that the coefficients add up to the numeric value N, the random number for each coefficient element may be serially (i.e., successively) calculated with the random number restricted to be some amount less than the remaining sum in order to achieve the numeric value N until the last coefficient value calculated is set equal to the remaining amount in order to achieve the numeric value N. For such a random number based system, given that N is again 5487, the homomorphic preserving mathematical relationship may be written as:

N=c₀+c₁+c₂+c₃+c₁₂+c₁₃+c₂₃+c₁₂₃

5487=385+985+685+584+786+482+887+693

and the resulting multivector representing the numeric value N would be:

multivector N=c₀+c₁e₁+c₂e₂+c₃e₃+c₁₂e₁₂+c₁₃ e₁₃+c₂₃e₂₃+c₁₂₃e₁₂₃

multivector N=385+985e₁+685e₂+584e₃+786e₁₂+482e₁₃+887e₂₃+693e₁₂₃

### Third Example

Unlike the first two examples, in this third example the homomorphic preserving mathematical relationship equation that is set equal to the numeric value N may be defined to include some subtraction of some coefficients, addition of a constant value, and multiplication of coefficient values by a constant, as well as the omission of one of the coefficients (i.e., c₁₂₃) from the homomorphic preserving mathematical relationship. In this third example, the homomorphic preserving mathematical relationship equation to represent the numeric value N might now be:

N=c₀+c₁−c₂+c₃−c₁₂+3*c₁₃+c₂₃+23

A modified version of the methodology of either the first example (use a mathematical equation to calculate the coefficient values) or the second example (randomly generated coefficient values) described above may be used to determine the coefficient values given that the homomorphic preserving mathematical relationship now subtracts some coefficients, adds a constant, multiplies a coefficient by a constant, and omits one coefficient from the homomorphic preserving mathematical relationship altogether. Using randomly generated numbers, and given that N is again 5487, the homomorphic preserving mathematical relationship may be written as:

N=c₀+c₁−c₂+c₃−c₁₂+3*c₁₃+c₂₃+23

5487=(901)+(985)−(185)+(−584)−(286)+3*(882)+(1987)+23

5487=901+985−185−584−286+2646+1987+23

and the resulting multivector representing the numeric value N would be:

multivector N=c₀+c₁e₁+c₂e₂+c₃e₃+c₁₂e₁₂+c₁₃e₁₃+c₂₃e₂₃+c₁₂₃e₁₂₃

multivector N=(901)+(985)e₁+(185)e₂+(−584)e₃+(286)e₁₂+(882)e₁₃+(1987)e₂₃+333e₁₂₃

multivector N=901+985e₁+185e₂−584e₃+286e₁₂+882e₁₃+1987e₂₃+333e₁₂₃

where the c₁₂₃ value of 333 is a dummy value not included in the homomorphic preserving mathematical relationship, but may potentially be used to provide other features such as signature capability and/or passing of command or other information.

A homomorphic preserving mathematical relationship that includes some subtractive elements has the advantage of being able to represent negative numbers and zero without the coefficient values being negative for a user that prefers to not have negative coefficient values.

C. Multivector to Number that Supports Homomorphism

Obtaining a numeric value from the coefficients of a numeric data message multivector is relatively simple and straight forward. To obtain the numeric data message value, simply perform the homomorphic preserving mathematical relationship equation for the numeric data message multivector using the values of the multivector coefficients plugged into the homomorphic preserving mathematical relationship equation. The examples given below provide the “multivector to number” process appropriate for the same example number as described above for the “number to multivector” process.

### First Example

In the first example above, the EDCHE embodiment performed the homomorphic preserving mathematical relationship process such that all coefficients are added together and there are not any coefficients that are subtracted. Thus, for a 3D multivector with coefficients c₀, c₁, c₂, c₃, c₁₂, c₁₃, c₂₃, and c₁₂₃, where the coefficients are numbered so as to correspond with the unit vector associated with each coefficient, the homomorphic preserving mathematical relationship equation to represent the result numeric value N would be:

N=c₀+c₁+c₂+c₃+c₁₂+c₁₃+c₂₃+c₁₂₃

As described above, the multivector has the form of:

multivector N=c₀+c₁e₁+c₂e₂+c₃e₃+c₁₂e₁₂+c₁₃ e₁₃+c₂₃e₂₃+c₁₂₃e₁₂₃

Now, given the following result multivector,

multivector N=725+21e₁+685e₂+286e₃−721e₁₂+85e₁₃+601e₂₃+192e₁₂₃

and knowing the multivector of the form:

multivector N=c₀+c₁e₁+c₂e₂+c₃e₃+c₁₂e₁₂+c₁₃e₁₃+c₂₃e₂₃+c₁₂₃e₁₂₃

then the result multivector may be rewritten to highlight the appropriate positive and negative values as:

(725)+(21)e₁+(685)e₂+(286)e₃+(−721)e₁₂+(85)e₁₃+(601)e₂₃+(192)e₁₂₃

and the calculation of the result numeric value N would proceed as follows:

N=c₀+c₁+c₂+c₃+c₁₂+c₁₃+c₂₃+c₁₂₃

N=(725)+(21)+(685)+(286)+(721)+(85)+(601)+(192)

N=725+21+685+286+721+85+601+192

such that result numeric value N would be:

N=3316

Now, given a different result multivector that includes some negative coefficients, such as the following vector:

333−201e₁+248e₂+506e₃−71e₁₂+80e₁₃+211e₂₃−743e₁₂₃

and knowing the result multivector with the given homomorphic preserving mathematical relationship equation is of the form:

multivector N=c₀+c₁e₁+c₂e₂+c₃e₃+c₁₂e₁₂+c₁₃e₁₃+c₂₃e₂₃+c₁₂₃e₁₂₃

then the result multivector may be rewritten to highlight the appropriate positive and negative values as:

(333)+(−201)e₁+(248)e₂+(506)e₃+(−71)e₁₂+(80)e₁₃+(211)e₂₃+(−743)e₁₂₃

and the calculation of the result numeric value N would proceed as follows:

N=c₀+c₁+c₂+c₃+c₁₂+c₁₃+c₂₃+c₁₂₃

N=(333)+(−201)+(248)+(506)+(−71)+(80)+(211)+(−743)

N=333−201+248+506−71+80+211−743

such that result numeric value N would be:

N=363

### Second Example

In the second example above, the EDCHE embodiment performed the homomorphic preserving mathematical relationship process such that all coefficients are added together and there are not any coefficients that are subtracted, which is the same homomorphic preserving mathematical relationship equation as for the first example above. Consequently, the “multivector to number” process is identical to that as described for the “multivector to number” process of the first example given above.

### Third Example

In the first and second example above, the EDCHE embodiment performed the homomorphic preserving mathematical relationship process such that all coefficients are added together and there are not any coefficients that are subtracted. The third example from above changed the homomorphic preserving mathematical relationship equation to include some subtraction of some coefficients, addition of a constant value, and multiplication of coefficient values by a constant, as well as the omission of one of the coefficients (i.e., c₁₂₃) from the homomorphic preserving mathematical relationship. Thus, for the third example, for a 3D multivector with coefficients c₀, c₁, c₂, c₃, c₁₂, c₁₃, c₂₃, and c₁₂₃, where the coefficients are numbered so as to correspond with the unit vector associated with each coefficient, the homomorphic preserving mathematical relationship equation to represent the numeric value N would again be:

N=c₀+c₁−c₂+c₃−c₁₂+3*c₁₃+c₂₃+23

As described above, the multivector has the form of:

multivector N=c₀+c₁e₁+c₂e₂+c₃e₃+c₁₂e₁₂+c₁₃e₁₃+c₂₃e₂₃+c₁₂₃e₁₂₃

Now, given the same following result multivector as for example 1 above,

multivector N=725+21e₁+685e₂+286e₃−721e₁₂+85e₁₃+601e₂₃+192e₁₂₃

and knowing the multivector is of the form:

multivector N=c₀+c₁e₁+c₂e₂+c₃e₃+c₁₂e₁₂+c₁₃e₁₃+c₂₃e₂₃+c₁₂₃e₁₂₃

then the result multivector may be rewritten to highlight the appropriate positive and negative values as:

multivector N=(725)+(21)e₁+(685)e₂+(286)e₃+(−721)e₁₂+(85)e₁₃+(601)e₂₃+(192)e₁₂₃

and the calculation of the result numeric value N would proceed as follows:

N=c₀+c₁−c₂+c₃−c₁₂₊₃*c₁₃+c₂₃+23

N=(725)+(21)−(685)+(286)−(−721)+3*(85)+(601)+23

N=725+21−685+286+721+255+601+23

such that result numeric value N would be:

N=1947

where the c₁₂₃ value of 192 is ignored as a dummy value not included in the homomorphic preserving mathematical relationship. Note that the third example result of 1947 does not equal the first example result of 3316 for the same result multivector. Thus, demonstrating the necessity of using the same homomorphic preserving mathematical relationship equation for all encrypted multivectors of any homomorphic operations that may involve multiple encrypted multivectors.

Now, given a different result multivector that includes some negative coefficients (that is the same as the negative coefficient result multivector also used for example 1 above), such as the following vector:

multivector N=333−201e₁+248e₂+506e₃−71e₁₂+80e₁₃+211e₂₃−743e₁₂₃

and knowing the result multivector with the given homomorphic preserving mathematical relationship equation is of the form:

multivector N=c₀+c₁e₁+c₂e₂+c₃e₃+c₁₂e₁₂+c₁₃e₁₃+c₂₃e₂₃+c₁₂₃e₁₂₃

then the result multivector may be rewritten to highlight the appropriate positive and negative values as:

multivector N=(333)+(−201)e₁+(248)e₂+(506)e₃+(−71)e₁₂+(80)e₁₃+(211)e₂₃+(−743)e₁₂₃

where the c₁₂₃ value of −743 is a dummy value not included in the homomorphic preserving mathematical relationship. Thus, the calculation of the result numeric value N would proceed as follows:

N=c₀+c₁−c₂+c₃−c₁₂+3*c₁₃+c₂₃+23

N=(333)+(−201)−(248)+(506)−(−71)+3*(80)+(211)+23

N=333−201−248+506+71+240+211+23

such that result numeric value N would be:

N=935

Note again that the third example result of 935 does not equal the first example result of 363 for the same result multivector. Thus, again, demonstrating the necessity of using the same homomorphic preserving mathematical relationship equation for all encrypted multivectors of homomorphic operations that may involve multiple encrypted multivectors.

### D. Search Homomorphism in EDCHE

Homomorphic Encryption Searching may be defined as a search of encrypted data for an unencrypted value without the search request requiring knowledge of the security keys and/or the actual encrypted value of the search for unencrypted value. That is, a search request may be generated by a system based on an unencrypted value and the system may search the encrypted values and locate a stored encrypted value without either the system generating the search request or the system performing the search of stored encrypted values having any knowledge of the encryption security keys.

### Mathematical Explanation of Multiplicative Homomorphic Property of EDCE as Applied for Searching:

Given any multivector Ā, the 0-blade reduction (also known as the Rationalize) of Ā is given by:

$$\begin{matrix}R ( \overline{A} ) = ( \overline{A} \overline{\overline{A}} ) {( \overline{A} \overline{\overline{A}} )}^{†} \\ = \overline{A} \overline{\overline{A}} {\overline{\overline{A}}}^{†} {\overline{A}}^{†}\end{matrix}$$

Using some involution properties, we also have:

(Ā̅B̅)=B̅A̅

and

(ĀB̅)^{†}=B̅^{†}Ā^{†}

Now, given a ciphertext C̅:

C̅=S̅₁ĀS̅₂

we can find the Rationalize of C̅ as follows:

R(C̅)=(S̅₁ĀS̅₂S̅₁̅Ā̅S̅₂̅)(S̅₁ĀS̅₂S̅₁̅Ā̅S̅₂̅)^{†}

By using the involution properties described in the equations above, and letting S̅₁Ā=P̅, we can expand the Rationalize of C̅ equation as:

$$\begin{matrix}R ( \overline{C} ) = ( \overline{P} {\overline{S}}_{2} {\overline{\overline{P} \overline{S}}}_{2} ) {( \overline{P} {\overline{S}}_{2} {\overline{\overline{P} \overline{S}}}_{2} )}^{†} \\ = ( \overline{P} {\overline{S}}_{2} {\overline{\overline{S}}}_{2} \overline{\overline{P}} ) {( {\overline{\overline{P} \overline{S}}}_{2} )}^{†} {( \overline{P} {\overline{S}}_{2} )}^{†} \\ = \overline{P} {\overline{S}}_{2} {\overline{\overline{S}}}_{2} {\overline{\overline{P}} ( {\overline{\overline{S}}}_{2} \overline{\overline{P}} )}^{†} {\overline{S}}_{2}^{†} {\overline{P}}^{†} \\ = \overline{P} {\overline{S}}_{2} {\overline{\overline{S}}}_{2} \overline{\overline{P}} {\overline{\overline{P}}}^{†} {\overline{\overline{S}}}_{2}^{†} {\overline{S}}_{2}^{†} {\overline{P}}^{†}\end{matrix}$$

Replacing P̅ by S̅₁Ā we now have:

R(C̅)=S̅₁ĀS̅₂S̅₂(S̅₁̅Ā̅)(S̅₁̅Ā̅)^{†}S̅₂^{†}S̅₂^{†}(S̅₁Ā)^{†}

Once again, using the involution properties described in the equations above, we can manipulate the Rationalize of C̅ equation as follows:

$$\begin{matrix}R ( \overline{C} ) = {\overline{S}}_{1} \overline{A} {\overline{S}}_{2} {\overline{\overline{S}}}_{2} \overline{\overline{A}} {{\overline{\overline{S}}}_{1} ( \overline{\overline{A}} {\overline{\overline{S}}}_{1} )}^{†} {\overline{\overline{S}}}_{2}^{†} {\overline{S}}_{2}^{†} {\overline{A}}^{†} {\overline{S}}_{1}^{†} \\ = {\overline{S}}_{1} \overline{A} {\overline{S}}_{2} {\overline{\overline{S}}}_{2} \overline{\overline{A}} {\overline{\overline{S}}}_{1} {\overline{\overline{S}}}_{1}^{†} {\overline{\overline{A}}}^{†} {\overline{\overline{S}}}_{2}^{†} {\overline{S}}_{2}^{†} {\overline{A}}^{†} {\overline{S}}_{1}^{†} \\ = {\overline{S}}_{1} \overline{A} {\overline{S}}_{2} {\overline{\overline{S}}}_{2} \overline{\overline{A}} {\overline{\overline{S}}}_{1} {\overline{\overline{S}}}_{1}^{†} {{\overline{\overline{A}}}^{†} ( {\overline{S}}_{2} {\overline{\overline{S}}}_{2} )}^{†} {\overline{A}}^{†} {\overline{S}}_{1}^{†}\end{matrix}$$

Note that S̅₂S̅₂ and (S̅₂S̅₂)^{†} result in a complex-like number, and therefore they commute. Thus, we can rearrange the Rationalize of C̅ equation above as:

R(C̅)=S̅₁ĀA̅S̅₂S̅₂S̅₁S̅₁^{†}A̅^{†}(S̅₂S̅₂)^{†}Ā^{†}S̅₁^{†}

Also note that this Rationalize of C̅ equation has the term ĀA̅ that also results in a complex-like number, so we can use this to continue the rearrangement of the Rationalize of C̅ equation as follows:

$$\begin{matrix}R ( \overline{C} ) = {\overline{S}}_{1} \overline{A} \overline{\overline{A}} {\overline{\overline{S}}}_{1} {\overline{\overline{S}}}_{1}^{†} {\overline{S}}_{2} {\overline{\overline{S}}}_{2} {{\overline{\overline{A}}}^{†} ( {\overline{S}}_{2} {\overline{\overline{S}}}_{2} )}^{†} {\overline{A}}^{†} {\overline{S}}_{1}^{†} \\ = {\overline{S}}_{1} {\overline{\overline{S}}}_{1} {\overline{\overline{S}}}_{1}^{†} \overline{A} \overline{\overline{A}} {\overline{\overline{A}}}^{†} {\overline{S}}_{2} {{\overline{\overline{S}}}_{2} ( {\overline{S}}_{2} {\overline{\overline{S}}}_{2} )}^{†} {\overline{A}}^{†} {\overline{S}}_{1}^{†} \\ = {\overline{S}}_{1} {\overline{\overline{S}}}_{1} {\overline{\overline{S}}}_{1}^{†} \overline{A} \overline{\overline{A}} {\overline{\overline{A}}}^{†} {\overline{S}}_{2} {\overline{\overline{S}}}_{2} {\overline{A}}^{†} {{\overline{S}}_{1}^{†} ( {\overline{S}}_{2} {\overline{\overline{S}}}_{2} )}^{†} \\ = {\overline{S}}_{1} {\overline{\overline{S}}}_{1} {\overline{\overline{S}}}_{1}^{†} \overline{A} \overline{\overline{A}} {\overline{\overline{A}}}^{†} {\overline{A}}^{†} {\overline{S}}_{1}^{†} {\overline{S}}_{2} {{\overline{\overline{S}}}_{2} ( {\overline{S}}_{2} {\overline{\overline{S}}}_{2} )}^{†}\end{matrix}$$

We can simplify Rationalize of C̅ equation by using the original Rationalize equation and rewrite Rationalize of C̅ equation as:

R(C̅)=S̅₁S̅₁S̅₁^{†}R(Ā)S̅₁^{†}R(S̅₂)

Since R(Ā) is a scalar, we can reorganize Eq. (12) as

R(C̅)=S̅₁S̅₁S̅₁^{†}S̅₁^{†}R(Ā)R(S̅₂)

And finally we obtain a multiplicative homomorphic relationship between the Rationalize of the ciphertext R(C̅) and the rationalize of the plaintext R(Ā) as follows:

R(C̅)=R(S̅₁)R(Ā)R(S̅₂)

Assuming the Rationalize of the security keys (R(S̅₁) and R(S̅₂)), then the Rationalize of the ciphertext (R(C̅)) should be evenly divisible by the Rationalize of the plaintext (R(Ā)). Accordingly, a modulus function on the Rationalize of the ciphertext (R(C̅)) by the Rationalize of the plaintext (R(Ā)) will be zero if the ciphertext (C̅) is an encrypted form of the plaintext (Ā) and non-zero if the ciphertext (C̅) is not an encrypted form of the plaintext (Ā). Thus, a system may use this relationship to establish that a ciphertext (C̅) of the plaintext (Ā) is FOUND when the modulus result is zero, and that a ciphertext (C̅) of the plaintext (Ā) is NOT-FOUND when the modulus result is non-zero.

The above description is for encryption utilizing two security keys (S̅₁ and S̅₂) geometric product “sandwich” Geometric Algebra geometric product operations (C̅=S̅₁M̅S̅₂) for the encryption process. Similar mathematical proofs may also be described for other Geometric Algebra geometric product operations, including single security key Geometric Algebra geometric product operations of a geometric product (C̅=M̅S̅_{S}) of the message multivector (M̅) and the shared secret multivector (S̅_{S}) and a single key geometric product “sandwich” (C̅=S̅_{S}M̅S̅_{S}). Encryption using Sylvester's equation (C̅=S̅_{S}M̅+M̅S̅_{S}) (see also, the “Appendix” below for additional information) may require some modifications in order to work consistently with the mathematics of the system described herein, and, is, accordingly, not addressed in this document, but may be addressed in an additional disclosure document.

Numerical Example of the Multiplicative Homomorphic Property of EDCE as Applied for Searching:

Given the following secret multivectors:

S̅₁=3+2ē₁+4ē₂+8ē₃+5ē₁₂+7ē₁₃+3ē₂₃+6ē₁₂₃

S̅₂=11+5ē₁+3ē₂+15ē₃+4ē₁₂+17ē₁3+2ē₂₃+1ē₁₂₃

And the following plaintext message multivector:

M̅=16+16ē₁+16ē₂+16ē₃+16ē₁₂+16ē₃+16ē₂₃+22ē₁₂₃

The Rationalize of the above multivectors as calculated by applying the original Rationalize equation to each individual multivector is:

R(S̅₁)=784

R(M̅)=88848

R(S̅₂)=29156

With the final relationship from above, we have:

R(C̅)=R(S̅₁)R(M̅)R(S̅₂)

R(C̅)=784*88848*29156

R(C̅)=2030914593792

In order to provide one more proof of the above statement, we can calculate R(C̅) by applying the original Rationalize equation as follows:

R(C̅)=(C̅C̅)(C̅C̅)^{†}=2030914593792

As the Rationalize of the ciphertext (R(C̅)) is equal to 2030914593792 for both calculations, the example calculation shows that derived relationship is valid.

It is also clear that the Rationalize of the ciphertext (R(C̅)) is a whole multiple (i.e., multiplied by the Rationalize of the first and second security keys, 784 and 29156) such that the modulus of the Rationalize of the ciphertext (R(C̅)) (i.e., 2030914593792) by the Rationalize of the message (R(M̅)) (i.e., 88848) will have a zero, or FOUND result.

### Homomorphic Searching Example Using EDCE (Report Example):

With the understanding of the mathematical basis for homomorphic searching described above it is worthwhile to go through an example of how a homomorphic search may be performed. In the following example, Alice stores some reports on the “cloud” (i.e., intermediary computing system) and later wishes to search to see if she has saved the reports to the cloud in the past. Given the following secret multivectors:

S̅₁=3+2ē₁+4ē₂+8ē₃+5ē₁₂+7ē₁₃+3ē₂₃+6ē₁₂₃

S̅₂=11+5ē₁+3ē₂+15ē₃+4ē₁₂+17ē₁₃+2ē₂₃+1ē₁₂₃

Alice receives the following reports and wishes to store them in the cloud. The following are examples of the plaintext reports (in vector form already) the Alice may receive.

R̅₁=67961+67961ē₆+67961ē₂+67961ē₃+67961ē₁₂+67961ē₁₃+67961ē₂₃+67962ē₁₂₃

R̅₂=121928+121928ē₁+121928ē₂+121928ē₃+121928ē₁₂+121928ē₁₃+121928ē₂₃+121935ē₁₂₃

R̅₃=19334+19334ē₁+19334ē₂+19334ē₃+19334ē₁₂+19334ē₁₃+19334ē₂₃+19335ē₁₂₃

R̅₄=54017+54017ē₁+54017ē₂+54017ē₃+54017ē₁₂+54017ē₁₃+54017ē₂₃+54018ē₁₂₃

R̅₅=45980+45980ē₁+45980ē₂+45980ē₃+45980ē₁₂+45980ē₁₃+45980ē₂₃+45985ē₁₂₃

The above reports will then be encrypted by Alice at her computing device (acting as the source computing device) by applying the triple product (i.e., “sandwich”) technique as follows:

C̅₁=S̅₁R̅S̅₂

C̅₂=S̅₁R̅₂S̅₂

C̅₃=S̅₁R̅₃S̅₂

C̅₄=S̅₁R̅₄S̅₂

C̅₅=S̅₁R̅S̅₂

which will generate:

C̅₁=−8427270−6796150ē₁+32621374ē₂−16582672ē₃+36427198ē₁₂−15495282ē₁₃+7067934ē₂₃+17398040ē₁₂₃

C̅₂=−15119814−12193150ē₁+58526098ē₂−29751748ē₃+65354122ē₁₂−27800802ē₁₃+12680442ē₂₃+31213736ē₁₂₃

C̅₃=−2397522−1933450ē₁+9280414ē₂−4717684ē₃+10363126ē₁₂−4408326ē₁₃+20107262ē₃+4949528ē₁₂₃

C̅₄=−6698214−5401750ē₁+25928254ē₂−13180336ē₃+28953214ē₁₂−12316050ē₁₃+56177582ē₂₃+13828376ē₁₂₃

C̅₅=−5702050−4598250ē₁+22070870ē₂−11220060ē₃+24645790ē₁₂−10484310e₁₃+4781870ē₂₃+11771000ē₁₂₃

All of the above encrypted reports are then sent by Alice (acting as the source computing device) to the cloud (acting as the intermediary computing system).

Now, Alice wants to perform a very basic search. After a while, she wants to know if the report R̅₃ is in the cloud and if it is, she would like to retrieve it. To start the homomorphic search, Alice (acting as the search request computing device) will send a search request to the cloud (i.e., intermediary computing system) including the Rationalize of R̅₃. So, Alice will need to calculate the Rationalize of R̅₃ on her computing device (i.e., the search request computing device) that is preparing the search request, which is a 0-blade reduction operation and is calculated as follows:

R(R̅₃)=(R̅₃R̅₃̅)(R̅₃R̅₃̅)^{†}=2990505785

Alice (acting as the search request computing device) sends R(R̅₃), as part of a search request, to the cloud (i.e., intermediary computing system). Since Alice desires to receive the encrypted report, Alice will define in the search request that the cloud send any FOUND result back to her as the destination. If desired, Alice could designate another system as the destination for any search results of the cloud. The cloud (i.e., intermediary computing system), after receiving the search request from Alice, then calculates the Rationalize of all encrypted reports stored at the cloud as follows:

R(C̅₁)=(C̅₁C̅₁̅)(C̅₁C̅₁̅)^{†}=844610950068165952

R(C̅₂)=(C̅₂C̅₂̅)(C̅₂C̅₂̅)^{†}=133213867806324988480

R(C̅₃)=(C̅₃C̅₃̅)(C̅₃C̅₃̅)^{†}=68357890347288640

R(C̅₄)=(C̅₄C̅₄̅)(C̅₄C̅₄̅)^{†}=533579250300437824

R(C̅s₅)=(C̅₅C̅₅̅)(C̅₅C̅₅̅)^{†}=9665749752287720000

In order to match the R(R̅₃) sent by Alice and the Rationalizes calculated by the cloud (i.e., intermediary computing system), the cloud will perform the following verification:

R(C̅ᵢ)mod R(R̅ᵢ)=0

Consequently, the cloud will calculate the Rationalize of the encrypted data “mod” the Rationalize sent by Alice as part of the search request. When the result is 0, the cloud will know that the data Alice wants is FOUND, and will send the encrypted data back to Alice (now acting as the destination computing device).

R(C̅₁)mod R(R̅₃)=2824976382

R(C̅₂)mod R(R̅₃)=2780935310

R(C̅₃)mod R(R̅₃)=0

R(C̅₄)mod R(R̅₃)=2067191264

R(C̅₅)mod R(R̅₃)=2367129770

Alice was looking for R̅₃ in the cloud. She could do that for many reasons, such as: to forward to someone else, to print from the cloud, create a backup for that particular report, and so on. It is also possible that the “report” she is looking for is some value that links to a larger report connected to the searched for value, such as the title of the report. If the title is found, the cloud (i.e., intermediary computing system) may then send the entire report back to Alice (or to some other destination specified by the search request). She sends R(R̅₃) as part of a search request to the cloud and the cloud computes R(C̅ᵢ) mod R(R̅₃) for all C̅₁. The only one that returns 0 is the operation on R(C̅₃) mod R(R̅₃), so the cloud knows Alice is requesting C̅₃.

### E. Hardware Implementation for Homomorphic Searching EDCHE Embodiments (FIG. 7)

FIG. 7 is a block diagram 700 of the hardware implementation for a homomorphic search encryption embodiment. One or more source computing devices 702 are connected over an electronic network/bus connection 704 to an intermediary (e.g., cloud) computing device 706. In the embodiment shown in FIG. 7, the source computing device(s) 702 sends the at least one cryptotext multivectors 710 that will “searched” through the searching homomorphism of an EDCHE embodiment at the intermediary computing system 706 over the network/bus connection 704 to the intermediary computing system 706. When there are two or more cryptotext multivectors 710 sent to the intermediary computing system 706 for storage on the intermediary computing system 706, each of the two or more cryptotext multivectors 710 may be created on a single source computing device 702, or each of the two or more cryptotext multivectors 710 may be created on multiple source computing devices 702. The source computing device(s) 702 send the at least one cryptotext multivector 710 over the network/bus connection 704 to the intermediary computing system 706.

The intermediary computing system 706 receives and stores the at least one cryptotext multivector 710 and may further store additional cryptotext multivectors sent before or after the currently stored cryptotext multivector 710. The search request computing device 714 creates a search request 716 of a plaintext data message. In the creation of the search request 714, the search request computing device 714, prepares a rationalize (R(M̅)) of the plaintext data message to be searched and includes the rationalize (R(M̅)) of the plaintext data message to be searched in the search request 716. The search request computing device 714 may also include a destination computing device 708 for receiving the search result 712. The search request computing device 714 sends the search request with the rationalize of the search data 716 over the network/bus connection 704 to the intermediary computing system 706 to perform the homomorphic search at the intermediary computing system 706.

The intermediary computing system 706 receives the search request with the rationalize of the search data 716. After receiving the search request 716 from the search request computing device 714, the intermediary computing system 706 begins the process of searching the stored cryptotext multivectors stored on the intermediary computing system 706 for the plaintext to be searched included as a rationalize of the plaintext data in the search request 716. As part of the process of the homomorphic search, the intermediary computing system 706 computes the rationalize (R(C̅ᵢ)) for each of the cryptotext multivectors stored on the intermediary computing system 706. The intermediary computing system 706 then performs a modulus operation (i.e., the remainder of a division operation of one number by another number) of each of the stored cryptotext rationalize (R(C̅ᵢ)) by the rationalize (R(M̅)) of the plaintext data message to be searched included in the search request 716. In mathematical terms, the intermediary computing system performs R(C̅ᵢ) mod R(R̅₃) to determine if any of the results are zero. If a result of the modulus operation is zero, the search result is indicated as FOUND for the cryptotext multivector associated with the zero result modulus operation. If there are not any zero modulus operation results for the cryptotext multivectors, the search result is indicated as NOT-FOUND. As designated by the search request computing device 714 in the search request 716, the intermediary computing system 706 may send the search result 712 to the destination computing device 708 over the network/bus connection 704. For a NOT-FOUND search result, only the indication of NOT-FOUND will typically be sent as the search result 712. For some embodiments, the search request 716 may indicate that just the FOUND/NOT-FOUND search result 712 be sent to the destination computing device 708, in which case, even when a cryptotext is FOUND, only the indication of FOUND will be sent as the search result 712. For other embodiments, the search request computing device 714 may include other operations in addition to or in place of sending a FOUND/NOT-FOUND indication, including, but not limited to: sending the cryptotext associated with the FOUND result to the destination computing system 708, performing some other operation with the cryptotext associated with the FOUND result at the intermediary computing system (i.e., performing other homomorphic functions such as add/multiply using the FOUND cryptotext multivector as an operand, printing the FOUND cryptotext on a device connected to the intermediary computing system 706, etc.), and/or sending additional cryptotext multivector(s) linked/associated with the FOUND cryptotext multivector (e.g., the FOUND cryptotext multivector is the title of a full report that includes at least one additional cryptotext multivector).

The destination computing device 708 receives the search result 712 from the intermediary computing system 706. When there are not any cryptotext multivectors included in the search result 712, the destination computing device 708 may perform operations in accord with the FOUND/NOT-FOUND result as desired by a system designer. When there is a FOUND result that includes at least one cryptotext multivector in the search result 712, if the destination computing device 708 intends to perform operations on the plaintext represented by the at least one cryptotext multivector associated with the FOUND result, the destination computing device 708 will need to decrypt the at least one cryptotext multivector.

Further, as noted in Sections 1 and 2 above, the cryptotext multivector(s) 710 may be converted to non-multivector cryptotext when being sent over the network/bus communication connection 704, then converted back into a cryptotext multivector(s) at the intermediary computing system 706 for homomorphic searching operations. Likewise, any cryptotext multivectors linked to/associated with a FOUND result being sent to the destination computing device 708 may be converted to non-multivector cryptotext when being sent over the network/bus communication connection 704, then converted back into the encrypted cryptotext multivector at the destination computing device 708 for decryption by the destination computing device 708 into a plaintext result.

Generally, communications, including encrypted communications, are bi-directional such that the source(s) computing device 702, the search request computing device 714, the intermediary computing system 706, and/or the destination computing device 708 may change roles so as to operate as a source computing device 702, the search request computing device 714, the intermediary computing system 706, and/or the destination computing device 708 as is necessary to accommodate the transfer of data back and forth between the source(s) 702, search request 714, intermediary, and/or destination 708 computing devices/systems as well as for performance of homomorphic search operations at the intermediary computing system 706.

Further, as shown in FIG. 7, the source(s) computing device 702 and search request computing device 714 appear to be a laptop computer and the destination computing device 708 appears to be a tablet device. Generally, any computing device capable of communication over any form of electronic network or bus communication platform 704 may be one, multiple or all of the source(s) computing device 702, the search request computing device 714, the intermediary computing system 706, and/or the destination computing device 708. Further still, the source(s) 702, search request 714, intermediary 706, and destination computing devices/systems 708 may actually be the same physical computing device communicating over an internal bus connection 704 with itself, but still desiring encrypted communication to ensure that an attacker cannot monitor the internal communications bus 704 or hack an unprotected area of the computing system (i.e., the intermediary section 706 or the search request section 714) in order to obtain sensitive data communications in an unencrypted format.

Various embodiments may implement the network/bus communications channel 704 using any communications channel 704 capable of transferring electronic data between the source(s) 702, search request 714, intermediary 706, and/or destination 708 computing devices/systems. For instance, the network/bus communication connection 704 may be an Internet connection routed over one or more different communications channels during transmission from the source(s) 702 and/or search request 714 to the intermediary 706, and then onto the destination 708. Likewise, the network/bus communication connection 704 may be an internal communications bus of a computing device, or even the internal bus of a processing or memory storage Integrated Circuit (IC) chip, such as a memory chip or a Central Processing Unit (CPU) chip. The network/bus communication channel 704 may utilize any medium capable of transmitting electronic data communications, including, but not limited to: wired communications, wireless electro-magnetic communications, fiber-optic cable communications, light/laser communications, sonic/sound communications, etc., and any combination thereof of the various communication channels.

The various embodiments may provide the control and management functions detailed herein via an application operating on the source(s) 702, search request 714, intermediary 706, and/or destination 708 computing devices/systems. The source(s) 702, search request 714, intermediary 706, and/or destination 708 computing devices/systems may each be a computer or computer system, or any other electronic device(s) capable of performing the communications and computations of an embodiment. The source(s) 702, search request 714, intermediary 706, and/or destination 708 computing devices/systems may include, but are not limited to: a general-purpose computer, a laptop/portable computer, a tablet device, a smart phone, an industrial control computer, a data storage system controller, a CPU, a Graphical Processing Unit (GPU), an Application Specific Integrated Circuit (ASI), and/or a Field Programmable Gate Array (FPGA). Notably, the source(s) 702 and/or destination 706 computing devices may be the storage controller of a data storage media (e.g., the controller for a hard disk drive) such that data delivered to/from the data storage media is always encrypted so as to limit the ability of an attacker to ever have access to unencrypted data. Embodiments may be provided as a computer program product which may include a computer-readable, or machine-readable, medium having stored thereon instructions which may be used to program/operate a computer (or other electronic devices) or computer system to perform a process or processes in accordance with the various embodiments. The computer-readable medium may include, but is not limited to, hard disk drives, floppy diskettes, optical disks, Compact Disc Read-Only Memories (CD-ROMs), Digital Versatile Disc ROMS (DVD-ROMs), Universal Serial Bus (USB) memory sticks, magneto-optical disks, ROMs, random access memories (RAMs), Erasable Programmable ROMs (EPROMs), Electrically Erasable Programmable ROMs (EEPROMs), magnetic optical cards, flash memory, or other types of media/machine-readable medium suitable for storing electronic instructions. The computer program instructions may reside and operate on a single computer/electronic device or various portions may be spread over multiple computers/devices that comprise a computer system. Moreover, embodiments may also be downloaded as a computer program product, wherein the program may be transferred from a remote computer to a requesting computer by way of data signals embodied in a carrier wave or other propagation medium via a communication link (e.g., a modem or network connection, including both wired/cabled and wireless connections).

### F. Homomorphic Searching EDCHE Operational Flow Charts (FIGS. 8 & 9A-C)

FIG. 8 is a flow chart 800 of the general operation for a homomorphic search encryption embodiment. At process 808 a shared secret numeric data value (S_{S}) is shared between the source(s) 802 and any destination computing devices (not shown in FIG. 8) that may need to decrypt FOUND encrypted data. The various embodiments may share the shared secret numeric data value (S_{S}) between the source(s) 802 and destination via any means desired by the users. To ensure the shared secret numeric data value (S_{S}) is kept secret, it is likely that some type of handshaking/setup encrypted key transfer mechanism will be desired to share the shared secret numeric data value (S_{S}). For example, the shared secret numeric data value (S_{S}) may be shared between the source(s) 802 and destination by means including, but not limited to: pre-conditioning the source(s) 802 computing device and the destination computing device with the shared secret numeric value (S_{S}), a standard public/private key exchange technique, RSA (Rivest-Shamir-Adleman) key exchange, and/or Diffie-Hellman key exchange (disclosed in more detail herein, above). Further, the original shared secret may be an alphanumeric string in ASCII (American Standard Code for Information Exchange) or another encoding protocol that is converted to a numeric value based on the associated encoding protocol, such as ASCII. However, both the source(s) 802 and destination need to know and use the same alphanumeric text conversion into a numeric value process to ensure that results of both the source(s) 802 and the destination are the same.

The processes 810-816 of source(s) computing device 802 are performed at least once in order to create the at least one cryptotext multivector that is to be stored at and searched by the intermediary computing system 804. At process 810, the source(s) 802 distributes the numeric message data (M) into message multivector (M̅) coefficients in accord with a homomorphic mathematical relationship equation between a plaintext data value and coefficients of a multivector that represents the plaintext data value. For all operations of a single collective homomorphic search process, all source(s) computing device(s) 802, the search request computing device 806, and the destination (not shown in FIG. 8), if the destination will be required to decrypt any encrypted data, should use the same homomorphic preserving mathematical relationship to preserve the homomorphism of the encrypted data and the “modulus” operation relationship between the encrypted data and the unencrypted data. Also, the encryption system will work with just one non-zero message multivector (M̅) coefficient, but, the more non-zero message multivector (M̅) coefficients there are, the stronger the encryption will become, so it is desirable to have more than one non-zero message multivector (M̅) coefficient. At process 812, the source(s) 802 distribute shared secret numeric value (S_{S}) into shared secret multivector (S̅_{S}) coefficients. Again, the encryption system will work with just one non-zero shared secret multivector (S̅_{S}) coefficient, but, the more non-zero shared secret multivector (S̅_{S}) coefficients there are, the stronger the encryption will become, so, again, it is desirable to have more than one non-zero shared secret multivector (S̅_{S}) coefficient. One skilled in the art will recognize that there are many approaches for distributing numeric data into several coefficients of a multivector (see herein, above for disclosure of some example packing/distribution methods). The primary requirement for the distribution process from the numeric values of the message (M) and the shared secret (S_{S}) to the multivector coefficient values (M̅ and S̅_{S}) is that the source(s) 802, the search request 806, and the destination (if the destination is to receive and decrypt encrypted data) computing devices/systems each know the processes 810/822 for distributing message data into a multivector. The process 812 is required for devices that will encrypt and/or decrypt data such as the source(s) 802 and the destination (not shown), if the destination is to receive and decrypt encrypted data as a result of a search. As long as it is known to both the source(s) 802 and the destination (if the destination is to receive and decrypt encrypted data from a search operation), the distribution of numeric data to multivector coefficients may be performed differently between the message (M)/search request (SR) and the shared secret (S_{S}).

The distributing/packing method defines, among many things, the Geometric Algebra operations permissible for EDCE and/or EDCHE embodiments. For example, the Rationalize operation on multivectors yields zero when all multivector coefficients are equal. Such multivectors having all equal coefficients have no inverse and the geometric product of such multivectors having all equal coefficients with another multivector has no inverse. For example, the Rationalize operation on multivectors yields zero when all multivector coefficients are equal. As discussed in more detail above, the decryption methodology for EDCE and EDCHE systems utilize the inverse of the cryptotext multivector being decrypted and of the security key(s) multivector to perform the decryption. Therefore, the cryptotext multivector being decrypted should not have all equal value coefficients. One means to ensure that the cryptotext multivector being decrypted does not have all equal value coefficients is to have the packing/coefficient distribution method ensure that not all coefficients are equal to each other (i.e., at least one coefficient should be different than the other coefficients) when creating the shared security multivector(s) and the data message multivector(s). For an embodiment of the EDCE that simply transfers the data message (such as a search embodiment that does not perform any mathematical operations that change the value of the encrypted data representation), this will ensure that the cryptotext multivector to be decrypted will not have all equivalent coefficients.

For embodiments that intend to retain homomorphic properties for encrypted data messages such as an embodiment of an EDCHE system, there is an additional restriction that the “packed” multivector that represents the original plaintext numeric message have a mathematical relationship (i.e., the homomorphic preserving mathematical relationship) to the original plaintext numeric message. In abstract algebra, the term homomorphism refers to a structure-preserving map between two algebraic structures, such as groups, rings, or vector spaces. An algebra homomorphism between two algebras is one that preserves the algebra structure. In order to preserve the algebra structure between arithmetic and Geometric Algebra operations, the method by which numbers are “packed” into multivector elements must remain a representation of the original number. One such relationship for packing the coefficients of the multivector that preserves homomorphic properties is to ensure that the coefficients of the multivector representation of the plaintext numeric message follow a mathematical data organization between the value of the plaintext numeric message and at least one of the values of the coefficients of the multivector representation of the plaintext numeric message where the mathematical operations incorporating the one or more values of the multivector coefficients have a result equal to the original plaintext numeric message value. The mathematical relationship may include: addition of at least one coefficient of the multivector coefficients, subtraction of at least one coefficient of the multivector coefficients, addition of a constant value, subtraction of a constant value, multiplication of at least one coefficient of the multivector coefficients by a constant value, and division of at least one coefficient of the multivector coefficients by a constant value. The location of the various mathematical operations relative to the particular locations of the coefficients in the multivector representation should also be consistently applied to all source numeric data messages converted to a multivector as well as for result multivectors converted to a result numeric data value in a particular encryption/decryption pathway.

The restriction to retain homomorphic properties is only applicable to the distribution (i.e., “packing”) of the message multivector (M̅) coefficients and not to the distribution (i.e., “packing”) of the shared secret multivector (S̅_{S}). Consequently, the distribution (i.e., “packing”) of the shared secret multivector (S̅_{S}) may be performed in any fashion so long as the distribution (i.e., “packing”) method of the shared secret multivector (S̅_{S}) is known and used consistently by the source 802 and destination computing devices as, ultimately, the shared secret multivector (S̅_{S}) used by the source 802 and destination should be equal to each other to ensure that the decryption operations of a destination work properly in relation to the encryption 814 operations. The number of potential coefficients is directly related to the size/dimension (N) of the multivectors such that the number of coefficients increases by a factor of 2 (i.e., 2^{N}) for each incremental increase in the size/dimension (N) of the multivector. To increase the confusion and/or diffusion of the encryption process disclosed herein, using multivectors of at least two dimensions will provide at least four coefficients to distribute the numeric data of the message (M) and the shared secret (S_{S}). By increasing the number of dimensions (N) of multivectors beyond two-dimension multivectors, the confusion and/or diffusion security characteristics will also be increased due to the additionally available multivector coefficients. Further, with the additionally available coefficients it is also possible to transfer more data in a single multivector message (M̅) payload using the additionally available multivector coefficients.

At process 814, the source(s) 802 encrypts a cryptotext multivector (C̅) as a function of at least one Geometric Algebra geometric product operation on the message multivector (M̅) and the shared secret multivector (S̅_{S}). Due to the nature of the geometric product operation of Geometric Algebra, there are many possible variations of the geometric product application that will provide similar degrees of confusion and diffusion. Some, but not all, of the potential geometric product calculations to encrypt the message data (M) include: a geometric product (C̅=M̅S̅_{S}) of the message multivector (M̅) and the shared secret multivector (S̅_{S}) and a geometric product “sandwich” (C̅=S̅_{S}M̅S̅_{S}).

At process 816, the source(s) 802 sends the cryptotext multivector (C̅) to the intermediary computing system 804. Various embodiments may optionally convert the cryptotext multivector (C̅) into cryptotext numeric data (C̅) in accord with reverse operation of a cryptotext data coefficient distribution algorithm that is known to the source(s) 802, intermediary (804), search request 806, and the destination (if the destination is to receive and decrypt encrypted data as a result of a search) computing devices/systems. An embodiment may also skip conversion to cryptotext numeric data (C) and directly send a representation of the cryptotext multivector (C̅) without first converting the cryptotext multivector (C̅) into cryptotext numeric data (C). The transmission may be implemented as a series of transfers of the coefficients or as some form of records/packets that define a data structure that carries the coefficient data of the cryptotext multivector (C̅). Not converting the cryptotext multivector (C̅) into cryptotext numeric data (C) has the advantage of avoiding the processing time for the conversion as well as having the advantage that, for homomorphic operations performed at an intermediary computing system, the intermediary computing system need not have any knowledge of the methodology used to create the cryptotext multivector (C̅). If process 816 is used to convert the cryptotext multivector (C̅) into cryptotext numeric data (C), it is necessary for any computing device/system that wishes to operate on the cryptotext multivector (C̅) to have knowledge of the particular conversion methodology so that the computing device/system may properly recreate the cryptotext multivector (C̅). A disadvantage of not converting the cryptotext multivector (C̅) into cryptotext numeric data (C) is that it may be possible to include additional confusion/diffusion features in conversion to cryptotext numeric data.

At process 818, the intermediary computing system 804 receives the at least one cryptotext multivector (C̅) sent by the source(s) 802. At process 820, the intermediary 804 stores the at least one cryptotext multivector (C̅) for a potential search that may be later requested by the search request computing device 806.

At process 822, the search request computing device 806 distributes the plaintext numeric search request data (SR) that is to be searched for on the intermediary computing system 804 into search request message multivector (S̅R̅) coefficients in accord with the homomorphic mathematical relationship equation between a plaintext data value and coefficients of a multivector that represents the plaintext data value as was used for the distribution of the message data that was encrypted on the sources in process 810 above. At process 824, the search request computing device 806 calculates a geometric algebra rationalize (R(S̅R̅)=(S̅R̅ S̅R̅)(S̅R̅ S̅R̅)^{†}) of the search request multivector (S̅R̅). At process 826, the search request computing device 806 sends a search request that includes the rationalize (R(S̅R̅)) of the search request multivector (S̅R̅) to the intermediary computing system 804 instructing the intermediary computing system 804 to perform a search for the search request data (SR) on the encrypted data stored on the intermediary 804 using the rationalize of the search request data (R(S̅R̅)). The search request computing device 806 may include additional data in the search request command sent 826 to the intermediary 804, including a destination computing system that should receive the result of the search, an instruction to send the encrypted data associated with a FOUND result to the destination computing system, an instruction to send any additional encrypted data linked to the encrypted data associated with a FOUND result (e.g., send encrypted data for a full report that may consist of multiple encrypted data multivectors when a search of a encrypted multivector representing the title of a report is found), and/or to perform some other operation on the encrypted data such as printing the encrypted data or performing other homomorphic operations with the encrypted data such as homomorphic addition or multiplication.

At process 828, the intermediary computing system 804 receives the search request for the rationalize (R(S̅R̅)) of the search request data multivector (S̅R̅) from the search request computing device 806. At process 830, the intermediary 804 computes the rationalize (R(C̅ᵢ)) for each of the cryptotext multivectors (C̅ᵢ) stored on the intermediary computing system 804. At process 832, the intermediary computing system 804 then performs a modulus operation (i.e., the remainder of a division operation of one number by another number) of each of the stored cryptotext rationalize (R(C̅ᵢ)) by the rationalize (R(S̅R̅)) of the plaintext search data message (SR) to be searched that was included in the search request sent at 826. In mathematical terms, the intermediary computing system performs R(C̅ᵢ) mod R(R̅₃) to determine if any of the results are zero (i.e., FOUND). At process 834, the intermediary 804 determines if a result of the modulus operation at 832 is zero such that a search result is indicated as FOUND for the cryptotext multivector associated with the zero result modulus operation. If there are not any zero modulus operation 832 results for the cryptotext multivectors (C̅ᵢ), the search result is indicated as NOT-FOUND.

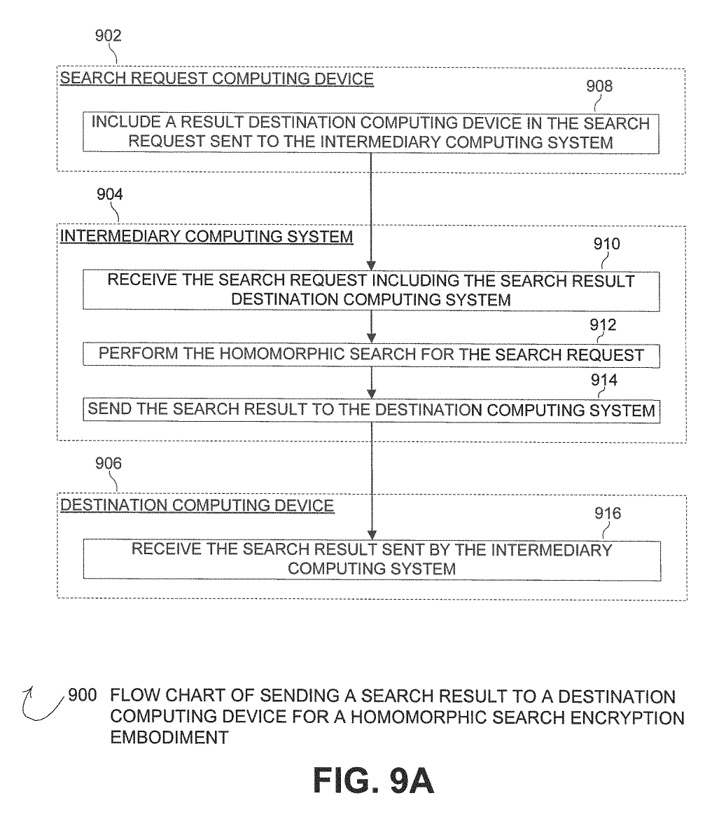

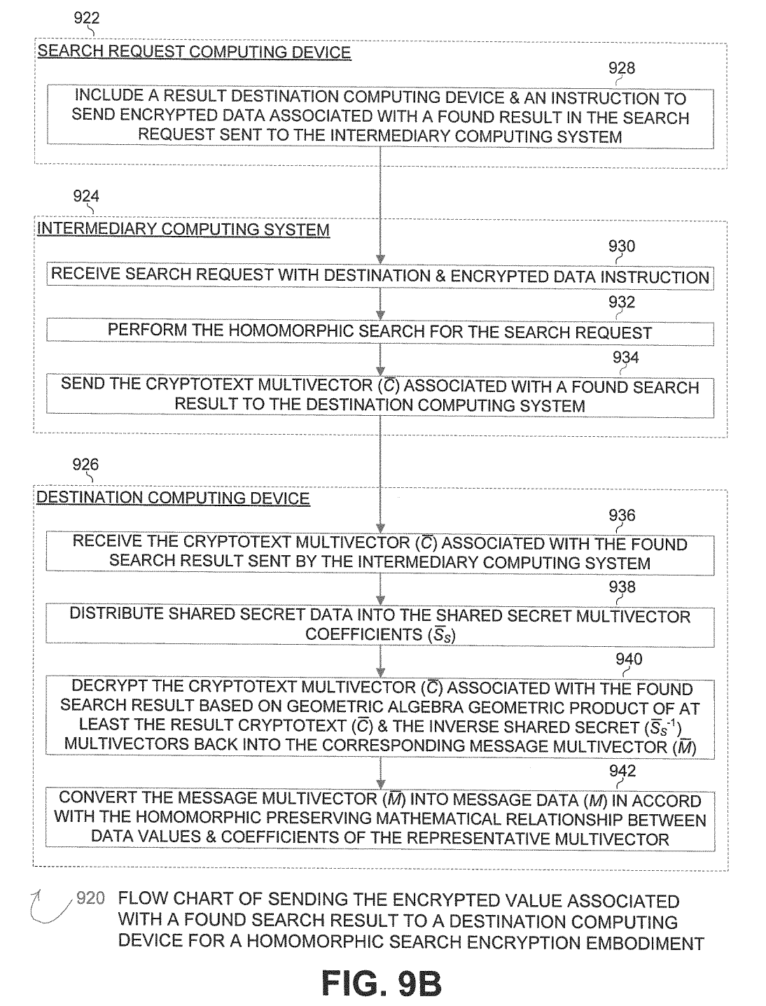

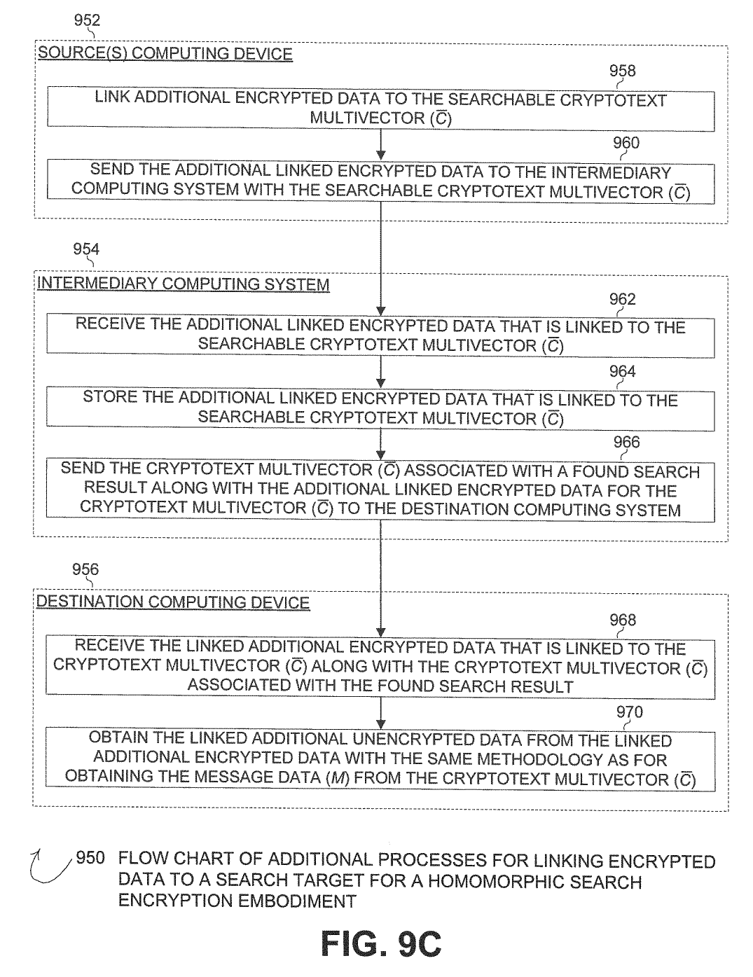

FIG. 9A is a flow chart 900 of the operations for sending a search result to a destination computing device 906 for a homomorphic search encryption embodiment. At process 908, the search request computing device 902 includes a result destination computing device 906 in the search request sent to the intermediary computing system 904. At process 910, the intermediary computing system 904 receives the search request including the search result destination computing device 906 from the search request computing device 902. At process 912, the intermediary computing system 904 performs the search request using the geometric algebra rationalize and the modulus operations as described above in the disclosure with respect to FIG. 8. At process 914, the intermediary computing system 904 sends the search result to the destination computing device 906. At process 916, the destination computing device 906 receives the search result sent by the intermediary computing system 904 and may perform any desired operations based on the search result. For example, if the search result is NOT-FOUND, the destination computing device 906 may instruct the search request computing device 902 (which, may actually be the same computing device performing multiple different roles), acting as a source computing device, to encrypt the data and send it to the intermediary computing system 904 for storage. If the result is FOUND, the destination computing device 906 may instruct the search request computing device 902 (which, again, may actually be the same computing device performing multiple different roles) to use the plaintext search request data (SR) without the need to obtain and decrypt the encrypted data since it is now known that the plaintext search request data (SR) is data that is stored on the intermediary computing system 904.

FIG. 9B is a flow chart 920 of the operations for sending the encrypted value associated with a FOUND search result to a destination computing device 926 for a homomorphic search encryption embodiment. At process 928, the search request computing device 922 includes a result destination computing device 926 and an instruction to send encrypted data associated with a FOUND search result in the search request sent to the intermediary computing system 924. At process 930, the intermediary computing system 924 receives the search request including the search result destination computing device 926 and the instruction to send encrypted data associated with a FOUND search result from the search request computing device 922. At process 932, the intermediary computing system 924 performs the search request using the geometric algebra rationalize and the modulus operations as described above in the disclosure with respect to FIG. 8. At process 934, the intermediary computing system 924 sends the search result and, when the search result is FOUND, including the cryptotext multivector (C̅) associated with the FOUND result, to the destination computing device 906.

At process 936, the destination computing device 926 receives the search result sent by the intermediary computing system 924 and when it is a FOUND search result, the search result includes the encrypted value (C̅) associated with the FOUND result. If the search result is NOT-FOUND such that there is not an associated encrypted value (C̅) included with the search result, then the remaining processes 938-942 are not necessary as there is not any encrypted data to decrypt. At process 938, the destination computing device 926 distributes shared secret numeric value (S_{S}) into shared secret multivector (S̅_{S}) coefficients in the same fashion as was done for the source(s) at process 812 of FIG. 8. At process 940, the destination computing device 926 decrypts the encrypted value (C̅) associated with the FOUND result as a function of at least one Geometric Algebra geometric product operation on the cryptotext multivector (C̅) and an inverse (S̅_{S}⁻¹) of the shared secret multivector (S̅_{S}) back into the message multivector (M̅). Again, due to the nature of the geometric product operation of Geometric Algebra there are many possible variations of the geometric product application that will provide similar degrees of confusion and diffusion. Some, but not all, of the potential geometric product calculations to decrypt the message data (M) from the encrypted value (C̅) associated with the FOUND result include: a geometric product (M̅=C̅S̅_{S}⁻) of the cryptotext multivector (C̅) and the inverse (S̅_{S}⁻¹) of the shared secret multivector (S̅_{S}) and a geometric product “sandwich” (M̅=S̅_{S}⁻¹C̅S̅_{S}⁻¹ to decrypt). At process 942, the destination computing device 926 converts the message multivector (M̅) into the plaintext numeric value (M) in accord with reverse operation of the homomorphic preserving mathematical relationship of the source(s) at process 810 of FIG. 8.

FIG. 9C is a flow chart 950 of additional operations for linking additional encrypted data to a search target and sending the additional linked encrypted data along with the encrypted value associated with a FOUND search result to a destination computing device 956 for a homomorphic search encryption embodiment. The flow chart of FIG. 9C includes the additional processes from FIG. 9B necessary to include additional linked encrypted data that is linked to the encrypted data associated with a FOUND search result. At process 958, at least one source computing device 952 links additional encrypted data to the searchable encrypted data multivector (C̅) that is to be stored at the intermediary computing system 954. At process 960, the at least one source computing device 952 sends the additional linked encrypted data along with the searchable encrypted data multivector (C̅) as encrypted data linked to the searchable encrypted data multivector (C̅). At process 962, the intermediary computing system 954 receives the additional linked encrypted data along with the searchable encrypted data multivector (C̅) as encrypted data linked to the searchable encrypted data multivector (C̅). At process 964, the intermediary computing system 952 stores the additional linked encrypted data along with the searchable encrypted data multivector (C̅) as encrypted data linked to the searchable encrypted data multivector (C̅). At process 966, the intermediary computing system 954 sends the additional linked encrypted data along with the searchable encrypted data multivector (C̅) as encrypted data linked to the searchable encrypted data multivector (C̅) for a searchable encrypted data multivector (C̅) associated with a FOUND search result. At process 968, the destination computing device 956 receives the additional linked encrypted data along with the searchable encrypted data multivector (C̅) as encrypted data linked to the searchable encrypted data multivector (C̅) for a searchable encrypted data multivector (C̅) associated with the FOUND search result. At process 970, the destination computing device 956 obtains the linked additional unencrypted data from the additional linked encrypted data sent along with the searchable encrypted data multivector (C̅) associated with the FOUND search result with the same methodology as for obtaining the message numeric data (M) from the cryptotext multivector (C̅) described in the disclosure with respect to processes 938-942 of FIG. 9B.

For more detail on general Geometric Algebra concepts, an additional discussion of an overview of general Geometric Algebra concepts may be found in “Appendix A: Geometric Algebra Overview” of the parent patent application Ser. No. 15/667,325, filed Aug. 2, 2017, entitled “Methods and Systems for Enhanced Data-Centric Encryption Systems Using Geometric Algebra,” which has been specifically incorporated herein by reference for all that it discloses and teaches. For a more exhaustive reference see [REFERENCE1].
[REFERENCE1] “Functions of Multivector Variables,” PLOS ONE| DOI: 10.1371/journal.pone.0116943 Mar. 16, 2015, James M. Chappell, Azhar Iqbal, Lachlan J. Gunn, Derek Abbott, School of Electrical and Electronic Engineering, University of Adelaide, Adelaide, South Australia, Australia}

The foregoing description of the invention has been presented for purposes of illustration and description. It is not intended to be exhaustive or to limit the invention to the precise form disclosed, and other modifications and variations may be possible in light of the above teachings. The above described embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method for performing homomorphic searching of an intermediary computing system that stores at least one cryptotext encrypted data representation of at least one corresponding plain text data value wherein said homomorphic search is initiated using a plaintext search data value without encrypting said plaintext search data value and without said intermediary computing device decrypting said at least one stored cryptotext encrypted data representation, the method comprising:
distributing by at least one source computing device at least one numeric message data value (Mₙ) into coefficients of at least one corresponding message multivector (M̅ₙ) in accord with a homomorphic preserving mathematical relationship between an unencrypted numeric data value and multivector coefficients representing said unencrypted numeric data value that is known to said at least one source computing device and said search request computing device;
distributing by said at least one source computing device said shared secret numeric value (S_{S}) into said shared secret multivector (S̅_{S}) in accord with a shared secret coefficient distribution algorithm such that said shared secret numeric value (S_{S}) is kept secret from other devices not intended to have access to said at least one corresponding numeric message data value (Mₙ) including said intermediary computing system;
encrypting by said at least one source computing device at least one corresponding cryptotext multivector (C̅ₙ) as said encryption function of at least one Geometric Algebra geometric product operation on said at least one corresponding message multivector (M̅ₙ) and said shared secret multivector (S̅_{S});
sending by said at least one source computing device said at least one cryptotext multivector (C̅ₙ) to said intermediary computing system;
receiving by said intermediary computing system said at least one cryptotext multivector (C̅ₙ) sent by said at least one source computing device;
storing by said intermediary computing system said at least one cryptotext multivector (C̅ₙ) on said intermediary computing system;
distributing by said search request computing device a search request numeric message data value (SR) into coefficients of a corresponding search request message multivector (S̅R̅) in accord with said homomorphic preserving mathematical relationship;
calculating by said search request computing device a Geometric Algebra rationalize R(S̅R̅) of said search request message multivector (S̅R̅);
sending by said search request computing device a search request for said rationalize R(S̅R̅) of said search request message multivector (S̅R̅) to said intermediary computing system;
receiving by said intermediary computing system said search request for said rationalize R(S̅R̅) of said search request message multivector (S̅R̅) sent by said search request computing device;
calculating by said intermediary computing system a Geometric Algebra rationalize R(C̅ₙ) of said at least one cryptotext multivector (C̅ₙ) stored on said intermediary computing device;
calculating by said intermediary computing system said rationalize R(C̅ₙ) of said at least one cryptotext multivector (C̅ₙ) modulus operation by said rationalize R(S̅R̅) of said search request message multivector (S̅R̅); and
determining by said intermediary computing system a search result as a function of said modulus operation on said at least one cryptotext multivector (C̅ₙ) by said rationalize R(S̅R̅) of said search request message multivector (S̅R̅) such that a FOUND result is indicated when said modulus operation result is zero and a NOT-FOUND result is indicated when said modulus operation result is non-zero.

2. The method of claim 1 wherein said search request for said rationalize R(S̅R̅) of said search request message multivector (S̅R̅) sent to said intermediary computing system by said search request computing device further includes a designation of a destination computing device for said search result, and said method of claim 1 further comprises:
sending by said intermediary computing system said search result to said destination computing device; and
receiving by said destination computing device said search result sent by said intermediary computing system.

3. The method of claim 1 wherein said search request for said rationalize R(S̅R̅) of said search request message multivector (S̅R̅) sent to said intermediary computing system by said search request computing device further includes a designation of a destination computing device for receiving said at least one cryptotext multivector (C̅ₙ) associated with a FOUND result, and, when said determination of said search result is a FOUND result, said method of claim 1 further comprises:
sending to said destination computing device by said intermediary computing system said at least one cryptotext multivector (C̅ₙ) associated with said search result when said search result is a FOUND result;
receiving by said destination computing device said at least one cryptotext multivector (C̅ₙ) associated with said FOUND search result sent by said intermediary computing system;
distributing by said destination computing device said shared secret numeric value (S_{S}) into said shared secret multivector (S̅_{S}) in accord with said shared secret coefficient distribution algorithm that is the same shared secret coefficient distribution algorithm known to said at least one source computing device;
decrypting by said destination computing device said at least one cryptotext multivector (C̅ₙ) associated with said FOUND search result as a decryption function of at least one Geometric Algebra geometric product operation on said at least one cryptotext multivector (C̅ₙ) and an inverse (S̅_{S}⁻¹) of said shared secret multivector (S̅_{S}) into said at least one message multivector (M̅ₙ) such that said decryption function provides a corresponding decryption operation for said encryption process of said at least one cryptotext multivector (C̅ₙ); and
converting by said destination computing device said at least one message multivector (M̅ₙ) into said at least one corresponding numeric message data value (Mₙ) in accord with said homomorphic preserving mathematical relationship that is the same homomorphic preserving mathematical relationship known to said at least one source computing device and said search request computing device.

4. The method of claim 3 further comprising:
linking by said at least one source computing device additional encrypted data to said at least one cryptotext multivector (C̅ₙ), wherein said additional encrypted data is encrypted with the same methodology as for said at least one cryptotext multivector (C̅ₙ);
sending by said at least one source computing device said linked additional encrypted data to said intermediary computing system as additional encrypted data that is linked to said at least one cryptotext multivector (C̅ₙ);
receiving by said intermediary computing system said intermediary computing system said linked additional encrypted data;
storing by said intermediary computing system said linked additional encrypted data as additional encrypted data that is linked to said at least one cryptotext multivector (C̅ₙ);
sending to said destination computing device by said intermediary computing system said linked additional encrypted data that is linked to said at least one cryptotext multivector (C̅ₙ) along with said at least one cryptotext multivector (C̅ₙ) associated with said search result when said search result is a FOUND result;
receiving by said destination computing device said linked additional encrypted data that is linked to said at least one cryptotext multivector (C̅ₙ) along with said at least one cryptotext multivector (C̅ₙ) associated with said FOUND search result sent by said intermediary computing system; and
obtaining by said destination computing device linked additional unencrypted data from said linked additional encrypted data with the same methodology as for obtaining said at least one numeric message data value (Mₙ) from said at least one cryptotext multivector (C̅ₙ).

5. The method of claim 1 wherein said homomorphic preserving mathematical relationship between said unencrypted numeric data value and said multivector coefficients representing said unencrypted numeric data ensures that a result of mathematical operations defined by said homomorphic preserving mathematical relationship on said multivector coefficients representing said unencrypted numeric data value is equal to said unencrypted numeric data value.

6. The method of claim 5 wherein said mathematical operations defined by said homomorphic preserving mathematical relationship are comprised of at least one of a group chosen from: addition of at least one coefficient of said multivector coefficients, subtraction of at least one coefficient of said multivector coefficients, addition of a constant value, subtraction of a constant value, multiplication of at least one coefficient of said multivector coefficients by a constant value, and division of at least one coefficient of said multivector coefficients by a constant value.

7. The method of claim 5 wherein said mathematical operations defined by said homomorphic preserving mathematical relationship incorporate at least one coefficient value of said multivector coefficients such that said mathematical operations defined by said homomorphic preserving mathematical relationship is comprised of one of a group chosen from: said mathematical operations defined by said homomorphic preserving mathematical relationship incorporate all coefficient values of said multivector coefficients, said mathematical operations defined by said homomorphic preserving mathematical relationship incorporate fewer than all but more than one coefficient values of said multivector coefficients, and said mathematical operations defined by said homomorphic preserving mathematical relationship incorporate one coefficient value of said multivector coefficients.

8. The method of claim 1 wherein said at least one numeric message data value (Mₙ) is a numeric value comprised of at least one of a group chosen from: positive numbers, negative numbers, zero, integer numbers, and real numbers.

9. The method of claim 1 wherein numeric values of said coefficients of said at least one message multivector (M̅ₙ) are comprised of at least one of a group chosen from: positive numbers, negative numbers, zero, integer numbers, and real numbers.

10. The method of claim 1:
wherein said process of distributing said at least one numeric message data value (Mₙ) into coefficients of said at least one corresponding message multivector (M̅ₙ) further ensures that not all coefficients of said at least one message multivector (M̅ₙ) are equal to each other; and
wherein said shared secret coefficient distribution algorithm further ensures that not all coefficients of said shared secret multivector (S̅_{S}) are equal to each other.

11. The method of claim 3 wherein said search request computing device separately performs processes of at least one of a group chosen from: said at least one source computing device, said intermediary computing system, and said destination computing device.

12. The method of claim 3 wherein said at least one source computing device separately performs processes of at least one of a group chosen from: said search request computing device, said intermediary computing system, and said destination computing device.

13. The method of claim 3 wherein said intermediary computing system separately performs processes of at least one of a group chosen from: said search request computing device, said at least one source computing device, and said destination computing device.

14. The method of claim 3 wherein said destination computing device separately performs processes of at least one of a group chosen from: said search request computing device, said at least one source computing device, and said intermediary computing system.

15. The method of claim 3 wherein evaluation of Geometric Algebra geometric products, inverses of multivectors, and rationalizations of multivectors is implemented on said at least one source computing device, said search request computing device, said intermediary computing device, and said destination computing device using basic arithmetic operations of addition, subtraction, multiplication, and division.

16. The method of claim 15 wherein said implementation of said Geometric Algebra geometric products, inverses of multivectors, and rationalizations of multivectors on said at least one source computing device, said search request computing device, said intermediary computing system, and said destination computing device does not include a complex operation to select a prime number, to calculate a logarithm function, and/or to calculate a natural logarithm function.

17. The method of claim 3 further comprising establishing said shared secret numeric value (S_{S}) between said at least one source computing device and said destination computing device using a known shared secret technique.

18. The method of claim 17 wherein said known shared secret technique is comprised of at least one of a group chosen from: pre-conditioning said first source computing device, said at least one additional source computing device, and said destination computing device with said shared secret numeric value (S_{S}); standard public/private key exchange technique; RSA (Rivest-Shamir-Adleman) key exchange, and Diffie-Hellman key exchange.

19. The method of claim 3 wherein said encryption function of at least one Geometric Algebra geometric product operation and said decryption function of at least one Geometric Algebra geometric product operation is comprised of at least one of a group chosen from: a geometric product (C̅ₙ=M̅S̅_{S}) of a message multivector (M̅) and said shared secret multivector (S̅_{S}) to encrypt and a geometric product (M̅=C̅ₙŜ_{S}⁻) of said at least one cryptotext multivector (C̅ₙ) and said inverse (S̅_{S}⁻¹) of said shared secret multivector (S̅_{S}) to decrypt, and a geometric product “sandwich” (C̅ₙ=S̅_{S}M̅S̅_{S} to encrypt and M̅=S̅_{S}⁻¹C̅ₙS̅_{S}⁻¹ to decrypt).

20. The method of claim 3:
wherein said encryption function of at least one Geometric Algebra geometric product operation performed by said at least one source computing device further comprises:
generating a second shared secret key (S_{S}_{₂}) as a scalar result of a 0-Blade Reduction Operation of said shared secret multivector (S̅_{S});
distributing said second shared secret key (S_{S}_{₂}) into coefficients of a second shared secret multivector (S̅_{S}_{₂}) in accord with a second shared secret coefficient distribution algorithm that is known to said at least one source computing device and said destination computing device; and
encrypting said at least one cryptotext multivector (C̅ₙ) as a function of Geometric Algebra geometric product operations on said at least one message multivector (M̅ₙ), said shared secret multivector (S̅_{S}), and said second shared secret multivector (S̅_{S}_{₂}); and
wherein said decryption function of at least one Geometric Algebra geometric product operation performed by said destination computing device further comprises:
generating said second shared secret key (S_{S}_{₂}) as a scalar result of said 0-Blade Reduction Operation of said shared secret multivector (S̅_{S});
distributing said second shared secret key (S_{S}_{₂}) into said second shared secret multivector (S̅_{S}_{₂}) in accord with said second shared secret coefficient distribution algorithm; and
decrypting said at least one cryptotext multivector (C̅ₙ) as a function of Geometric Algebra geometric product operations on said at least one cryptotext multivector (C̅ₙ), an inverse (S̅_{S}⁻¹) of said shared secret multivector (S̅_{S}), and an inverse (S̅_{S}_{₂}⁻¹) of said second shared secret multivector (S̅_{S}_{₂}) into said at least one message multivector (M̅ₙ).

21. The method of claim 20 wherein said 0-Blade Reduction Operation is a geometric product (S_{S}_{₂}=(S̅_{S}S̅_{S})(S̅_{S}S̅_{S})^{†}) of a geometric product (S̅_{S}S̅_{S}) of said shared secret multivector (S̅_{S}) and a Clifford conjugate (S̅_{S}) of said shared secret multivector (S̅_{S}) and a geometric reverse ((S̅_{S}S̅_{S})^{†}) of said geometric product (S̅_{S}S̅_{S}) of said shared secret multivector (S̅_{S}) and said Clifford conjugate (S̅_{S}) of said shared secret multivector (S̅_{S}).

22. The method of claim 20 wherein said Geometric Algebra geometric product operations are comprised of a geometric product “sandwich” (C̅ₙ=S̅_{S}M̅S̅_{S}_{₂} to encrypt and M̅=S̅_{S}⁻¹C̅ₙS̅S₂⁻¹ to decrypt).

23. The method of claim 1 wherein said process of sending by said at least one source computing device said at least one corresponding cryptotext multivector (C̅ₙ) to said intermediary computing system, and receiving by said intermediary computing system said at least one cryptotext multivector (C̅ₙ) sent by said corresponding at least one source computing device further comprises:
converting by said at least one source computing device said at least one corresponding additional cryptotext multivector (C̅ₙ) into at least one corresponding additional cryptotext numeric data (Cₙ) in accord with reverse operation of a cryptotext data coefficient distribution algorithm that is known to said at least one source computing device and said intermediary computing system;
sending by said at least one source computing device said at least one corresponding cryptotext numeric data (Cₙ) to said intermediary computing system;
receiving by said intermediary computing system said at least one cryptotext numeric data (Cₙ) sent by said corresponding at least one source computing device; and
distributing by said intermediary computing system said at least one cryptotext numeric data (Cₙ) into said at least one corresponding cryptotext multivector (C̅ₙ) in accord with said cryptotext data coefficient distribution algorithm.

24. The method of claim 3 wherein said process of sending by said intermediary computing system said at least one additional cryptotext numeric data (Cₙ) to said destination computing device and receiving by said destination computing device said at least one additional cryptotext numeric data (Cₙ) sent by said intermediary computing system further comprises:
converting by said intermediary computing system said at least one cryptotext multivector (C̅ₙ) into at least one corresponding cryptotext numeric data (Cₙ) in accord with reverse operation of a cryptotext data coefficient distribution algorithm that is known to said destination computing device and said intermediary computing system;
sending by said intermediary computing system said at least one corresponding cryptotext numeric data (Cₙ) to said destination computing device;
receiving by said destination computing device said at least one corresponding cryptotext numeric data (Cₙ) sent by said intermediary computing system; and
distributing by said destination computing device said at least one corresponding cryptotext numeric data (Cₙ) into said at least one corresponding cryptotext multivector (C̅ₙ) in accord with said cryptotext data coefficient distribution algorithm.

25. A method for encrypting a numeric message data value (M) on a source computing device in order to transfer a cryptotext multivector (C̅) encrypted representation of said numeric message data value (M) to an intermediary computing system that will save said cryptotext multivector (C̅) and perform homomorphic searches of cryptotext multivectors stored on said intermediary computing system as requested by a search request computing device, the method comprising:
distributing by said source computing device said numeric message data value (M) into coefficients of a message multivector (M̅) in accord with a homomorphic preserving mathematical relationship between an unencrypted numeric data value and multivector coefficients representing said unencrypted numeric data value that is known to said source computing device and said destination computing device;
distributing by said source computing device a shared secret numeric value (S_{S}) into coefficients of a shared secret multivector (S̅_{S}) in accord with a shared secret coefficient distribution algorithm such that said shared secret numeric value (S_{S}) is kept secret from other devices not intended to have access to said numeric message data including said intermediary computing system;
encrypting by said source computing device said cryptotext multivector (C̅) as an encryption function of at least one Geometric Algebra geometric product operation on said message multivector (M̅) and said shared secret multivector (S̅_{S}); and
sending by said source computing device said cryptotext multivector (C̅) to said intermediary computing system.

26. A method for a search request computing device to request that an intermediary computing system perform a homomorphic search of cryptotext multivectors stored on said intermediary computing system, the method comprising:
distributing by said search request computing device a search request numeric message data value (SR) into coefficients of a corresponding search request message multivector (S̅R̅) in accord with said homomorphic preserving mathematical relationship, said homomorphic preserving mathematical relationship also being known to and used by at least one source computing that delivers said cryptotext multivectors to said intermediary computing system;
calculating by said search request computing device a Geometric Algebra rationalize R(S̅R̅) of said search request message multivector (S̅R̅); and
sending by said search request computing device a search request for said rationalize R(S̅R̅) of said search request message multivector (S̅R̅) to said intermediary computing system.

27. A method for performing a homomorphic search of cryptotext multivectors stored on an intermediary computing system in response to a search request from a search request computing device, the method comprising:
receiving by said intermediary computing system said at least one cryptotext multivector (C̅ₙ) sent by at least one source computing device;
storing by said intermediary computing system said at least one cryptotext multivector (C̅ₙ) on said intermediary computing system;
receiving by said intermediary computing system said rationalize R(S̅R̅) of a search request message multivector (S̅R̅) sent by said search request computing device;
calculating by said intermediary computing system a Geometric Algebra rationalize R(C̅ₙ) of said at least one cryptotext multivector (C̅ₙ) stored on said intermediary computing device;
calculating by said intermediary computing system said rationalize R(C̅ₙ) of said at least one cryptotext multivector (C̅ₙ) modulus operation by said rationalize R(S̅R̅) of said search request message multivector (S̅R̅); and
determining by said intermediary computing system a search result as a function of said modulus operation on said at least one cryptotext multivector (C̅ₙ) by said rationalize R(S̅R̅) of said search request message multivector (S̅R̅) such that a FOUND result is indicated when said modulus operation result is zero and a NOT-FOUND result is indicated when said modulus operation result is non-zero.

28. A method for decrypting at least one cryptotext multivector (C̅ₙ) associated with a FOUND search result of a homomorphic search performed by an intermediary computing system of cryptotext multivectors stored on said intermediary computing system, the method comprising:
receiving by said destination computing device said at least one cryptotext multivector (C̅ₙ) associated with said FOUND search result sent by said intermediary computing system;
distributing by said destination computing device said shared secret numeric value (S_{S}) into said shared secret multivector (S̅_{S}) in accord with said shared secret coefficient distribution algorithm that is the same shared secret coefficient distribution algorithm known to and used by at least one source computing that delivers said cryptotext multivectors to said intermediary computing system;
decrypting by said destination computing device said at least one cryptotext multivector (C̅ₙ) associated with said FOUND search result as a decryption function of at least one Geometric Algebra geometric product operation on said at least one cryptotext multivector (C̅ₙ) and an inverse (S̅_{S}⁻¹) of said shared secret multivector (S̅_{S}) into said at least one message multivector (M̅ₙ) such that said decryption function provides a corresponding decryption operation for said encryption process of said at least one cryptotext multivector (C̅ₙ) at said at least one source computing that delivers said cryptotext multivectors to said intermediary computing system; and
converting by said destination computing device said at least one message multivector (M̅ₙ) into said at least one corresponding numeric message data value (Mₙ) in accord with said homomorphic preserving mathematical relationship that is the same homomorphic preserving mathematical relationship known to and used by said at least one source computing device that delivers said cryptotext multivectors to said intermediary computing system.

29. A homomorphic search Enhanced Data-Centric Encryption (EDCE) system for homomorphic searching of an intermediary computing system that stores at least one cryptotext encrypted data representation of at least one corresponding plain text data value wherein said homomorphic search is initiated using a plaintext search data value without encrypting said plaintext search data value and without said intermediary computing device decrypting said at least one stored cryptotext encrypted data representation, the homomorphic search EDCE system comprising:
at least one source computing device, wherein each of said at least one source computing devices further comprises:
a source numeric message distribution subsystem that distributes at least one numeric message data value (Mₙ) into coefficients of at least one corresponding message multivector (M̅ₙ) in accord with a homomorphic preserving mathematical relationship between an unencrypted numeric data value and multivector coefficients representing said unencrypted numeric data value that is known to said at least one source computing device and said search request computing device;
a source numeric shared secret distribution subsystem that distributes said shared secret numeric value (S_{S}) into said shared secret multivector (S̅_{S}) in accord with a shared secret coefficient distribution algorithm such that said shared secret numeric value (S_{S}) is kept secret from other devices not intended to have access to said at least one corresponding numeric message data value (Mₙ) including said intermediary computing system;
a source encryption subsystem that encrypts at least one corresponding cryptotext multivector (C̅ₙ) as said encryption function of at least one Geometric Algebra geometric product operation on said at least one corresponding message multivector (M̅ₙ) and said shared secret multivector (S̅_{S}); and
a source send subsystem that sends said at least one cryptotext multivector (C̅ₙ) to said intermediary computing system;
a search request computing device, wherein said search request computing device further comprises:
a search request numeric message distribution subsystem that distributes a search request numeric message data value (SR) into coefficients of a corresponding search request message multivector (S̅R̅) in accord with said homomorphic preserving mathematical relationship;
a search request rationalize calculation subsystem that calculates a Geometric Algebra rationalize R(S̅R̅) of said search request message multivector (S̅R̅); and
a search request send subsystem that sends a search request for said rationalize R(S̅R̅) of said search request message multivector (S̅R̅) to said intermediary computing system; and
said intermediary computing system, wherein said intermediary computing system further comprises:
an intermediary receive subsystem that receives said at least one cryptotext multivector (C̅ₙ) sent by said at least one source computing device;
an intermediary store subsystem that stores said at least one cryptotext multivector (C̅ₙ) on said intermediary computing system;
an intermediary receive search request subsystem that receives said search request for said rationalize R(S̅R̅) of said search request message multivector (S̅R̅) sent by said search request computing device;
an intermediary rationalize calculation subsystem that calculates a Geometric Algebra rationalize R(C̅ₙ) of said at least one cryptotext multivector (C̅ₙ) stored on said intermediary computing device;
an intermediary modulus calculation subsystem that calculates said rationalize R(C̅ₙ) of said at least one cryptotext multivector (C̅ₙ) modulus operation by said rationalize R(S̅R̅) of said search request message multivector (S̅R̅); and
an intermediary search result determination subsystem that determines a search result as a function of said modulus operation on said at least one cryptotext multivector (C̅ₙ) by said rationalize R(S̅R̅) of said search request message multivector (S̅R̅) such that a FOUND result is indicated when said modulus operation result is zero and a NOT-FOUND result is indicated when said modulus operation result is non-zero.

30. The homomorphic search EDCE system of claim 29:
wherein said search request for said rationalize R(S̅R̅) of said search request message multivector (S̅R̅) sent to said intermediary computing system by said search request computing device further includes a designation of a destination computing device for said search result;
wherein said intermediary computing system further comprises an intermediary send subsystem that sends said search result to said destination computing device; and
wherein said homomorphic search EDCE system of claim 29 further comprises:
said destination computing device, wherein said destination computing device further comprises:
a destination receive subsystem that receives said search result sent by said intermediary computing system.

31. The homomorphic search EDCE system of claim 29:
wherein said search request for said rationalize R(S̅R̅) of said search request message multivector (S̅R̅) sent to said intermediary computing system by said search request computing device further includes a designation of a destination computing device for receiving said at least one cryptotext multivector (C̅ₙ) associated with a FOUND result;
wherein said intermediary computing system further comprises an intermediary send subsystem that sends to said destination computing device said at least one cryptotext multivector (C̅ₙ) associated with said search result when said search result is a FOUND result; and
wherein when said determination of said search result is a FOUND result, said homomorphic search EDCE system of claim 29 further comprises:
said destination computing device, wherein said destination computing device further comprises:
a destination receive subsystem that receives said at least one cryptotext multivector (C̅ₙ) associated with said FOUND search result sent by said intermediary computing system;
a destination numeric shared secret distribution subsystem that distributes said shared secret numeric value (S_{S}) into said shared secret multivector (S̅_{S}) in accord with said shared secret coefficient distribution algorithm that is the same shared secret coefficient distribution algorithm known to said at least one source computing device;
a destination decryption subsystem that decrypts said at least one cryptotext multivector (C̅ₙ) associated with said FOUND search result as a decryption function of at least one Geometric Algebra geometric product operation on said at least one cryptotext multivector (C̅ₙ) and an inverse (S̅_{S}⁻¹) of said shared secret multivector (S̅_{S}) into said at least one message multivector (M̅ₙ) such that said decryption function provides a corresponding decryption operation for said encryption process of said at least one cryptotext multivector (C̅ₙ); and
a destination convert multivector subsystem that converts said at least one message multivector (M̅ₙ) into said at least one corresponding numeric message data value (Mₙ) in accord with said homomorphic preserving mathematical relationship that is the same homomorphic preserving mathematical relationship known to said at least one source computing device and said search request computing device.

32. The homomorphic search EDCE system of claim 31:
wherein said at least one source computing device further comprises a source link subsystem that links additional encrypted data to said at least one cryptotext multivector (C̅ₙ), wherein said additional encrypted data is encrypted with the same methodology as for said at least one cryptotext multivector (C̅ₙ);
wherein said source send subsystem further sends said linked additional encrypted data to said intermediary computing system as additional encrypted data that is linked to said at least one cryptotext multivector (C̅ₙ);
wherein said intermediary receive subsystem further receives said linked additional encrypted data;
wherein said intermediary store subsystem further stores said linked additional encrypted data as additional encrypted data that is linked to said at least one cryptotext multivector (C̅ₙ);
wherein said intermediary send subsystem further sends to said destination computing device said linked additional encrypted data that is linked to said at least one cryptotext multivector (C̅ₙ) along with said at least one cryptotext multivector (C̅ₙ) associated with said search result when said search result is a FOUND result;
wherein said destination receive subsystem further receives said linked additional encrypted data that is linked to said at least one cryptotext multivector (C̅ₙ) along with said at least one cryptotext multivector (C̅ₙ) associated with said FOUND search result sent by said intermediary computing system; and
wherein said destination computing device further comprises a destination link subsystem that obtains linked additional unencrypted data from said linked additional encrypted data with the same methodology as for obtaining said at least one numeric message data value (Mₙ) from said at least one cryptotext multivector (C̅ₙ).

33. The homomorphic search EDCE system of claim 29 wherein said homomorphic preserving mathematical relationship between said unencrypted numeric data value and said multivector coefficients representing said unencrypted numeric data ensures that a result of mathematical operations defined by said homomorphic preserving mathematical relationship on said multivector coefficients representing said unencrypted numeric data value is equal to said unencrypted numeric data value.

34. The homomorphic search EDCE system of claim 33 wherein said mathematical operations defined by said homomorphic preserving mathematical relationship are comprised of at least one of a group chosen from: addition of at least one coefficient of said multivector coefficients, subtraction of at least one coefficient of said multivector coefficients, addition of a constant value, subtraction of a constant value, multiplication of at least one coefficient of said multivector coefficients by a constant value, and division of at least one coefficient of said multivector coefficients by a constant value.

35. The homomorphic search EDCE system of claim 33 wherein said mathematical operations defined by said homomorphic preserving mathematical relationship incorporate at least one coefficient value of said multivector coefficients such that said mathematical operations defined by said homomorphic preserving mathematical relationship is comprised of one of a group chosen from: said mathematical operations defined by said homomorphic preserving mathematical relationship incorporate all coefficient values of said multivector coefficients, said mathematical operations defined by said homomorphic preserving mathematical relationship incorporate fewer than all but more than one coefficient values of said multivector coefficients, and said mathematical operations defined by said homomorphic preserving mathematical relationship incorporate one coefficient value of said multivector coefficients.

36. The homomorphic search EDCE system of claim 29 wherein said at least one numeric message data value (Mₙ) is a numeric value comprised of at least one of a group chosen from: positive numbers, negative numbers, zero, integer numbers, and real numbers.

37. The homomorphic search EDCE system of claim 29 wherein numeric values of said coefficients of said at least one message multivector (M̅ₙ) are comprised of at least one of a group chosen from: positive numbers, negative numbers, zero, integer numbers, and real numbers.

38. The homomorphic search EDCE system of claim 29:
wherein said source numeric message distribution subsystem further ensures that not all coefficients of said at least one message multivector (M̅ₙ) are equal to each other; and
wherein said shared secret coefficient distribution algorithm further ensures that not all coefficients of said shared secret multivector (S̅_{S}) are equal to each other.

39. The homomorphic search EDCE system of claim 31 wherein said search request computing device separately performs processes of at least one of a group chosen from: said at least one source computing device, said intermediary computing system, and said destination computing device.

40. The homomorphic search EDCE system of claim 31 wherein said at least one source computing device separately performs processes of at least one of a group chosen from: said search request computing device, said intermediary computing system, and said destination computing device.

41. The homomorphic search EDCE system of claim 31 wherein said intermediary computing system separately performs processes of at least one of a group chosen from: said search request computing device, said at least one source computing device, and said destination computing device.

42. The homomorphic search EDCE system of claim 31 wherein said destination computing device separately performs processes of at least one of a group chosen from: said search request computing device, said at least one source computing device, and said intermediary computing system.

43. The homomorphic search EDCE system of claim 31 wherein evaluation of Geometric Algebra geometric products, inverses of multivectors, and rationalizations of multivectors is implemented on said at least one source computing device, said search request computing device, said intermediary computing device, and said destination computing device using basic arithmetic operations of addition, subtraction, multiplication, and division.

44. The homomorphic search EDCE system of claim 43 wherein said implementation of said Geometric Algebra geometric products, inverses of multivectors, and rationalizations of multivectors on said at least one source computing device, said search request computing device, said intermediary computing system, and said destination computing device does not include a complex operation to select a prime number, to calculate a logarithm function, and/or to calculate a natural logarithm function.

45. The homomorphic search EDCE system of claim 31 further comprising establishing said shared secret numeric value (S_{S}) between said at least one source computing device and said destination computing device using a known shared secret technique.

46. The homomorphic search EDCE system of claim 45 wherein said known shared secret technique is comprised of at least one of a group chosen from: pre-conditioning said first source computing device, said at least one additional source computing device, and said destination computing device with said shared secret numeric value (S_{S}); standard public/private key exchange technique; RSA (Rivest-Shamir-Adleman) key exchange, and Diffie-Hellman key exchange.

47. The homomorphic search EDCE system of claim 31 wherein said encryption function of at least one Geometric Algebra geometric product operation and said decryption function of at least one Geometric Algebra geometric product operation is comprised of at least one of a group chosen from: a geometric product (C̅ₙ=M̅S̅_{S}) of a message multivector (M̅) and said shared secret multivector (S̅_{S}) to encrypt and a geometric product (M̅=C̅ₙS̅_{S}⁻¹) of said at least one cryptotext multivector (C̅ₙ) and said inverse (S̅_{S}⁻¹) of said shared secret multivector (S̅_{S}) to decrypt, and a geometric product “sandwich” (C̅ₙ=S̅_{S}M̅S̅_{S} to encrypt and M̅=S̅ₛ⁻¹C̅ₙS̅_{S}⁻¹ to decrypt).

48. The homomorphic search EDCE system of claim 31:
wherein each of said at least one source computing devices further comprises:
a source second shared secret key generation subsystem that generates a second shared secret key (S_{S}_{₂}) as a scalar result of a 0-Blade Reduction Operation of said shared secret multivector (S̅_{S}); and
a source second numeric shared secret distribution subsystem that distributes said second shared secret key (S_{S}_{₂}) into coefficients of a second shared secret multivector (S̅_{S}_{₂}) in accord with a second shared secret coefficient distribution algorithm that is known to said at least one source computing device and said destination computing device; and
wherein said source encryption subsystem further encrypts said at least one cryptotext multivector (C̅ₙ) as a function of Geometric Algebra geometric product operations on said at least one message multivector (M̅ₙ), said shared secret multivector (S̅_{S}), and said second shared secret multivector (S̅_{S}_{₂});
wherein said destination computing device further comprises:
a destination second shared secret key generation subsystem that generates said second shared secret key (S_{S}_{₂}) as a scalar result of said 0-Blade Reduction Operation of said shared secret multivector (S̅_{S}); and
a destination second numeric shared secret distribution subsystem that distributes said second shared secret key (S_{S}_{₂}) into said second shared secret multivector (S̅_{S}_{₂}) in accord with said second shared secret coefficient distribution algorithm; and
wherein said destination decryption subsystem further decrypts said at least one cryptotext multivector (C̅ₙ) as a function of Geometric Algebra geometric product operations on said at least one cryptotext multivector (C̅ₙ), an inverse (S̅_{S}⁻¹) of said shared secret multivector (S̅_{S}), and an inverse (S̅_{S}_{₂}⁻¹) of said second shared secret multivector (S̅_{S}_{₂}) into said at least one message multivector (M̅ₙ).

49. The homomorphic search EDCE system of claim 48 wherein said 0-Blade Reduction Operation is a geometric product (S_{S}_{₂}=(S̅_{S}S̅_{S})(S̅_{S}S̅_{S})^{†}) of a geometric product (S̅_{S}S̅_{S}) of said shared secret multivector (S̅_{S}) and a Clifford conjugate (S̅_{S}) of said shared secret multivector (S̅_{S}) and a geometric reverse ((S̅_{S}S̅_{S})^{†}) of said geometric product (S̅_{S}S̅_{S}) of said shared secret multivector (S̅_{S}) and said Clifford conjugate (S̅_{S}) of said shared secret multivector (S̅_{S}).

50. The homomorphic search EDCE system of claim 48 wherein said Geometric Algebra geometric product operations are comprised of a geometric product “sandwich” (C̅ₙ=S̅_{S}M̅S̅_{S}_{₂} to encrypt and M̅=S̅_{S}⁻¹C̅ₙS̅_{S}_{₂}⁻¹ to decrypt).

51. The homomorphic search EDCE system of claim 29:
wherein said source send subsystem further converts said at least one corresponding additional cryptotext multivector (C̅ₙ) into at least one corresponding additional cryptotext numeric data (Cₙ) in accord with reverse operation of a cryptotext data coefficient distribution algorithm that is known to said at least one source computing device and said intermediary computing system then sends said at least one corresponding cryptotext numeric data (Cₙ) to said intermediary computing system; and
wherein said intermediary receive subsystem further receives said at least one cryptotext numeric data (Cₙ) sent by said corresponding at least one source computing device, then distributes said at least one cryptotext numeric data (Cₙ) into said at least one corresponding cryptotext multivector (C̅ₙ) in accord with said cryptotext data coefficient distribution algorithm.

52. The homomorphic search EDCE system of claim 31:
wherein said intermediary send subsystem further converts said at least one cryptotext multivector (C̅ₙ) into at least one corresponding cryptotext numeric data (Cₙ) in accord with reverse operation of a cryptotext data coefficient distribution algorithm that is known to said destination computing device and said intermediary computing system, then sends said at least one corresponding cryptotext numeric data (Cₙ) to said destination computing device; and
wherein said destination receive subsystem further receives said at least one corresponding cryptotext numeric data (Cₙ) sent by said intermediary computing system, then distributes said at least one corresponding cryptotext numeric data (Cₙ) into said at least one corresponding cryptotext multivector (C̅ₙ) in accord with said cryptotext data coefficient distribution algorithm.

53. A homomorphic search Enhanced Data-Centric Encryption (EDCE) system source computing device for encrypting a numeric message data value (M) in order to transfer a cryptotext multivector (C̅) encrypted representation of said numeric message data value (M) to an intermediary computing system that will save said cryptotext multivector (C̅) and perform homomorphic searches of cryptotext multivectors stored on said intermediary computing system as requested by a search request computing device, the homomorphic search EDCE system source computing device comprising:
a source numeric message distribution subsystem that distributes said numeric message data value (M) into coefficients of a message multivector (M̅) in accord with a homomorphic preserving mathematical relationship between an unencrypted numeric data value and multivector coefficients representing said unencrypted numeric data value that is known to said source computing device and said destination computing device;
a source numeric shared secret distribution subsystem that distributes a shared secret numeric value (S_{S}) into coefficients of a shared secret multivector (S̅_{S}) in accord with a shared secret coefficient distribution algorithm such that said shared secret numeric value (S_{S}) is kept secret from other devices not intended to have access to said numeric message data including said intermediary computing system;
a source encryption subsystem that encrypts said cryptotext multivector (C̅) as an encryption function of at least one Geometric Algebra geometric product operation on said message multivector (M̅) and said shared secret multivector (S̅_{S}); and
a source send subsystem that sends said cryptotext multivector (C̅) to said intermediary computing system.

54. A homomorphic search Enhanced Data-Centric Encryption (EDCE) system search request computing device to request that an intermediary computing system perform a homomorphic search of cryptotext multivectors stored on said intermediary computing system, the homomorphic search EDCE system search request computing device comprising:
a search request numeric message distribution subsystem that distributes a search request numeric message data value (SR) into coefficients of a corresponding search request message multivector (S̅R̅) in accord with said homomorphic preserving mathematical relationship, said homomorphic preserving mathematical relationship also being known to and used by at least one source computing that delivers said cryptotext multivectors to said intermediary computing system;
a search request rationalize calculation subsystem that calculates a Geometric Algebra rationalize R(S̅R̅) of said search request message multivector (S̅R̅); and
a search request send subsystem that sends a search request for said rationalize R(S̅R̅) of said search request message multivector (S̅R̅) to said intermediary computing system.

55. A homomorphic search Enhanced Data-Centric Encryption (EDCE) system intermediary computing system for performing a homomorphic search of cryptotext multivectors stored on said homomorphic search EDCE system intermediary computing system in response to a search request from a search request computing device, the homomorphic search EDCE system intermediary computing system comprising:
an intermediary receive subsystem that receives said at least one cryptotext multivector (C̅ₙ) sent by at least one source computing device;
an intermediary store subsystem that stores said at least one cryptotext multivector (C̅ₙ) on said intermediary computing system;
an intermediary receive search request subsystem that receives said rationalize R(S̅R̅) of a search request message multivector (S̅R̅) sent by said search request computing device;
an intermediary rationalize calculation subsystem that calculates a Geometric Algebra rationalize R(C̅ₙ) of said at least one cryptotext multivector (C̅ₙ) stored on said intermediary computing device;
an intermediary modulus calculation subsystem that calculates said rationalize R(C̅ₙ) of said at least one cryptotext multivector (C̅ₙ) modulus operation by said rationalize R(S̅R̅) of said search request message multivector (S̅R̅); and
an intermediary search result determination subsystem that determines a search result as a function of said modulus operation on said at least one cryptotext multivector (C̅ₙ) by said rationalize R(S̅R̅) of said search request message multivector (S̅R̅) such that a FOUND result is indicated when said modulus operation result is zero and a NOT-FOUND result is indicated when said modulus operation result is non-zero.

56. A homomorphic search Enhanced Data-Centric Encryption (EDCE) system destination computing device for decrypting at least one cryptotext multivector (C̅ₙ) associated with a FOUND search result of a homomorphic search performed by an intermediary computing system of cryptotext multivectors stored on said intermediary computing system, the homomorphic search EDCE system destination computing device comprising:
a destination receive subsystem that receives said at least one cryptotext multivector (C̅ₙ) associated with said FOUND search result sent by said intermediary computing system;
a destination numeric shared secret distribution subsystem that distributes said shared secret numeric value (S_{S}) into said shared secret multivector (S̅_{S}) in accord with said shared secret coefficient distribution algorithm that is the same shared secret coefficient distribution algorithm known to and used by at least one source computing that delivers said cryptotext multivectors to said intermediary computing system;
a destination decryption subsystem that decrypts said at least one cryptotext multivector (C̅ₙ) associated with said FOUND search result as a decryption function of at least one Geometric Algebra geometric product operation on said at least one cryptotext multivector (C̅ₙ) and an inverse (S̅_{S}⁻¹) of said shared secret multivector (S̅_{S}) into said at least one message multivector (M̅ₙ) such that said decryption function provides a corresponding decryption operation for said encryption process of said at least one cryptotext multivector (C̅ₙ); and
a destination convert multivector subsystem that converts said at least one message multivector (M̅ₙ) into said at least one corresponding numeric message data value (Mₙ) in accord with said homomorphic preserving mathematical relationship that is the same homomorphic preserving mathematical relationship known to and used by said at least one source computing device that delivers said cryptotext multivectors to said intermediary computing system.
